(19) United States
(12) Patent Application Publication
(10) Pub. No.: US 2023/0358863 A1
(43) Pub. Date: Nov. 9, 2023

(54) RANGE IMAGING DEVICE AND RANGE IMAGING METHOD

(71) Applicant: TOPPAN Inc., Tokyo (JP)

(72) Inventors: Satoshi TAKAHASHI, Taito-ku (JP); Tomohiro NAKAGOME, Taito-ku (JP)

(73) Assignee: TOPPAN Inc., Tokyo (JP)

(21) Appl. No.: 18/351,658

(22) Filed: Jul. 13, 2023

Related U.S. Application Data
(63) Continuation of application No. PCT/JP2022/001059, filed on Jan. 14, 2022.

(30) Foreign Application Priority Data
Jan. 14, 2021 (JP) 2021-004414

(51) Int. Cl. G01S 7/4863; G01S 17/10

(52) U.S. Cl. CPC G01S 7/4863; G01S 17/10

(57) ABSTRACT

A range imaging device including: a light source unit; a light receiving unit that includes a pixel and a pixel driving circuit, the pixel including a photoelectric conversion device and three or more charge storage units; and a range image processing unit. To cause charge corresponding to reflected light of a light pulse reflected by an object to be distributed to and stored in two of the charge storage units, the range image processing unit performs control so that the charge corresponding to the reflected light is stored in the two of the charge storage units for different reflected light storage times in a single frame period according to an intensity of the reflected light.

### CROSS-REFERENCE TO RELATED APPLICATIONS

The present application is a continuation of and claims the benefit of priority to International Application No. PCT/JP2022/001059, filed Jan. 14, 2022, which is based upon and claims the benefit of priority to Japanese Application No. 2021-004414, filed Jan. 14, 2021. The entire contents of these applications are incorporated herein by reference.

### BACKGROUND OF THE INVENTION

### Field of the Invention

The present invention relates to range imaging devices and range imaging methods.

### Description of Background Art

For example, JP 4235729 B describes a technique of calculating a distance by sequentially distributing charge to three charge storage units provided in each pixel. The entire contents of this publication are incorporated herein by reference.

### SUMMARY OF THE INVENTION

According to one aspect of the present invention, a light source that emits a light pulse to a measurement space, a range image processing unit including circuitry that calculates a distance to an object in the measurement space, and a light receiving unit including a pixel and a pixel driving circuit such that the pixel includes a photoelectric conversion device that generates charge corresponding to incident light, and three or more charge storage units that store the charge, and that the pixel driving circuit causes the charge to be distributed to and stored in each of the charge storage units of the pixel at predetermined timings synchronized with emission of the light pulse. The range image processing unit calculates a distance to the object in the measurement space based on an amount of the charge stored in each of the charge storage units and controls such that the charge corresponding to reflected light of the light pulse reflected by the object is stored in two of the charge storage units for different reflected light storage times in a single frame period according to an intensity of the reflected light.

According to another aspect of the present invention, a range imaging method includes emitting a light pulse to a measurement space and calculating a distance to an object in the measurement space based on an amount of charge stored in each of charge storage units. A range imaging device executes the range imaging method and includes a light source that emits the light pulse to the measurement space, a range image processing unit including circuitry that calculates the distance to the object in the measurement space based on the amount of charge stored in each of the charge storage units, and a light receiving unit includes a pixel and a pixel driving circuit such that the pixel includes a photoelectric conversion device that generates the charge corresponding to incident light, and three or more charge storage units that store the charge, and that the pixel driving circuit causes the charge to be distributed to and stored in each of the charge storage units of the pixel at predetermined timings synchronized with emission of the light pulse.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram showing a schematic configuration of a range imaging device according to a first embodiment of the present invention;

FIG. 2 is a block diagram showing a schematic configuration of a range image sensor of the first embodiment;

FIG. 3 is a circuit diagram showing an example of a configuration of one of pixels of the first embodiment;

FIG. 4A is a timing chart showing the conventional timing at which the pixels are driven;

FIG. 4B is a timing chart showing the conventional timing at which the pixels are driven;

FIG. 5A is a timing chart showing the timing at which the pixels are driven in a measurement mode M1 of the first embodiment;

FIG. 5B is a timing chart showing the timing at which the pixels are driven in the measurement mode M1 of the first embodiment;

FIG. 6 is a flowchart showing a flow of a process performed by the range imaging device in the measurement mode M1 of the first embodiment;

FIG. 7 is a timing chart showing the timing at which the pixels are driven in a measurement mode M2 of the first embodiment;

FIG. 8 is a flowchart showing a flow of a process performed by the range imaging device in the measurement mode M2 of the first embodiment;

FIG. 9A is a timing chart showing the timing at which pixels are driven in a measurement mode M3 according to a second embodiment of the present invention;

FIG. 9B is a timing chart showing the timing at which the pixels are driven in the measurement mode M3 of the second embodiment;

FIG. 10 is a flowchart showing a flow of a process performed by the range imaging device in the measurement mode M3 of the second embodiment;

FIG. 11A is a timing chart showing the timing at which the pixels are driven in a measurement mode M4 of the second embodiment;

FIG. 11B is a timing chart showing the timing at which the pixels are driven in the measurement mode M4 of the second embodiment;

FIG. 12 is a flowchart showing a flow of a process performed by the range imaging device in the measurement mode M4 of the second embodiment;

FIG. 13A is a timing chart showing the timing at which pixels are driven in a measurement mode M5 according to a third embodiment of the present invention;

FIG. 13B is a timing chart showing the timing at which the pixels are driven in the measurement mode M5 of the third embodiment;

FIG. 13C is a timing chart showing the timing at which the pixels are driven in the measurement mode M5 of the third embodiment;

FIG. 14 is a flowchart showing a flow of a process performed by the range imaging device in the measurement mode M5 of the third embodiment;

FIG. 15 is a timing chart showing the timing at which pixels are driven in a modification of the embodiment;

FIG. 16 is a timing chart showing the timing at which pixels are driven in a modification of the embodiment;

FIG. 17 is a timing chart showing the timing at which pixels each of which includes three charge storage units are driven according to a fourth embodiment of the present invention;

FIG. 18A is a timing chart showing the timing at which pixels each of which includes four charge storage units are driven in the fourth embodiment;

FIG. 18B is a timing chart showing the timing at which the pixels each of which includes four charge storage units are driven in the fourth embodiment; and

FIG. 19 is a diagram showing advantageous effects of the embodiments.

### DETAILED DESCRIPTION OF THE EMBODIMENTS

Embodiments will now be described with reference to the accompanying drawings, wherein like reference numerals designate corresponding or identical elements throughout the various drawings. A range imaging device of embodiments will be described with reference to the drawings.

### First Embodiment

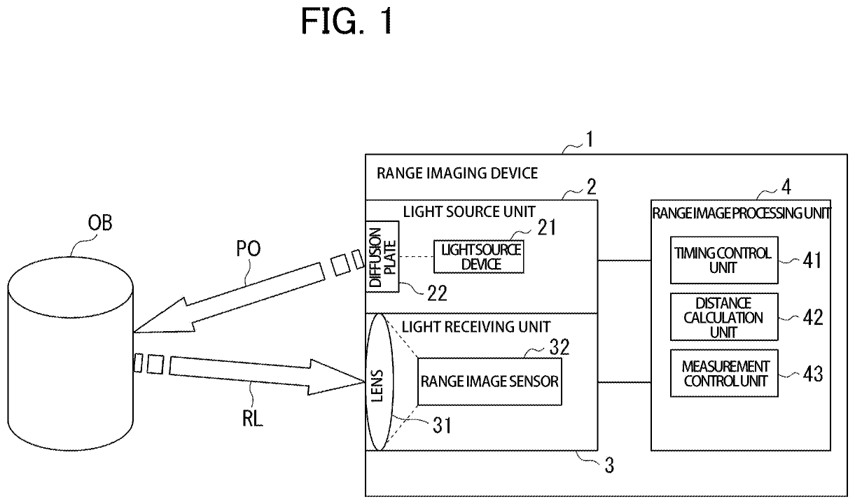

First, a first embodiment will be described. FIG. 1 is a block diagram showing a schematic configuration of a range imaging device according to the first embodiment of the present invention. A range imaging device 1 configured as shown in FIG. 1 includes a light source unit 2, a light receiving unit 3, and a range image processing unit 4. FIG. 1 also shows an object OB as an object for which distance measurement is performed by the range imaging device 1.

The light source unit 2 emits a light pulse PO to a space to be measured in which the object OB is present as an object for which distance measurement is performed by the range imaging device 1, under the control of the range image processing unit 4. The light source unit 2 may be, for example, a surface emitting semiconductor laser module such as a vertical cavity surface emitting laser (VCSEL). The light source unit 2 includes a light source device 21 and a diffusion plate 22.

The light source device 21 is a light source that emits laser light in the near-infrared wavelength range (e.g., in a wavelength range of 850 nm to 940 nm) as the light pulse PO with which the object OB is irradiated. The light source device 21 may be, for example, a semiconductor laser light emitting element. The light source device 21 emits pulsed laser light under the control of a timing control unit 41.

The diffusion plate 22 is an optical component that diffuses laser light in the near-infrared wavelength range emitted from the light source device 21 over a surface from which the laser light emerges so that the object OB is irradiated with the laser light. The pulsed laser light diffused by the diffusion plate 22 emerges as the light pulse PO, and the object OB is irradiated with the light pulse PO.

The light receiving unit 3 receives reflected light RL of the light pulse PO reflected by the object OB as an object for which distance measurement is performed by the range imaging device 1, and outputs a pixel signal corresponding to the reflected light RL received. The light receiving unit 3 includes a lens 31 and a range image sensor 32.

The lens 31 is an optical lens that guides the reflected light RL incident on the lens 31 to the range image sensor 32. The reflected light RL incident on the lens 31 emerges toward the range image sensor 32 and is received by (incident on) pixels provided in a light receiving region of the range image sensor 32.

The range image sensor 32 is an image sensor used in the range imaging device 1. The range image sensor 32 includes multiple pixels in a two-dimensional light receiving region. Each of the pixels of the range image sensor 32 includes a single photoelectric conversion device, multiple charge storage units corresponding to the single photoelectric conversion device, and a component that distributes charge to each of the charge storage units. That is, each of the pixels is a distribution-type image sensor in which charge is distributed to and stored in the multiple charge storage units.

The range image sensor 32 distributes charge generated by the photoelectric conversion device to each of the charge storage units, under the control of the timing control unit 41. Furthermore, the range image sensor 32 outputs a pixel signal corresponding to the amount of charge distributed to each of the charge storage units. In the range image sensor 32, the multiple pixels are arranged in a two-dimensional matrix, and the range image sensor 32 outputs a pixel signal for each frame for each of the pixels.

The range image processing unit 4 controls the range imaging device 1 to calculate the distance to the object OB. The range image processing unit 4 includes the timing control unit 41, a distance calculation unit 42, and a measurement control unit 43.

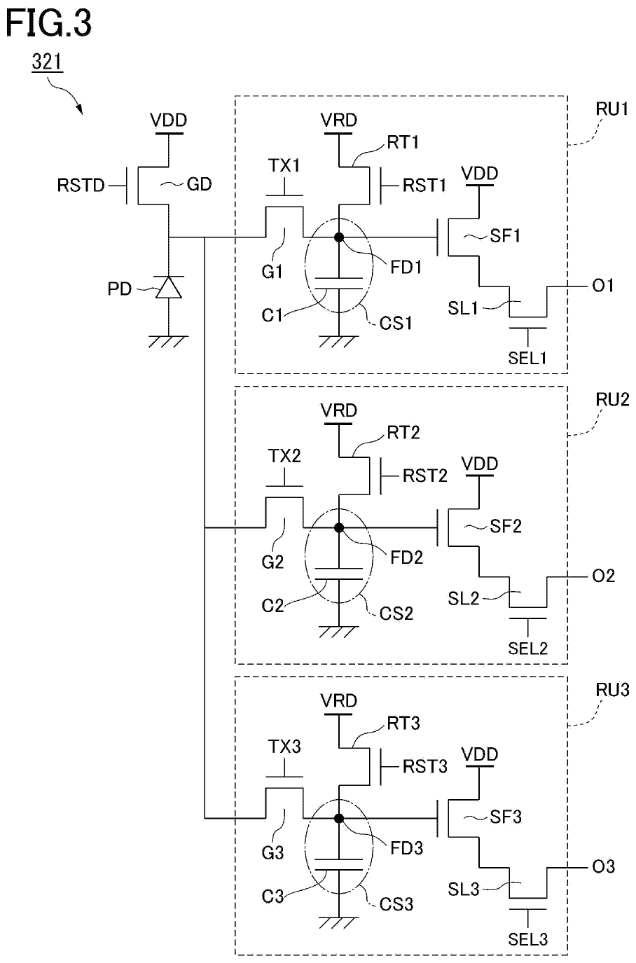

The timing control unit 41 controls the timing at which various control signals required for measurement are output, under the control of the measurement control unit 43. The various control signals include, for example, a signal for controlling emission of the light pulse PO, a signal for distributing the reflected light RL to the multiple charge storage units, and a signal for controlling the number of distributions per frame. The number of distributions is the number of repetitions of the process of distributing charge to charge storage units CS (see FIG. 3). An exposure time is the product of the number of distributions and a duration (a storage time Ta described later) for which charge is stored in each of the charge storage units in a single charge distribution process.

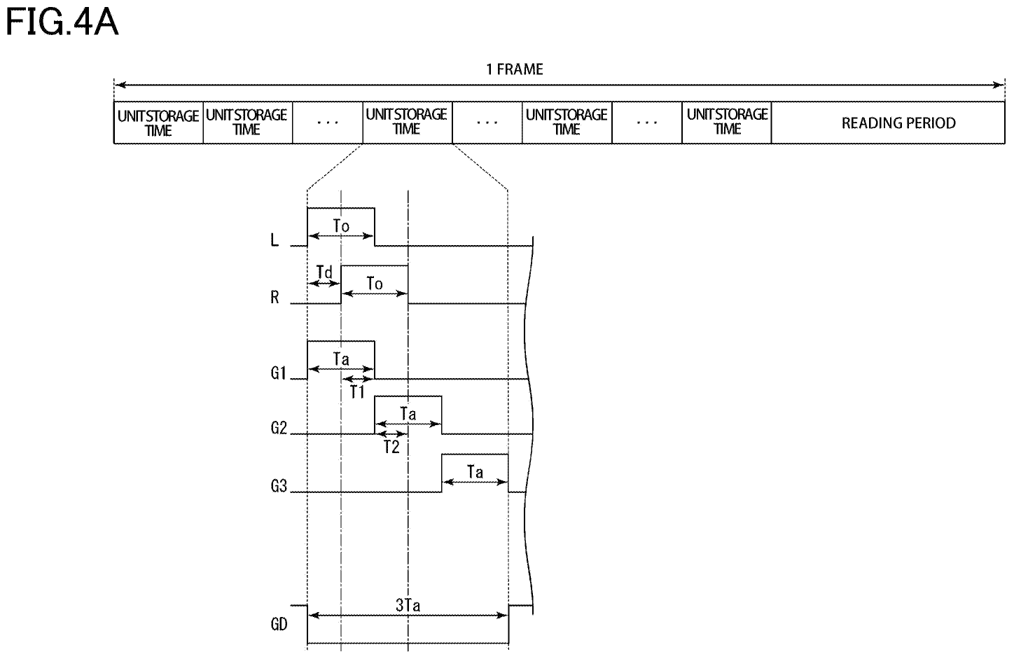

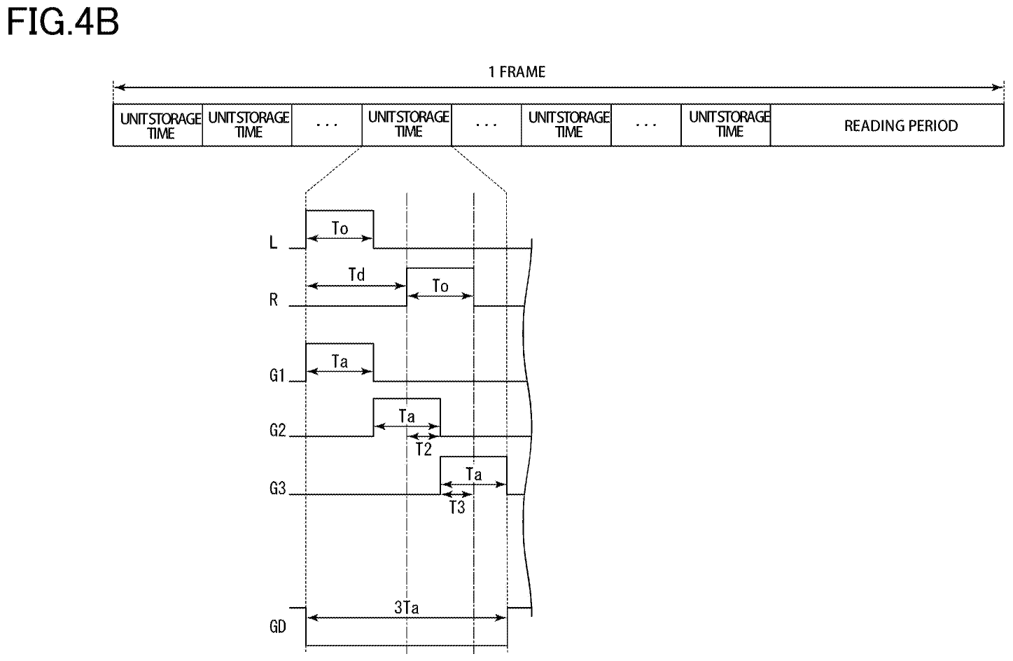

The distance calculation unit 42 outputs distance information obtained by calculating the distance to the object OB, based on a pixel signal output from the range image sensor 32. The distance calculation unit 42 calculates a delay time Td (see FIG. 4A) from the time at which the light pulse PO is emitted to the time at which the reflected light RL is received, based on the amount of charge stored in the multiple charge storage units. The distance calculation unit 42 calculates the distance to the object OB according to the calculated delay time Td.

The distance calculation unit 42 classifies the pixels into distance groups based on the distance to the object OB (e.g., groups such as a short-distance group and a long-distance group), according to the amount of charge stored in the multiple charge storage units of each of the pixels.

The distance calculation unit 42 uses the classification results to select, from the multiple charge storage units, a charge storage unit for which calculation of the delay time Td is performed. The distance calculation unit 42 uses an arithmetic expression corresponding to the selected charge storage unit to calculate the distance to the object OB. The methods that the distance calculation unit 42 uses for classification of the pixels into distance groups, selection of a charge storage unit, and distance calculation will be described later in detail.

The measurement control unit 43 controls the timing control unit 41. For example, the measurement control unit 43 sets the number of distributions and the storage time Ta in each frame and controls the timing control unit 41 to perform imaging according to the setting.

In the present embodiment, the measurement control unit 43 sets the exposure times of the multiple charge storage units provided in each of the pixels to be different from each other (have different durations). That is, the measurement control unit 43 sets the product of the number of distributions and the storage time Ta for the multiple charge storage units provided in each of the pixels to different values. For example, the measurement control unit 43 applies the same storage time Ta but different numbers of distributions for the multiple charge storage units to set the exposure times of the multiple charge storage units to be different from each other (have different durations).

In the following, an example will be described in which the measurement control unit 43 provides multiple measurement steps in each frame and sets different numbers of distributions for the charge storage units in the measurement steps. The details of the measurement steps will be described later.

However, the configuration of the measurement control unit 43 is not limited to the above configuration. The measurement control unit 43 may control the timing control unit 41 so that at least the multiple charge storage units provided in each of the pixels have different exposure times. For example, the measurement control unit 43 may cause the charge storage units to have the same number of distributions but different storage times Ta so that the charge storage units have different exposure times. The measurement control unit 43 may not provide multiple measurement steps in each frame and may cause the charge storage units to have different numbers of distributions or/and different storage times Ta so that the charge storage units have different exposure times.

With such a configuration, in the range imaging device 1, the light pulse PO in the near-infrared wavelength range emitted from the light source unit 2 to the object OB is reflected by the object OB, and the reflected light RL is received by the light receiving unit 3, and the range image processing unit 4 outputs distance information obtained by measuring the distance to the object OB.

FIG. 1 shows the range imaging device 1 in which the range image processing unit 4 is provided; however, the range image processing unit 4 may be provided outside the range imaging device 1.

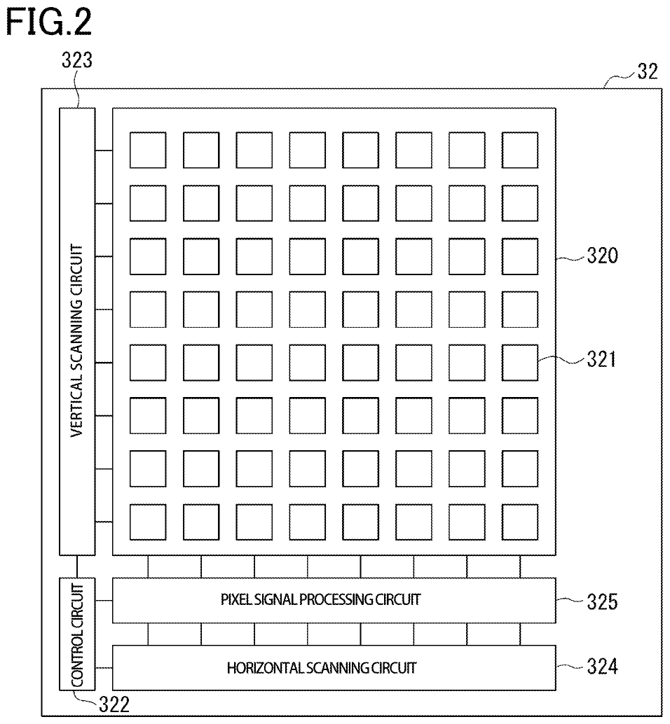

Next, a configuration of the range image sensor 32 used as an image sensor in the range imaging device 1 will be described. FIG. 2 is a block diagram showing a schematic configuration of the image sensor (range image sensor 32) used in the range imaging device 1 according to the first embodiment of the present invention.

As shown in FIG. 2, the range image sensor 32 includes, for example, a light receiving region 320 in which multiple pixels 321 are arranged, a control circuit 322, a vertical scanning circuit 323 that performs a distribution operation, a horizontal scanning circuit 324, and a pixel signal processing circuit 325.

The light receiving region 320 is a region in which the multiple pixels 321 are arranged. FIG. 2 shows an example in which the pixels 321 are arranged in a two-dimensional matrix with 8 rows and 8 columns. In the pixels 321, charge corresponding to the amount of received light is stored. The control circuit 322 controls the range image sensor 32 in a centralized manner. The control circuit 322 controls the operation of the components of the range image sensor 32, for example, according to instructions from the timing control unit 41 of the range image processing unit 4. The components of the range image sensor 32 may be directly controlled by the timing control unit 41. In such a case, the control circuit 322 may be omitted.

The vertical scanning circuit 323 is a circuit that controls, for each row, the pixels 321 arranged in the light receiving region 320, under the control of the control circuit 322. The vertical scanning circuit 323 causes the pixels 321 to output, to the pixel signal processing circuit 325, a voltage signal corresponding to the amount of charge stored in each of the charge storage units CS of the pixels 321. In this case, the vertical scanning circuit 323 distributes charge generated through conversion by the photoelectric conversion device to each of the charge storage units of the pixels 321. That is, the vertical scanning circuit 323 is an example of “pixel driving circuit”.

The pixel signal processing circuit 325 is a circuit that performs predetermined signal processing (e.g., noise suppression processing, AD conversion processing, etc.) with respect to a voltage signal output from the pixels 321 in each row to the corresponding vertical signal line, under the control of the control circuit 322.

The horizontal scanning circuit 324 is a circuit that causes a signal output from the pixel signal processing circuit 325 to be sequentially output to a horizontal signal line, under the control of the control circuit 322. Thus, a pixel signal corresponding to the amount of charge stored for each frame is sequentially output to the range image processing unit 4 via the horizontal signal line.

In the following description, the pixel signal processing circuit 325 is presumed to perform AD conversion processing, and the pixel signal is presumed to be a digital signal.

A configuration of the pixels 321 arranged in the light receiving region 320 of the range image sensor 32 will be described. FIG. 3 is a circuit diagram showing an example of the configuration of the pixels 321 arranged in the light receiving region 320 of the range image sensor 32 of the first embodiment. FIG. 3 shows an example of the configuration of one of the multiple pixels 321 arranged in the light receiving region 320. The pixel 321 is an example of the configuration including three pixel signal reading units.

The pixel 321 includes a single photoelectric conversion device PD, a drain gate transistor GD, and three pixel signal reading units RU each of which outputs a voltage signal from the corresponding output terminal O. The pixel signal reading units RU each include a reading gate transistor G, a floating diffusion FD, a charge storage capacitor C, a reset gate transistor RT, a source follower gate transistor SF, and a selection gate transistor SL. In each of the pixel signal reading units RU, the floating diffusion FD and the charge storage capacitor C constitute a charge storage unit CS.

In FIG. 3, the three pixel signal reading units RU are distinguished by the number “1”, “2”, or “3” following the reference sign “RU” of the pixel signal reading units RU. Similarly, the components of the three pixel signal reading units RU are also distinguished by the number following the reference sign of the components of each of the pixel signal reading units RU that represents the corresponding pixel signal reading unit RU.

In the pixel 321 shown in FIG. 3, a pixel signal reading unit RU1 that outputs a voltage signal from an output terminal O1 includes a reading gate transistor G1, a floating diffusion FD1, a charge storage capacitor C1, a reset gate transistor RT1, a source follower gate transistor SF1, and a selection gate transistor SL1. In the pixel signal reading unit RU1, the floating diffusion FD1 and the charge storage capacitor C1 constitute a charge storage unit CS1. A pixel signal reading unit RU2 and a pixel signal reading unit RU3 also have the same configuration. The charge storage unit CS1 is an example of a “first charge storage unit”. The charge storage unit CS2 is an example of a “second charge storage unit”. The charge storage unit CS3 is an example of a “third charge storage unit”.

The photoelectric conversion device PD is an embedded photodiode that performs photoelectric conversion of incident light to generate charge and stores the generated charge. The photoelectric conversion device PD may have any structure. The photoelectric conversion device PD may be, for example, a PN photodiode having a structure in which a P-type semiconductor is joined to an N-type semiconductor, or a PIN photodiode having a structure in which an I-type semiconductor is provided between a P-type semiconductor and a N-type semiconductor. The photoelectric conversion device PD is not limited to a photodiode, and may be, for example, a photogate-type photoelectric conversion device.

In the pixels 321, charge generated through photoelectric conversion of incident light by the photoelectric conversion device PD is distributed to each of the three charge storage units CS, and a voltage signal corresponding to the amount of charge distributed is output to the pixel signal processing circuit 325.

The configuration of the pixels arranged in the range image sensor 32 is not limited to the configuration including the three pixel signal reading units RU as shown in FIG. 3, and the pixels may have any configuration including multiple pixel signal reading units RU. That is, the pixels arranged in the range image sensor 32 may include two pixel signal reading units RU (charge storage units CS), or four or more pixel signal reading units RU (charge storage units CS).

In the pixel 321 in the example shown in FIG. 3, each of the charge storage units CS is constituted by the floating diffusion FD and the charge storage capacitor C. However, each of the charge storage units CS is constituted only by at least the floating diffusion FD, and the pixel 321 may not include the charge storage capacitor C.

In the example shown in FIG. 3, the pixel 321 includes the drain gate transistor GD; however, the pixel 321 may not include the drain gate transistor GD in the case where the charge stored (remaining) in the photoelectric conversion device PD is not required to be eliminated.

Next, the conventional timing at which the pixels 321 are driven in the range imaging device 1 will be described with reference to FIGS. 4A and 4B. FIGS. 4A and 4B are a timing chart showing the conventional timing at which the pixels 321 are driven. FIG. 4A shows a timing chart for pixels that receive reflected light from an object at a short distance (short-distance light receiving pixels). FIG. 4B shows a timing chart for pixels that receive reflected light from an object at a long distance (long-distance light receiving pixels). The short distance is an example of “first distance”. The long distance is an example of “second distance”.

In FIGS. 4A and 4B, the symbol “L” represents the timing at which the light pulse PO is emitted, the symbol “R” represents the timing at which reflected light is received, the symbol “G1” represents the timing of a driving signal TX1, the symbol “G2” represents the timing of a driving signal TX2, the symbol “G3” represents the timing of a driving signal TX3, and the symbol “GD” represents the timing of a driving signal RSTD. The driving signal TX1 is a signal for driving the reading gate transistor G1. The same applies to the driving signals TX2 and TX3.

As shown in FIGS. 4A and 4B, the light pulse PO is emitted for an emission time To, and after the delay time Td, the reflected light RL is received by the range image sensor 32. In synchronization with emission of the light pulse PO, the vertical scanning circuit 323 causes charge to be stored in the charge storage units CS1, CS2, and CS3 in this order. In FIGS. 4A and 4B, the “unit storage time” represents the time from when the light pulse PO is emitted to when charge is sequentially stored in the charge storage units CS in a single distribution process.

First, a case in which the reflected light RL is received from an object located at a short distance will be described with reference to FIG. 4A. In synchronization with the timing at which the light pulse PO is emitted, the vertical scanning circuit 323 switches the drain gate transistor GD to the OFF state and switches the reading gate transistor G1 to the ON state. When the storage time Ta has elapsed after the reading gate transistor G1 is switched to the ON state, the vertical scanning circuit 323 switches the reading gate transistor G1 to the OFF state. Thus, charge generated through photoelectric conversion by the photoelectric conversion device PD while the reading gate transistor G1 is controlled to be in the ON state is stored in the charge storage unit CS1 via the reading gate transistor G1.

Then, at the timing at which the reading gate transistor G1 is switched to the OFF state, the vertical scanning circuit 323 causes the reading gate transistor G2 to be in the ON state for the storage time Ta. Thus, charge generated through photoelectric conversion by the photoelectric conversion device PD while the reading gate transistor G2 is controlled to be in the ON state is stored in the charge storage unit CS2 via the reading gate transistor G2.

Then, at the timing at which the storage of charge in the charge storage unit CS2 is terminated, the vertical scanning circuit 323 switches the reading gate transistor G3 to the ON state, and when the storage time Ta has elapsed, the vertical scanning circuit 323 switches the reading gate transistor G3 to the OFF state. Thus, charge generated through photoelectric conversion by the photoelectric conversion device PD while the reading gate transistor G3 is controlled to be in the ON state is stored in the charge storage unit CS3 via the reading gate transistor G3.

Then, at the timing at which the storage of charge in the charge storage unit CS3 is terminated, the vertical scanning circuit 323 switches the drain gate transistor GD to the ON state for discharge. Thus, charge generated through photoelectric conversion by the photoelectric conversion device PD is eliminated via the drain gate transistor GD.

The vertical scanning circuit 323 repeatedly drives the pixels as described above for a predetermined number of distributions within each frame. Then, the vertical scanning circuit 323 outputs a voltage signal corresponding to the amount of charge distributed to each of the charge storage units CS. Specifically, the vertical scanning circuit 323 causes the selection gate transistor SL1 to be in the ON state for a predetermined time to output, from the output terminal O1, a voltage signal corresponding to the amount of charge stored in the charge storage unit CS1 via the pixel signal reading unit RU1. Similarly, the vertical scanning circuit 323 sequentially switches the selection gate transistors SL2 and SL3 to the ON state to output, from the output terminals O2 and O3, a voltage signal corresponding to the amount of charge stored in the charge storage units CS2 and CS3. Then, an electrical signal corresponding to the amount of charge for each frame stored in each of the charge storage units CS is output to the distance calculation unit 42 via the pixel signal processing circuit 325 and the horizontal scanning circuit 324.

In the example described above, the light source unit 2 emits the light pulse PO at the timing at which the reading gate transistor G1 is switched to the ON state. However, the present invention is not limited to this. The light source unit 2 only emits the light pulse PO at the timing at which at least the reflected light RL from an object located at a short distance is received by the charge storage units CS1 and CS2. For example, the light source unit 2 may emit the light pulse PO at the timing before the reading gate transistor G1 is switched to the ON state. In the example described above, the emission time To for which the light pulse PO is emitted has the same duration as the storage time Ta. However, the present invention is not limited to this. The emission time To and the storage time Ta may have different durations.

In the case of the short-distance light receiving pixels as shown in FIG. 4A, due to the relationship between the timing at which the light pulse PO is emitted and the timing at which charge is stored in each of the charge storage units CS, charge corresponding to the reflected light RL and an external light component is distributed to and held in the charge storage units CS1 and CS2. Furthermore, charge corresponding to an external light component such as background light is held in the charge storage unit CS3. The distribution (distribution ratio) of the amount of charge between the charge storage units CS1 and CS2 is a ratio corresponding to the delay time Td from the time at which the light pulse PO is emitted to the time at which the light pulse PO is reflected by the object OB and is incident on the range imaging device 1.

Applying this principle, for the conventional short-distance light receiving pixels, the distance calculation unit 42 calculates the delay time Td using the following formula (1).

Td=To×(Q2−Q3)/(Q1+Q2−2×Q3) (1)

Here, To represents the period during which the light pulse PO is emitted, Q1 represents the amount of charge stored in the charge storage unit CS1, Q2 represents the amount of charge stored in the charge storage unit CS2, and Q3 represents the amount of charge stored in the charge storage unit CS3. In the formula (1), the amount of charge corresponding to the external light component of the amount of charge stored in the charge storage units CS1 and CS2 is assumed to be equal to the amount of charge stored in the charge storage unit CS3.

For the short-distance light receiving pixels, the distance calculation unit 42 multiplies the delay time Td obtained using the formula (1) by the speed of light (speed) to calculate the round-trip distance to the object OB. Then, the distance calculation unit 42 calculates ½ of the calculated round-trip distance to obtain the distance to the object OB.

Next, a case in which the reflected light RL is received from an object located at a long distance will be described with reference to FIG. 4B. The timing at which the vertical scanning circuit 323 causes the light pulse PO to be emitted, the timing at which the vertical scanning circuit 323 switches the reading gate transistors G1 to G3 and the drain gate transistor GD to the ON state, and the like are the same as those shown in FIG. 4A and are thus not described.

In the case of the long-distance light receiving pixels as shown in FIG. 4B, the delay time Td are longer than in the case of the short-distance light receiving pixels as shown in FIG. 4A. Thus, charge corresponding to an external light component is held in the charge storage unit CS1, and charge corresponding to the reflected light RL and an external light component is distributed to and held in the charge storage units CS2 and CS3. The distribution (distribution ratio) of the amount of charge between the charge storage units CS2 and CS3 is a ratio corresponding to the delay time Td.

For the conventional long-distance light receiving pixels, the distance calculation unit 42 calculates the delay time Td using the following formula (2).

Td=To×(Q3−Q1)/(Q2+Q3−2×Q1) (2)

Here, To represents the period during which the light pulse PO is emitted, Q1 represents the amount of charge stored in the charge storage unit CS1, Q2 represents the amount of charge stored in the charge storage unit CS2, and Q3 represents the amount of charge stored in the charge storage unit CS3. In the formula (2), the amount of charge corresponding to the external light component of the amount of charge stored in the charge storage units CS2 and CS3 is assumed to be equal to the amount of charge stored in the charge storage unit CS1.

For the long-distance light receiving pixels, the distance calculation unit 42 multiplies the delay time Td obtained using the formula (2) by the speed of light (speed) to calculate the round-trip distance to the object OB. Then, the distance calculation unit 42 calculates ½ of the calculated round-trip distance to obtain the distance to the object OB.

In the case of the long-distance light receiving pixels as shown in FIG. 4B, the amount of reflected light RL is smaller than in the case of the short-distance light receiving pixels as shown in FIG. 4A. A smaller amount of reflected light RL is a factor causing reduction in accuracy of distance measurement. Thus, in order to measure the distance to an object located at a long distance, for example, a larger number of distributions may be performed to obtain a longer exposure time, allowing measurement with higher accuracy.

However, in the range imaging device 1, a storage operation is typically performed at the same timing for all the pixels. Thus, it is difficult to drive only specific pixels (the long-distance light receiving pixels in this case) at the timing different from the timing at which the other pixels are driven, in order to increase the exposure time of the specific pixels. That is, the short-distance light receiving pixels and the long-distance light receiving pixels are set to have the same exposure time.

Thus, when an object located at a short distance and an object located at a long distance are both present in the measurement distance range, if charge is stored in the charge storage units the number of distributions that does not cause saturation of the charge storage unit CS1 of the short-distance light receiving pixels, the distance to the object located at a long distance has low accuracy. On the other hand, if the exposure time of the charge storage units CS2 and CS3 of the long-distance light receiving pixels is increased to measure with higher accuracy the distance to the object located at a long distance, the charge storage unit CS1 of the short-distance light receiving pixels is saturated; thus, the distance to the object located at a short distance cannot be accurately calculated. That is, the upper limit of the exposure time of all the pixels is determined according to the intensity of the reflected light RL received by the charge storage unit CS1 of the short-distance light receiving pixels. Thus, when objects located at a short distance and objects located at a long distance are both present, it is difficult to perform accurate measurement for the object located at a long distance.

In order to address this issue, in the present embodiment, the number of distributions for each of the charge storage units CS is controlled so that the multiple (three in the present embodiment) charge storage units CS provided in each of the pixels have different exposure times. The method in which the distance calculation unit 42 controls the number of distributions for each of the charge storage units CS will be described in detail below.

### Measurement Mode M1

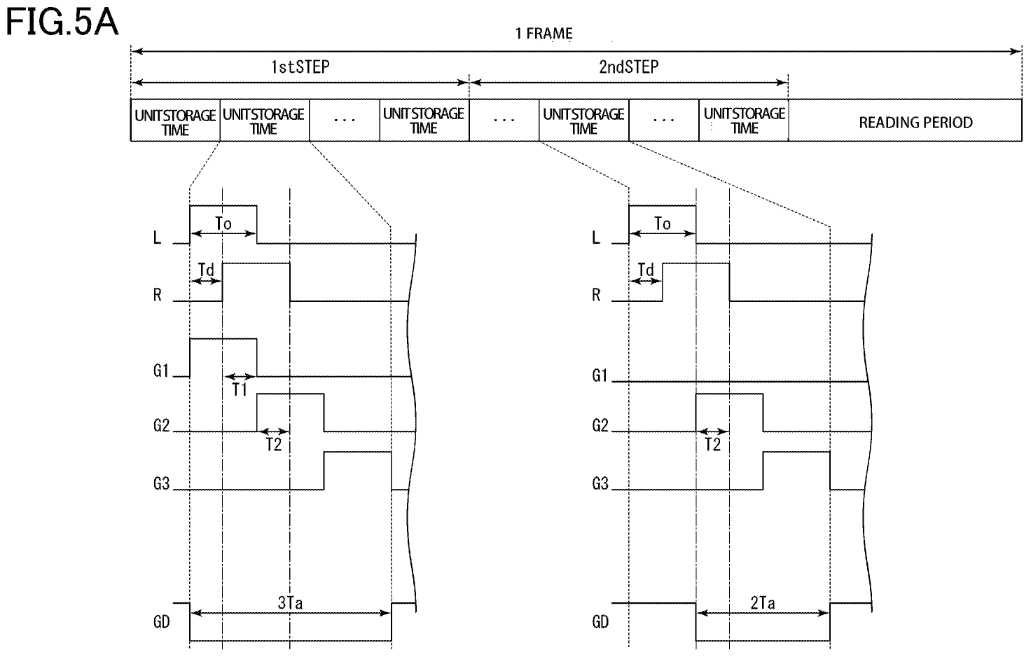

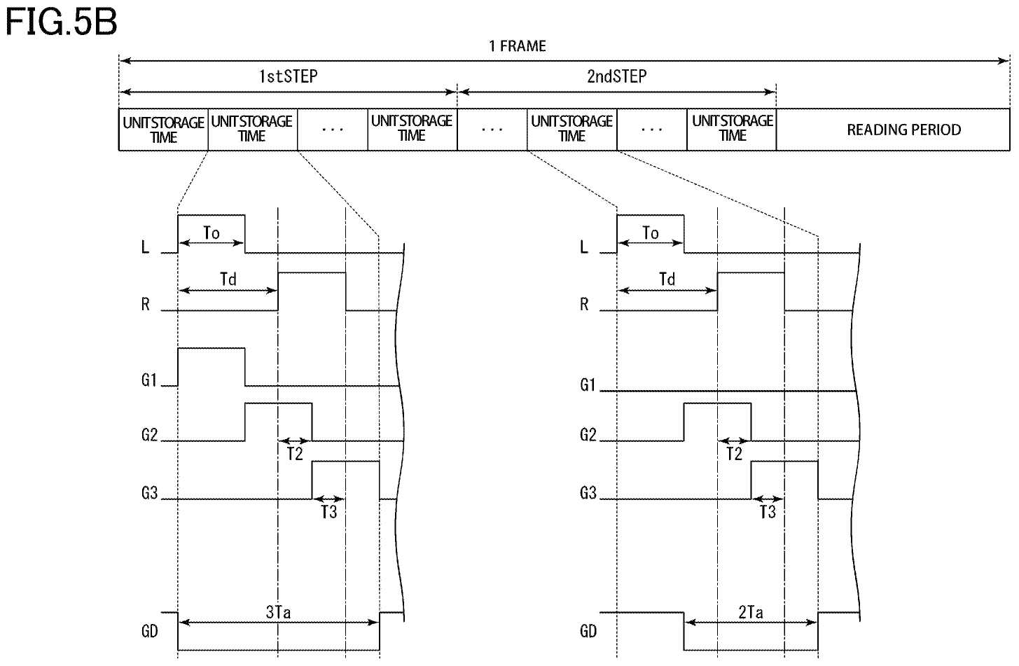

First, a measurement mode M1 will be described with reference to FIGS. 5A and 5B. FIGS. 5A and 5B are a timing chart showing a first example of the timing at which the pixels 321 are driven in the first embodiment. FIG. 5A shows a timing chart for the pixels that receive reflected light from an object at a short distance (short-distance light receiving pixels). FIG. 5B shows a timing chart for the pixels that receive reflected light from an object at a long distance (long-distance light receiving pixels). The symbols such as “L”, “R”, and “G1” in FIGS. 5A and 5B are the same as those in FIG. 4A.

As shown in FIGS. 5A and 5B, in the measurement mode M1 of the present embodiment, two measurement steps (1st STEP and 2nd STEP) are provided in each frame. In the 1st STEP, charge storage operation is performed by applying a conventional driving method. The conventional driving method may be, for example, a method of sequentially storing charge via the reading gate transistors G1 to G3 in synchronization with the timing at which the light pulse PO is emitted, as shown in the timing charts in FIGS. 4A and 4B.

In the 2nd STEP, control is performed so that no charge is stored in the charge storage unit CS1 but charge is stored in the charge storage units CS2 and CS3. Specifically, as shown in FIG. 5A, in the 2nd STEP, the vertical scanning circuit 323 does not control the reading gate transistor G1 to be in the ON state. Instead, the vertical scanning circuit 323 switches the reading gate transistors G2 and G3 to the ON state at the same timing as in the 1st STEP.

Specifically, at the timing at which the storage time Ta has elapsed from emission of the light pulse PO, the vertical scanning circuit 323 switches the drain gate transistor GD to the OFF state and causes the reading gate transistor G2 to be in the ON state for the storage time Ta. Then, at the timing at which the reading gate transistor G2 is switched to the OFF state, the vertical scanning circuit 323 causes the reading gate transistor G3 to be in the ON state for the storage time Ta. Then, at the timing at which the reading gate transistor G3 is switched to the OFF state, the vertical scanning circuit 323 switches the drain gate transistor GD to the ON state for discharge. In the 2nd STEP, the drain gate transistor GD is in the OFF state for the time (2×Ta) during which charge is stored in the charge storage units CS2 and CS3.

With the above configuration, in the case of the short-distance light receiving pixels as shown in FIG. 5A, charge can be distributed to and stored in the charge storage units CS1 and CS2, and in the case of the long-distance light receiving pixels as shown in FIG. 5B, charge can be distributed to and stored in the charge storage units CS2 and CS3. Furthermore, in the present embodiment, in each of the pixels, the charge storage unit CS1 can have an exposure time (with a duration) different from that of the charge storage units CS2 and CS3. This makes it possible to store charge without causing saturation of the charge storage unit CS1 of the short-distance light receiving pixels and to store a larger amount of charge in the charge storage units CS2 and CS3 of the long-distance light receiving pixels. Thus, even when an object located at a short distance and an object located at a long distance are both present in the measurement distance range, it is possible to perform accurate measurement for the object located at a long distance.

The number of distributions in the 1st STEP and the 2nd STEP in the measurement mode M1 of the present embodiment may be set to any number of distributions according to the situation. For example, the number of distributions in the 1st STEP is set not to exceed the upper limit of the number of distributions that does not cause saturation of the charge storage unit CS1 of the short-distance light receiving pixels. The number of distributions in the 2nd STEP is set so that no saturation occurs in the charge storage unit CS2 or CS3 of the pixels 321 (including the short-distance light receiving pixels and the long-distance light receiving pixels) and that the amount of charge stored in the charge storage units CS2 and CS3 of the long-distance light receiving pixels is sufficiently large to allow accurate distance calculation.

In the present embodiment, when the pixels 321 are driven according to the timing chart in FIG. 5A, the distance calculation unit 42 cannot apply the formula (1) in the process of calculating the distance to an object located at a short distance. This is because the charge storage units CS1 and CS2 are different from each other in the time during which the reflected light RL is received (exposure time) in each frame, and the charge storage units CS1 and CS3 are different from each other in the time during which external light is received (exposure time) in each frame. Thus, the distance calculation unit 42 performs correction so that the exposure time of the charge storage unit CS1 is equivalent to the exposure time of each of the charge storage units CS2 and CS3.

For example, for the short-distance light receiving pixels in the measurement mode M1, the distance calculation unit 42 calculates the delay time Td by applying the following formulas (3) and (4).

Q1 #=Q1×{(x+y)/x} (3)

Td=To×(Q2−Q3)/(Q1 #+Q2−2×Q2) (4)

In the formula (3), Q1 #represents the amount of charge stored in the charge storage unit CS1 (after correction), x represents the exposure time of the charge storage unit CS1 in the 1st STEP, y represents the exposure time of the charge storage units CS2 and CS3 in the 2nd STEP, and Q1 represents the amount of charge stored in the charge storage unit CS1. In the formula (4), To represents the period during which the light pulse PO is emitted, Q1 #represents the amount of charge stored in the charge storage unit CS1 (after correction), Q2 represents the amount of charge stored in the charge storage unit CS2, and Q3 represents the amount of charge stored in the charge storage unit CS3. In the formula (4), the amount of charge corresponding to the external light component of the amount of charge stored in the charge storage units CS1 and CS2 is assumed to be equal to the amount of charge stored in the charge storage unit CS3.

For the short-distance light receiving pixels of the present embodiment, the distance calculation unit 42 multiplies the delay time Td obtained using the formula (4) by the speed of light (speed) to calculate the round-trip distance to the object OB. Then, the distance calculation unit 42 calculates ½ of the calculated round-trip distance to obtain the distance to the object OB.

Applying the same concept, for the long-distance light receiving pixels, the distance calculation unit 42 calculates the delay time Td using the following formulas (5) and (6).

Q1 #=Q1×{(x+y)/x} (5)

Td=To×(Q3−Q1 #)/(Q2+Q3−2×Q1 #) (6)

In the formula (5), x represents the exposure time of the charge storage unit CS1 in the 1st STEP, y represents the exposure time of the charge storage units CS2 and CS3 in the 2nd STEP, and Q1 represents the amount of charge stored in the charge storage unit CS1. In the formula (6), To represents the period during which the light pulse PO is emitted, Q1 #represents the amount of charge after correction, Q2 represents the amount of charge stored in the charge storage unit CS2, and Q3 represents the amount of charge stored in the charge storage unit CS3. In the formula (6), the amount of charge corresponding to the external light component of the amount of charge stored in the charge storage units CS1 and CS2 is assumed to be equal to the amount of charge stored in the charge storage unit CS3.

For the long-distance light receiving pixels of the present embodiment, the distance calculation unit 42 multiplies the delay time Td obtained using the formula (6) by the speed of light (speed) to calculate the round-trip distance to the object OB. Then, the distance calculation unit 42 calculates ½ of the calculated round-trip distance to obtain the distance to the object OB.

Thus, in the present embodiment, to cause charge corresponding to the reflected light RL to be distributed to and stored in two of the charge storage units CS, control is performed so that the charge corresponding to the reflected light RL is stored in the two of the charge storage units CS for different periods of time (durations) (an example of “reflected light storage time”) in a single frame period according to the intensity of the reflected light RL. As described above, the intensity of the reflected light RL varies depending on the distance from the range imaging device to an object, the intensity of an emitted light pulse, and the reflectance of the object. For example, the present embodiment focuses on the fact that the intensity of the reflected light RL varies depending on the distance to an object, assuming that the intensity of the light pulse PO and the reflectance of the object are constant. Specifically, control is performed so that the time during which charge corresponding to the reflected light RL is stored varies depending on whether the pixels receive the reflected light RL reflected by the object OB located at a short distance.

In FIGS. 5A and 5B, in the case of receiving the reflected light RL reflected by the object OB located at a short distance as in the case shown in FIG. 5A, the intensity of the reflected light RL is higher than in the case of receiving the reflected light RL reflected by an object located at a long distance as in the case shown in FIG. 5B. If control is performed so that the time during which charge corresponding to the reflected light RL is stored is the same in the case shown in FIG. 5A and the case shown in FIG. 5B, in the case shown in FIG. 5A, the amount of charge corresponding to the reflected light RL is saturated, and in the case shown in FIG. 5B, a small amount of charge corresponding to the reflected light RL is stored. This may lead to distance measurement with low accuracy in both cases. In order to address this issue, the range image processing unit 4 performs control so that no saturation occurs in the charge storage units CS in the case of receiving the reflected light RL having a high intensity and that a large amount of charge is stored in the charge storage units CS in the case of receiving the reflected light RL having a low intensity. That is, the range image processing unit 4 performs control so that the reflected light storage time of the charge storage unit CS1 is shorter than the reflected light storage time of the charge storage unit CS2 in a single frame period. This makes it possible to prevent saturation of the charge storage unit CS1 in which charge corresponding to the reflected light RL having a higher intensity is stored and to store a large amount of charge in the other charge storage units CS (the charge storage units CS2 and CS3) in which charge corresponding to the reflected light RL having a lower intensity is stored. The charge storage units CS1 and CS2 in FIG. 5A are an example of “two of the charge storage units to which charge corresponding to the reflected light RL is distributed and in which the charge is stored”.

Specifically, in FIGS. 5A and 5B, the 1st STEP and the 2nd STEP are provided in a single frame period. In the 1st STEP, charge is stored in all the charge storage units CS1 to CS3. In the 2nd STEP, the relative timing of emission of the light pulse PO and charge storage in the charge storage units CS is the same as in the 1st STEP, and no charge is stored in charge storage unit CS1, but charge is stored in charge storage units CS2 and CS3. Thus, the range image processing unit 4 performs control so that the reflected light storage time of the charge storage unit CS1 is shorter than the reflected light storage time of the charge storage unit CS2 in a single frame period. More specifically, the range image processing unit 4 sets the reflected light storage time of the charge storage unit CS1 to (x), and sets the reflected light storage time of the charge storage unit CS2 to (x+y). Here, x represents the exposure time of each of the charge storage units CS1 to CS3 in the 1st STEP, and y represents the exposure time of each of the charge storage units CS2 and CS3 in the 2nd STEP.

When an object located at a short distance and an object located at a long distance are both present in the measurement distance range, the distance calculation unit 42 can measure with higher accuracy the distance to the object located at a long distance by applying the formula (4) or (6) according to the pixels. However, the distance calculation unit 42 cannot determine in advance one of the formulas (4) and (6) to be applied to the pixels 321. Thus, in the process of calculating the distance, the distance calculation unit 42 compares the amount of charge Q1 after correction (i.e., the amount of charge Q1 #) with the amount of charge Q3 to determine one of the formulas (4) and (6) to be applied to the pixels 321.

As described above, in the pixels 321 as the short-distance light receiving pixels, the reflected light RL from the object OB is distributed to and received by the charge storage units CS1 and CS2, and an external light component is received by the charge storage unit CS3. In this case, the amount of charge Q1 #is larger than the amount of charge Q3. Using this property, the distance calculation unit 42 determines that a pixel 321 in which the amount of charge Q1 #is larger than the amount of charge Q3 is a short-distance light receiving pixel, and selects the formula (4) to calculate the distance for the pixel 321.

On the other hand, in the pixels 321 as the long-distance light receiving pixels, the reflected light RL from the object OB is distributed to and received by the charge storage units CS2 and CS3, and an external light component is received by the charge storage unit CS1. In this case, the amount of charge Q1 #is smaller than the amount of charge Q3. Using this property, the distance calculation unit 42 determines that a pixel 321 in which the amount of charge Q1 #is smaller than or equal to the amount of charge Q3 is a long-distance light receiving pixel and selects the formula (6) to calculate the distance for the pixel 321.

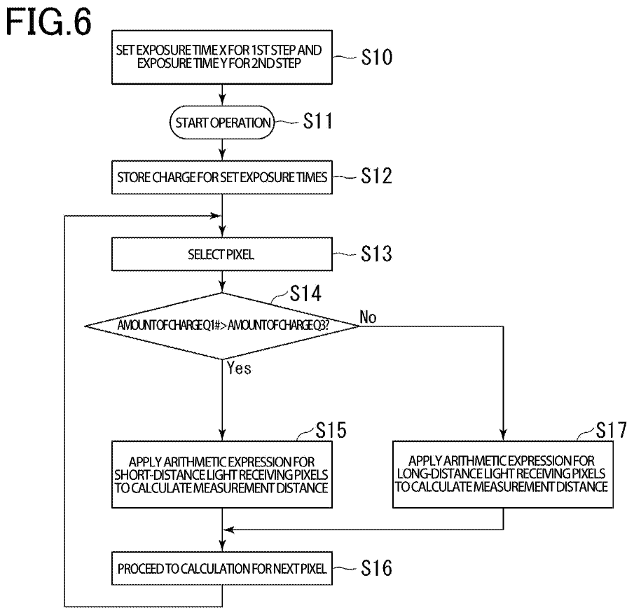

A flow of the process performed by the range imaging device 1 in the measurement mode M1 of the first embodiment will be described with reference to FIG. 6.

### Step S10

First, the range imaging device 1 causes the measurement control unit 43 to set in advance the exposure time x for the 1st STEP and the exposure time y for the 2nd STEP.

### Step S11

The range imaging device 1 starts operation. The range imaging device 1 is triggered, for example, by an action such as depression of an imaging button by an operator and starts an operation for distance measurement.

### Step S12

The range imaging device 1 causes charge to be stored in the charge storage units CS for the exposure times x and y set in advance. For example, the range imaging device 1 performs an operation corresponding to the timing in the 1st STEP to cause charge corresponding to the exposure time x to be stored in the charge storage units CS1 to CS3. Furthermore, the range imaging device 1 performs an operation corresponding to the timing in the 2nd STEP to cause charge corresponding to the exposure time y to be stored in the charge storage units CS2 and CS3.

### Step S13

After charge for each frame is stored in each of the multiple pixels 321 provided in the range imaging device 1, the range imaging device 1 selects one of the pixels 321 for which distance calculation is performed.

### Step S14

The range imaging device 1 determines whether in the selected pixel 321, the amount of charge Q1 #as the amount of charge after correction is larger than the amount of charge Q3. The range imaging device 1 uses the formula (3) to calculate the amount of charge Q1 #as the amount of charge after correction and compares the calculated amount of charge Q1 #with the amount of charge Q3 to determine whether the amount of charge Q1 #is larger than the amount of charge Q3.

### Step S15

When the amount of charge Q1 #is larger than the amount of charge Q3, the range imaging device 1 applies the arithmetic expression corresponding to the short-distance light receiving pixels in the measurement mode M1 (the formula (4)) to calculate the measurement distance.

### Step S16

The range imaging device 1 proceeds to the process for a next pixel 321, and control returns to step S13. For example, the range imaging device 1 holds the distance calculated for the pixel 321 in association with the position coordinates of the pixel 321, and proceeds to the process of distance calculation for one of the pixels 321 for which distance calculation has not yet been performed.

### Step S17

On the other hand, when the amount of charge Q1 #is smaller than or equal to the amount of charge Q3 in step S14, the range imaging device 1 applies the arithmetic expression corresponding to the long-distance light receiving pixels in the measurement mode M1 (the formula (6)) to calculate the measurement distance. After calculation, control proceeds to step S16, and the range imaging device 1 proceeds to the process for a next pixel 321.

### Measurement Mode M2

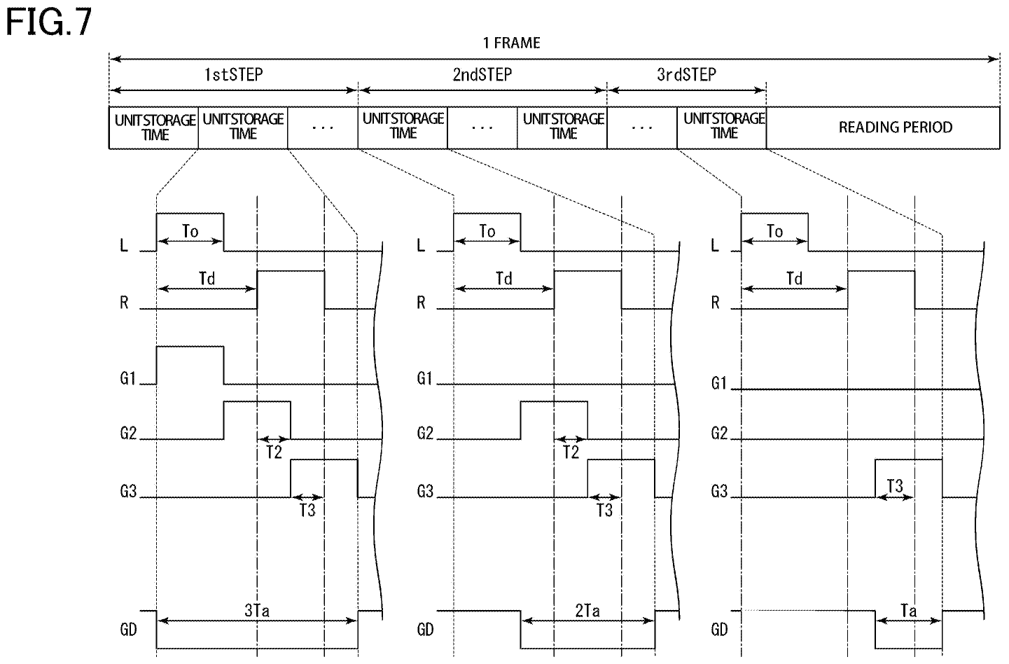

Next, a measurement mode M2 will be described with reference to FIG. 7. FIG. 7 is a timing chart showing a second example of the timing at which the pixels 321 are driven in the first embodiment. FIG. 7 shows a timing chart for the pixels that receive the reflected light RL from an object at a long distance (long-distance light receiving pixels). The symbols such as “L”, “R”, and “G1” in FIG. 7 are the same as those in FIG. 4A.

As shown in FIG. 7, in the present embodiment, three measurement steps (1st STEP, 2nd STEP, and 3rd STEP) are provided in each frame. In the 1st STEP, the measurement control unit 43 performs charge storage operation by applying the conventional timing. In the 2nd STEP, the measurement control unit 43 performs charge storage operation by applying the same timing as in the 2nd STEP in the measurement mode M1.

In the 3rd STEP, the measurement control unit 43 performs control so that no charge is stored in the charge storage unit CS1 or CS2, but charge is stored only in the charge storage unit CS3. Specifically, as shown in FIG. 7, in the 3rd STEP, the vertical scanning circuit 323 does not control the reading gate transistor G1 or G2 to be in the ON state. Instead, the vertical scanning circuit 323 switches the reading gate transistor G3 to the ON state at the same timing as in the 1st STEP.

Specifically, at the timing at which twice the storage time Ta has elapsed from emission of the light pulse PO, the vertical scanning circuit 323 switches the drain gate transistor GD to the OFF state and switches the reading gate transistor G3 to the ON state. When the storage time Ta has elapsed after the reading gate transistor G3 is switched to the ON state, the vertical scanning circuit 323 switches the reading gate transistor G3 to the OFF state. Thus, charge generated through photoelectric conversion by the photoelectric conversion device PD while the reading gate transistor G3 is controlled to be in the ON state is stored in the charge storage unit CS3 via the reading gate transistor G3.

At the timing at which the storage of charge in the charge storage unit CS3 is terminated, the vertical scanning circuit 323 switches the drain gate transistor GD to the ON state for discharge. Thus, charge generated through photoelectric conversion by the photoelectric conversion device PD is eliminated via the drain gate transistor GD. That is, in the 3rd STEP, the drain gate transistor GD is in the OFF state for the time (1×Ta) during which charge is stored in the charge storage unit CS3.

With the above configuration, in the present embodiment, the charge storage units CS1 to CS3 provided in each of the pixels can have different exposure times (exposure times with different durations). This makes it possible to store a larger amount of charge in the charge storage units CS1 to CS3 without causing saturation.

An example will be described in which an object located at a short distance, an object located at a medium distance, and an object located at a long distance are all present in the measurement distance range. An object located at a medium distance is an object located at a distance at which a higher ratio of charge is stored in the charge storage unit CS2 when the reflected light RL is distributed to and stored in the charge storage units CS1 and CS2. In this case, if a larger number of distributions is performed in the 2nd STEP, saturation may occur in the charge storage unit CS2 of medium-distance light receiving pixels (pixels 321 that receive the reflected light RL from an object located at a medium distance). In such a case, it is possible to set the number of distributions in the 2nd STEP so that no saturation occurs in the charge storage unit CS2 of the medium-distance light receiving pixels and to store a larger amount of charge in the charge storage unit CS3 of the long-distance light receiving pixels in the 3rd STEP.

When the measurement mode M2 is applied, the distance calculation unit 42 calculates the delay time Td by applying the following formulas (7) to (10).

Q1##=Q1×{(x+y+z)/x} (7)

Q2#=Q2×{(x+y+z)/(x+y)} (8)

Td=To×(Q2#−Q3)/(Q1##+Q2−2×Q3) (9)

Td=To×(Q3−Q1 ##)/(Q2#+Q3−2×Q1 ##) (10)

In the formula (7), Q1 ##represents the amount of charge stored in the charge storage unit CS1 (after correction), x represents the exposure time of the charge storage unit CS1 in the 1st STEP, y represents the exposure time of the charge storage units CS2 and CS3 in the 2nd STEP, z represents the exposure time of the charge storage unit CS3 in the 3rd STEP, and Q1 represents the amount of charge stored in the charge storage unit CS1. In the formula (8), Q2 #represents the amount of charge stored in the charge storage unit CS2 (after correction), and Q2 represents the amount of charge stored in the charge storage unit CS2. In the formula (9), Td represents the delay time for the short-distance light receiving pixels. In the formula (10), Td represents the delay time for the long-distance light receiving pixels. In the formulas (9) and (10), To represents the period during which the light pulse PO is emitted, Q1 ##represents the amount of charge stored in the charge storage unit CS1 (after correction), Q2 represents the amount of charge stored in the charge storage unit CS2, and Q3 represents the amount of charge stored in the charge storage unit CS3. In the formula (9), the amount of charge corresponding to the external light component of the amount of charge stored in the charge storage units CS1 and CS2 is assumed to be equal to the amount of charge stored in the charge storage unit CS3. In the formula (10), the amount of charge corresponding to the external light component of the amount of charge stored in the charge storage units CS2 and CS3 is assumed to be equal to the amount of charge stored in the charge storage unit CS1.

Thus, in the present embodiment, to cause charge corresponding to the reflected light RL to be distributed to and stored in two of the charge storage units CS, control is performed so that the charge corresponding to the reflected light RL is stored in the two of the charge storage units CS for different periods of time (durations) (an example of “reflected light storage time”) in a single frame period according to the intensity of the reflected light RL. For example, the present embodiment focuses on the fact that the intensity of the reflected light RL varies depending on the distance to an object, assuming that the intensity of the light pulse PO and the reflectance of the object are constant.

In the case of receiving the reflected light RL reflected by the object OB located at a medium distance as in the case shown in FIG. 7, the intensity of the reflected light RL is higher than in the case of receiving the reflected light RL reflected by an object located at a long distance. If control is performed so that the time during which charge corresponding to the reflected light RL is stored is the same in the case shown in FIG. 7 and the case of receiving the reflected light RL reflected by an object located at a long distance, in the case shown in FIG. 7, the amount of charge corresponding to the reflected light RL is saturated, and in the case of receiving the reflected light RL reflected by an object located at a long distance, a small amount of charge corresponding to the reflected light RL is stored. This may lead to distance measurement with low accuracy in both cases. In order to address this issue, the range image processing unit 4 performs control so that no saturation occurs in the charge storage units CS in the case of receiving reflected light RL having a high intensity and that a large amount of charge is stored in the charge storage units CS in the case of receiving the reflected light RL having a low intensity. That is, the range image processing unit 4 performs control so that the reflected light storage time of the charge storage unit CS2 is shorter than the reflected light storage time of the charge storage unit CS3 in a single frame period. This makes it possible to prevent saturation of the charge storage unit CS2 in which charge corresponding to the reflected light RL having a higher intensity is stored and to store a large amount of charge in the other charge storage unit CS (the charge storage unit CS3) in which charge corresponding to the reflected light RL having a lower intensity is stored. The charge storage units CS2 and CS3 in FIG. 7 are an example of “two of the charge storage units to which charge corresponding to the reflected light RL is distributed and in which the charge is stored”.

Specifically, in FIG. 7, the 1st STEP, the 2nd STEP, and the 3rd STEP are provided in a single frame period. In the 1st STEP, charge is stored in all the charge storage units CS1 to CS3. In the 2nd STEP, the relative timing of emission of the light pulse PO and charge storage in the charge storage units CS is the same as in the 1st STEP, and no charge is stored in the charge storage unit CS1, but charge is stored in the charge storage units CS2 and CS3. In the 3rd STEP, no charge is stored in the charge storage unit CS1 or CS2, but charge is stored only in the charge storage unit CS3. Thus, the range image processing unit 4 performs control so that the reflected light storage time of the charge storage unit CS2 is shorter than the reflected light storage time of the charge storage unit CS3 in a single frame period. More specifically, the range image processing unit 4 sets the reflected light storage time of the charge storage unit CS2 to (x+y), and sets the reflected light storage time of the charge storage unit CS3 to (x+y+z). Here, x represents the exposure time of each of the charge storage units CS1 to CS3 in the 1st STEP, y represents the exposure time of each of the charge storage units CS2 and CS3 in the 2nd STEP, and z represents the exposure time of the charge storage unit CS3 in the 3rd STEP.

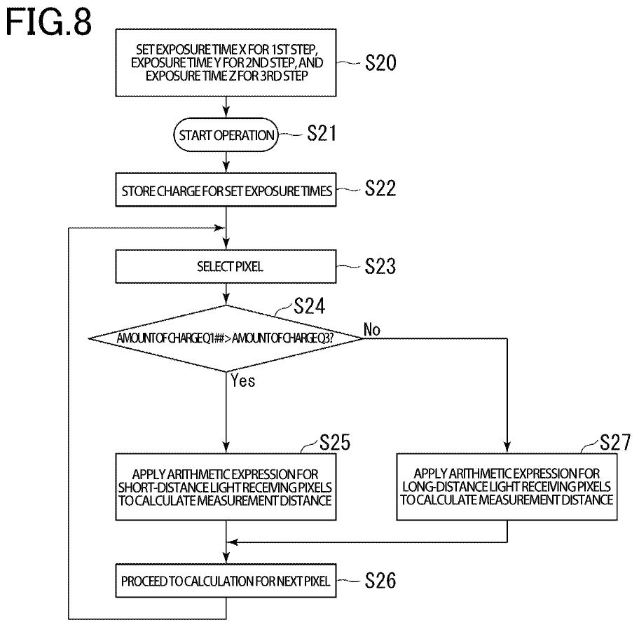

A flow of the process performed by the range imaging device 1 in the measurement mode M2 of the first embodiment will be described with reference to FIG. 8. Steps S21, S23, and S26 in the flowchart shown in FIG. 8 are similar to steps S11, S13, and S16 in FIG. 6, and are thus not described.

### Step S20

First, the range imaging device 1 causes the measurement control unit 43 to set in advance the exposure time x for the 1st STEP, the exposure time y for the 2nd STEP, and the exposure time z for the 3rd STEP.

### Step S22

The range imaging device 1 causes charge to be stored in the charge storage units CS for the exposure times x, y, and z set in advance. For example, the range imaging device 1 performs an operation corresponding to the timing in the 1st STEP to cause charge corresponding to the exposure time x to be stored in the charge storage units CS1 to CS3. Furthermore, the range imaging device 1 performs an operation corresponding to the timing in the 2nd STEP to cause charge corresponding to the exposure time y to be stored in the charge storage units CS2 and CS3. Furthermore, the range imaging device 1 performs an operation corresponding to the timing in the 3rd STEP to cause charge corresponding to the exposure time z to be stored in the charge storage unit CS3.

### Step S24

The range imaging device 1 determines whether in the selected pixel 321, the amount of charge Q1 ##as the amount of charge after correction is larger than the amount of charge Q3. The range imaging device 1 uses the formula (7) to calculate the amount of charge Q1 ##as the amount of charge after correction, and compares the calculated amount of charge Q1 ##with the amount of charge Q3 to determine whether the amount of charge Q1 ##is larger than the amount of charge Q3.

### Step S25

When the amount of charge Q1 ##is larger than the amount of charge Q3, the range imaging device 1 applies the arithmetic expression corresponding to the short-distance light receiving pixels in the measurement mode M2 (the formula (9)) to calculate the measurement distance. The range imaging device 1 uses the formula (8) to calculate the amount of charge Q2 #as the amount of charge after correction, and applies the calculated amount of charge Q2 #, the amount of charge Q1 ##calculated earlier, and the amount of charge Q3 to the formula (9) to calculate the delay time Td. Based on the calculated delay time Td, the range imaging device 1 calculates the measurement distance for the pixels 321 (short-distance light receiving pixels).

### Step S27

On the other hand, when the amount of charge Q1 ##is smaller than or equal to the amount of charge Q3 in step S24, the range imaging device 1 applies the arithmetic expression corresponding to the long-distance light receiving pixels in the measurement mode M2 (the formula (10)) to calculate the measurement distance. The range imaging device 1 uses the formula (8) to calculate the amount of charge Q2 #as the amount of charge after correction, and applies the calculated amount of charge Q2 #, the amount of charge Q1 ##calculated earlier, and the amount of charge Q3 to the formula (10) to calculate the delay time Td. Based on the calculated delay time Td, the range imaging device 1 calculates the measurement distance for the pixels 321 (long-distance light receiving pixels).

In the example described above, the objects are located at a short distance and at a long distance. The distance range is determined according to, for example, the emission time To of the light pulse PO, and the duration indicated by the distribution time Ta for the charge storage units CS. The speed of light is known, and light is known to travel approximately 300,000 km per second. Thus, light travels 15 cm per nanosecond (ns) for half of a round trip. For example, when the emission time To of the light pulse PO is 10 ns, the short distance can be in the range of approximately 0 to 150 cm, and the long distance can be in the range of approximately 150 cm to 300 cm.

In order to further increase the measurable distance range, the emission time To of the light pulse and the storage time Ta for the charge storage units CS (durations) may be increased. However, emission of the light pulse PO for a longer time leads to a lower distance resolution. Thus, a trade-off between the measurement distance range and the resolution is considered in selecting the desired setting (the emission time To and the storage time Ta).

A possible method of increasing the measurable distance while maintaining the resolution is to increase the number of charge storage units CS. By increasing the number of charge storage units CS, even when an increase in the distance to the object OB leads to an increase in the delay time Td, the reflected light RL from the object OB can be distributed to and received by the charge storage units CS. A case in which the number of charge storage units CS is increased to four will be described below as a second embodiment.

### Second Embodiment

Next, the second embodiment will be described. The present embodiment is different from the embodiment described above in that each of the pixels 321 of the range imaging device 1 includes four charge storage units CS (charge storage units CS1 to CS4) and that a charge storage unit CS for storing only the external light component is determined (fixed) in advance. The second embodiment is different from the embodiment described above in the timing at which driving reading gate transistors G1 to G4 are driven. The charge storage unit CS4 is an example of “fourth charge storage unit”.

Measurement Mode M3

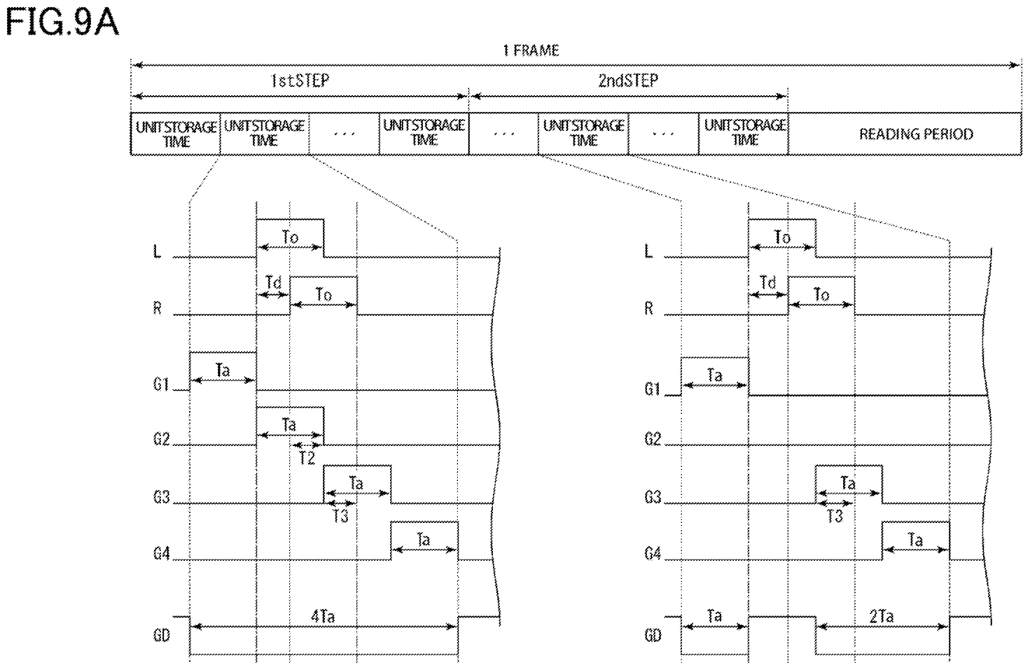

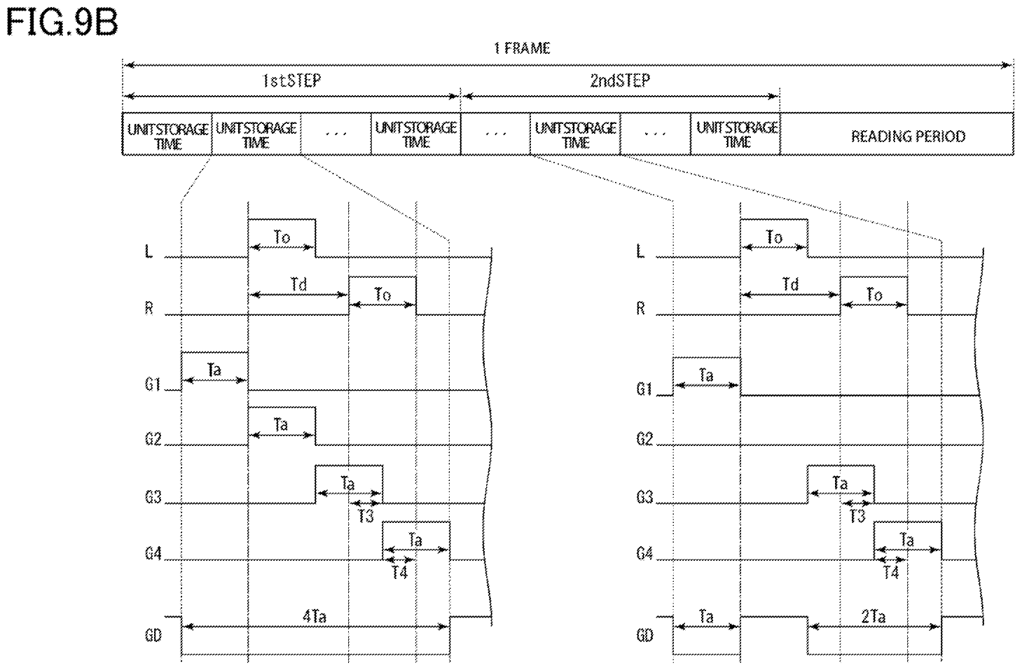

First, a measurement mode M3 of the present embodiment will be described with reference to FIGS. 9A and 9B. FIGS. 9A and 9B are a timing chart showing a first example of the timing at which the pixels 321 are driven in the second embodiment. FIG. 9A shows a timing chart for the short-distance light receiving pixels. FIG. 9B shows a timing chart for the long-distance light receiving pixels. The symbols such as “L”, “R”, and “G1” in FIGS. 9A and 9B are the same as those in FIG. 4A.

In the measurement mode M3, only the external light component is stored in the charge storage unit CS1. In the following, an example will be described in which in the measurement mode M3, at the timing at which the charge storage unit CS1 is switched to the OFF state after the charge storage unit CS1 is controlled to be in the ON state for the storage time Ta, the light pulse PO is emitted. This enables only the external light component to be stored in the charge storage unit CS1.

As shown in FIGS. 9A and 9B, in the measurement mode M3 of the present embodiment, two measurement steps (1st STEP and 2nd STEP) are provided in each frame.

In the 1st STEP in the measurement mode M3, charge storage operation is performed by applying a conventional driving method. The conventional driving method may be, for example, a method of sequentially storing charge via the reading gate transistors G1 to G4 in synchronization with the timing at which the light pulse PO is emitted, as shown in FIGS. 9A and 9B.

Specifically, as shown in FIG. 9A, in the 1st STEP, first, the vertical scanning circuit 323 switches the drain gate transistor GD to the OFF state and causes the reading gate transistor G1 to be in the ON state for the storage time Ta. The vertical scanning circuit 323 causes the light pulse PO not to be emitted while the reading gate transistor G1 is in the ON state. Thus, charge corresponding to the external light component is stored in the charge storage unit CS1 via the reading gate transistor G1 while the reading gate transistor G1 is controlled to be in the ON state.

Then, at the timing at which the reading gate transistor G1 is switched to the OFF state, the vertical scanning circuit 323 causes the light pulse PO to be emitted for the emission time To and causes the reading gate transistor G2 to be in the ON state for the storage time Ta. Thus, charge corresponding to a part of the external light component and the reflected light RL is stored in the charge storage unit CS2 via the reading gate transistor G2 while the reading gate transistor G2 is controlled to be in the ON state.

Then, at the timing at which the reading gate transistor G2 is switched to the OFF state, the vertical scanning circuit 323 causes the reading gate transistor G3 to be in the ON state for the storage time Ta. Thus, charge corresponding to the remaining part of the external light component and the reflected light RL is stored in the charge storage unit CS3 via the reading gate transistor G3 while the reading gate transistor G3 is controlled to be in the ON state.

Then, at the timing at which the reading gate transistor G3 is switched to the OFF state, the vertical scanning circuit 323 causes the reading gate transistor G4 to be in the ON state for the storage time Ta. Thus, charge corresponding to the external light component and the reflected light RL is stored in the charge storage unit CS4 via the reading gate transistor G4 while the reading gate transistor G4 is controlled to be in the ON state.

Then, at the timing at which the reading gate transistor G4 is switched to the OFF state, the vertical scanning circuit 323 switches the drain gate transistor GD to the ON state for discharge. Thus, charge generated through photoelectric conversion by the photoelectric conversion device PD is eliminated via the drain gate transistor GD.

The vertical scanning circuit 323 repeatedly drives the pixels as described above for a predetermined number of distributions in the 1st STEP. In this case, the number of distributions in the 1st STEP is set so that no saturation occurs in the charge storage unit CS2 of the short-distance light receiving pixels.

In the 2nd STEP in the measurement mode M3, control is performed so that no charge is stored in the charge storage unit CS2, but charge is stored in the charge storage units CS1, CS3, and CS4. Specifically, as shown in FIG. 9A, in the 2nd STEP, the vertical scanning circuit 323 does not control the reading gate transistor G2 to be in the ON state. Instead, the vertical scanning circuit 323 switches the reading gate transistors G1, G3, and G4 to the ON state at the same timing as in the 1st STEP.

Specifically, first, the vertical scanning circuit 323 causes the reading gate transistor G1 to be in the ON state for the storage time Ta. Then, at the timing at which the reading gate transistor G1 is switched to the OFF state, the vertical scanning circuit 323 causes the light pulse PO to be emitted for the emission time To. Then, at the timing at which emission of the light pulse PO is terminated, the vertical scanning circuit 323 causes the reading gate transistor G3 to be in the ON state for the storage time Ta. Then, at the timing at which the reading gate transistor G3 is switched to the OFF state, the vertical scanning circuit 323 causes the reading gate transistor G4 to be in the ON state for the storage time Ta. Then, at the timing at which the reading gate transistor G4 is switched to the OFF state, the vertical scanning circuit 323 switches the drain gate transistor GD to the ON state for discharge. In the 2nd STEP in the measurement mode M3, the drain gate transistor GD is in the OFF state for the time (storage time Ta) during which charge is stored in the charge storage unit CS1 and for the time (2×Ta) during which charge is stored in the charge storage units CS3 and CS4.

The vertical scanning circuit 323 repeatedly drives the pixels as described above for a predetermined number of distributions in the 2nd STEP. Then, the vertical scanning circuit 323 outputs a voltage signal corresponding to the amount of charge distributed to each of the charge storage units CS. The vertical scanning circuit 323 outputs a voltage signal corresponding to the amount of charge in the same manner as shown in FIG. 4A and is thus not described.

With the above configuration, in the case of the short-distance light receiving pixels as shown in FIG. 9A, charge can be distributed to and stored in the charge storage units CS2 and CS3, and in the case of the long-distance light receiving pixels as shown in FIG. 9B, charge can be distributed to and stored in the charge storage units CS3 and CS4. Furthermore, in the present embodiment, in each of the pixels, the charge storage unit CS2 can have an exposure time (with a duration) different from that of the charge storage units CS1, CS3, and CS4. This makes it possible to store charge without causing saturation of the charge storage unit CS2 of the short-distance light receiving pixels and to store a larger amount of charge in the charge storage units CS3 and CS4 of the long-distance light receiving pixels. Thus, even when an object located at a short distance and an object located at a long distance are both present in the measurement distance range, it is possible to perform accurate measurement for the object located at a long distance.

The number of distributions in the 1st STEP and the 2nd STEP in the measurement mode M3 of the present embodiment may be set to any number of distributions according to the situation. For example, the number of distributions in the 1st STEP is set not to exceed the upper limit of the number of distributions that does not cause saturation of the charge storage unit CS2 of the short-distance light receiving pixels. The number of distributions in the 2nd STEP is set so that no saturation occurs in the charge storage unit CS3 or CS4 of the pixels 321 (including the short-distance light receiving pixels and the long-distance light receiving pixels) and that the amount of charge stored in the charge storage units CS3 and CS4 of the long-distance light receiving pixels is sufficiently large to allow accurate distance calculation.

In the present embodiment, when the pixels 321 are driven according to the timing chart in FIG. 9A, the distance calculation unit 42 performs correction so that the exposure time of the charge storage unit CS2 is equivalent to the exposure time of each of the other charge storage units CS (the charge storage units CS1, CS3, and CS4).

For example, for the short-distance light receiving pixels in the measurement mode M3, the distance calculation unit 42 calculates the delay time Td by applying the following formulas (11) and (12).

Q2#=Q2×{(x+y)/x} (11)

Td=To×(Q3−Q1)/(Q2#+Q3−2×Q1) (12)

In the formula (11), x represents the exposure time of the charge storage unit CS2 in the 1st STEP, y represents the exposure time of the other charge storage units CS in the 2nd STEP, and Q2 represents the amount of charge stored in the charge storage unit CS2. In the formula (12), To represents the period during which the light pulse PO is emitted, Q2 #represents the amount of charge after correction, Q1 represents the amount of charge stored in the charge storage unit CS1, and Q3 represents the amount of charge stored in the charge storage unit CS3. In the formula (12), the amount of charge corresponding to the external light component of the amount of charge stored in the charge storage units CS2 and CS3 is assumed to be equal to the amount of charge stored in the charge storage unit CS1.

For example, for the long-distance light receiving pixels in the measurement mode M3, the distance calculation unit 42 calculates the delay time Td by applying the following formula (13).

Td=To×(Q4−Q1)/(Q3+Q4−2×Q1) (13)

In the formula (13), To represents the period during which the light pulse PO is emitted, Q1 represents the amount of charge stored in the charge storage unit CS1, Q3 represents the amount of charge stored in the charge storage unit CS3, and Q4 represents the amount of charge stored in the charge storage unit CS4. In the formula (13), the amount of charge corresponding to the external light component of the amount of charge stored in the charge storage units CS3 and CS4 is assumed to be equal to the amount of charge stored in the charge storage unit CS1.

When an object located at a short distance and an object located at a long distance are both present in the measurement distance range, the distance calculation unit 42 can measure with higher accuracy the distance to the object located at a long distance by applying the formula (12) or (13) according to the pixels. In the process of calculating the distance, the distance calculation unit 42 compares the amount of charge Q2 after correction (i.e., the amount of charge Q2 #) with the amount of charge Q4 to determine one of the formulas (12) and (13) to be applied to the pixels 321.

As described above, in the pixels 321 as the short-distance light receiving pixels, the reflected light RL from the object OB is distributed to and received by the charge storage units CS2 and CS3, and an external light component is received by the charge storage units CS1 and CS4. In this case, the amount of charge Q2 #is larger than the amount of charge Q4. Using this property, the distance calculation unit 42 determines that a pixel 321 in which the amount of charge Q2 #is larger than the amount of charge Q4 is a short-distance light receiving pixel, and selects the formula (12) to calculate the distance for the pixel 321.

On the other hand, in the pixels 321 as the long-distance light receiving pixels, the reflected light RL from the object OB is distributed to and received by the charge storage units CS3 and CS4, and an external light component is received by the charge storage units CS1 and CS2. In this case, the amount of charge Q2 #is smaller than the amount of charge Q4. Using this property, the distance calculation unit 42 determines that a pixel 321 in which the amount of charge Q2 #is smaller than or equal to the amount of charge Q4 is a long-distance light receiving pixel and selects the formula (13) to calculate the distance for the pixel 321.

Thus, in the present embodiment, to cause charge corresponding to the reflected light RL to be distributed to and stored in two of the charge storage units CS, control is performed so that the charge corresponding to the reflected light RL is stored in the two of the charge storage units CS for different durations (an example of “reflected light storage time”) in a single frame period according to the intensity of the reflected light RL. For example, the present embodiment focuses on the fact that the intensity of the reflected light RL varies depending on the distance to an object, assuming that the intensity of the light pulse PO and the reflectance of the object are constant.

In FIGS. 9A and 9B, in the case of receiving the reflected light RL reflected by the object OB located at a short distance as in the case shown in FIG. 9A, the intensity of the reflected light RL is higher than in the case of receiving the reflected light RL reflected by an object located at a long distance as in the case shown in FIG. 9B. If control is performed so that the time during which charge corresponding to the reflected light RL is stored is the same in the case shown in FIG. 9A and the case shown in FIG. 9B, in the case shown in FIG. 9A, the amount of charge corresponding to the reflected light RL is saturated, and in the case shown in FIG. 9B, a small amount of charge corresponding to the reflected light RL is stored. This may lead to distance measurement with low accuracy in both cases. In order to address this issue, the range image processing unit 4 performs control so that no saturation occurs in the charge storage units CS in the case of receiving reflected light RL having a high intensity and that a large amount of charge is stored in the charge storage units CS in the case of receiving the reflected light RL having a low intensity. That is, the range image processing unit 4 performs control so that the reflected light storage time of the charge storage unit CS2 is shorter than the reflected light storage time of the charge storage unit CS3 in a single frame period. This makes it possible to prevent saturation of the charge storage unit CS2 in which charge corresponding to the reflected light RL having a higher intensity is stored and to store a large amount of charge in the other charge storage units CS (the charge storage units CS3 and CS4) in which charge corresponding to the reflected light RL having a lower intensity is stored. The charge storage units CS2 and CS3 in FIG. 9A are an example of “two of the charge storage units to which charge corresponding to the reflected light RL is distributed and in which the charge is stored”.

Specifically, in FIGS. 9A and 9B, the 1st STEP and the 2nd STEP are provided in a single frame period. In the 1st STEP, charge is stored in all the charge storage units CS1 to CS4. In the 2nd STEP, the relative timing of emission of the light pulse PO and charge storage in the charge storage units CS is the same as in the 1st STEP, and no charge is stored in the charge storage unit CS2, but charge is stored in the charge storage units CS1, CS3, and CS4. Thus, the range image processing unit 4 performs control so that the reflected light storage time of the charge storage unit CS2 is shorter than the reflected light storage time of the charge storage unit CS3 in a single frame period. More specifically, the range image processing unit 4 sets the reflected light storage time of the charge storage unit CS2 to (x) and sets the reflected light storage time of the charge storage unit CS3 to (x+y). Here, x represents the exposure time of each of the charge storage units CS1 to CS4 in the 1st STEP, and y represents the exposure time of each of the charge storage units CS1, CS3, and CS4 in the 2nd STEP.

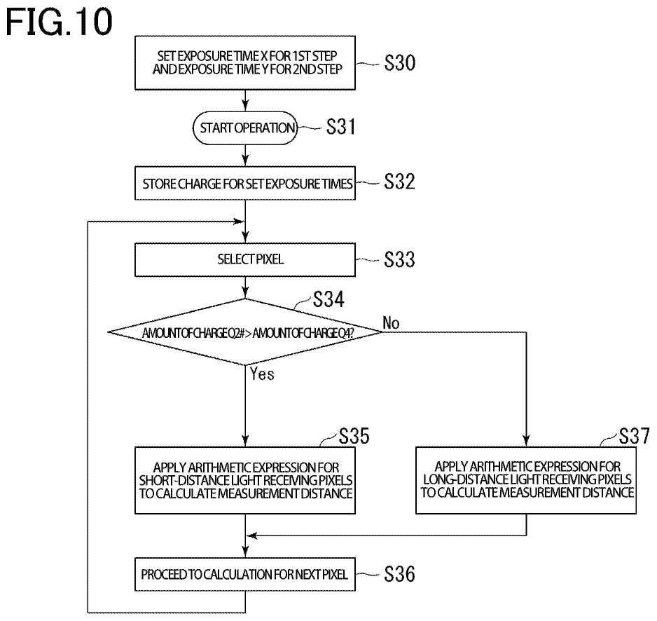

A flow of the process performed by the range imaging device 1 in the measurement mode M3 of the second embodiment will be described with reference to FIG. 10. Steps S30, S31, S33, and S36 in the flowchart shown in FIG. 10 are similar to steps S10, S11, S13, and S16 in FIG. 6, and are thus not described.

### Step S32

The range imaging device 1 causes charge to be stored in the charge storage units CS for the exposure times x and y set in advance. For example, the range imaging device 1 performs an operation corresponding to the timing in the 1st STEP to cause charge corresponding to the exposure time x to be stored in the charge storage units CS1 to CS4. Furthermore, the range imaging device 1 performs an operation corresponding to the timing in the 2nd STEP to cause charge corresponding to the exposure time y to be stored in the charge storage units CS1, CS3, and CS4.

### Step S34

The range imaging device 1 determines whether in the selected pixel 321, the amount of charge Q2 #as the amount of charge after correction is larger than the amount of charge Q4. The range imaging device 1 uses the formula (11) to calculate the amount of charge Q2 #as the amount of charge after correction and compares the calculated amount of charge Q2 #with the amount of charge Q4 to determine whether the amount of charge Q2 #is larger than the amount of charge Q4.

### Step S35

When the amount of charge Q2 #is larger than the amount of charge Q4, the range imaging device 1 applies the arithmetic expression corresponding to the short-distance light receiving pixels in the measurement mode M3 (the formula (12)) to calculate the measurement distance. The range imaging device 1 applies the amount of charge Q2 #calculated in step S34 and the amounts of charge Q1 and Q3 to the formula (12) to calculate the delay time Td. Based on the calculated delay time Td, the range imaging device 1 calculates the measurement distance for the pixels 321 (short-distance light receiving pixels).

### Step S37

On the other hand, when the amount of charge Q2 #is smaller than or equal to the amount of charge Q4 in step S34, the range imaging device 1 applies the arithmetic expression corresponding to the long-distance light receiving pixels in the measurement mode M3 (the formula (13)) to calculate the measurement distance. The range imaging device 1 applies the amounts of charge Q1, Q3, and Q4 to the formula (13) to calculate the delay time Td. Based on the calculated delay time Td, the range imaging device 1 calculates the measurement distance for the pixels 321 (long-distance light receiving pixels).

### Measurement Mode M4

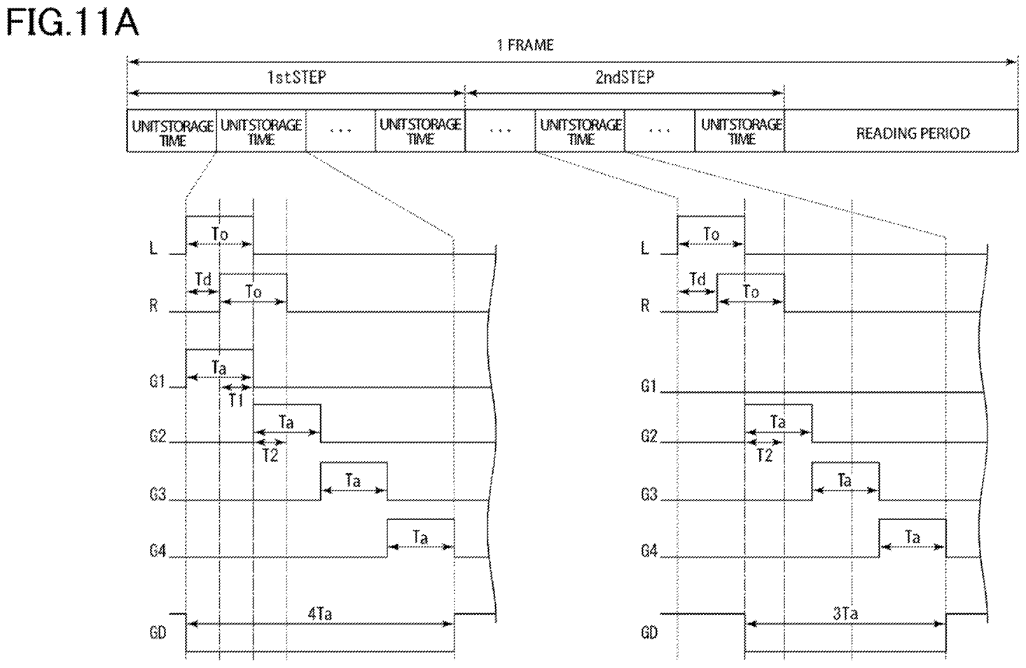

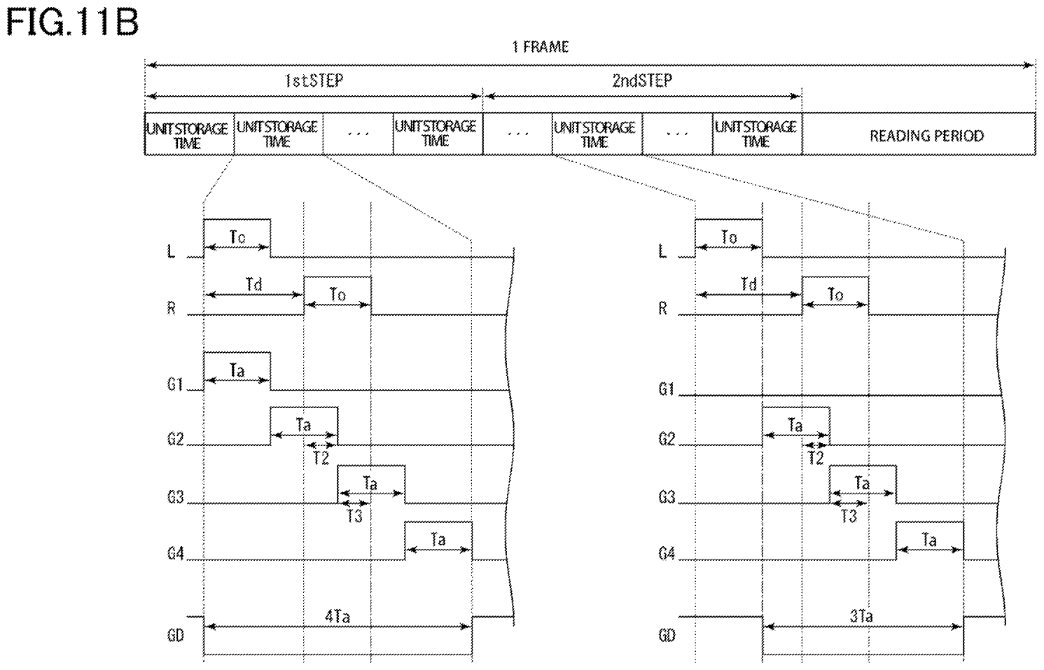

Next, a measurement mode M4 of the present embodiment will be described with reference to FIGS. 11A and 11B. FIGS. 11A and 11B are a timing chart showing a second example of the timing at which the pixels 321 are driven in the second embodiment. FIG. 11A shows a timing chart for the short-distance light receiving pixels. FIG. 11B shows a timing chart for the long-distance light receiving pixels. The symbols such as “L”, “R”, and “G1” in FIGS. 11A and 11B are the same as those in FIG. 4A.

In the measurement mode M4, only the external light component is stored in the charge storage unit CS4. In the following, an example will be described in which in the measurement mode M4, the charge storage unit CS4 is controlled to be in the ON state for the storage time Ta, when after emission of the light pulse PO, sufficient time has elapsed before the reflected light RL is received from an object located at a long distance. This enables only the external light component to be stored in the charge storage unit CS4.

As shown in FIGS. 11A and 11B, in the measurement mode M4 of the present embodiment, two measurement steps (1st STEP and 2nd STEP) are provided in each frame.

In the 1st STEP in the measurement mode M4, charge storage operation is performed by applying a conventional driving method. The conventional driving method may be, for example, a method of sequentially storing charge via the reading gate transistors G1 to G4 in synchronization with the timing at which the light pulse PO is emitted, as shown in FIGS. 11A and 11B.

Specifically, as shown in FIG. 11A, in the 1st STEP, first, the vertical scanning circuit 323 causes the light pulse PO to be emitted for the emission time To. At the timing at which the light pulse PO is emitted for the emission time To, the vertical scanning circuit 323 switches the drain gate transistor GD to the OFF state and causes the reading gate transistor G1 to be in the ON state for the storage time Ta. Thus, charge corresponding to the external light component is stored in the charge storage unit CS1 via the reading gate transistor G1 while the reading gate transistor G1 is controlled to be in the ON state.

Then, at the timing at which the reading gate transistor G1 is switched to the OFF state, the vertical scanning circuit 323 causes the reading gate transistor G2 to be in the ON state for the storage time Ta. Thus, charge corresponding to the remaining part of the external light component and the reflected light RL is stored in the charge storage unit CS2 via the reading gate transistor G2 while the reading gate transistor G2 is controlled to be in the ON state.

Then, at the timing at which the reading gate transistor G2 is switched to the OFF state, the vertical scanning circuit 323 causes the reading gate transistor G3 to be in the ON state for the storage time Ta. Thus, charge corresponding to the external light component is stored in the charge storage unit CS3 via the reading gate transistor G3 while the reading gate transistor G3 is controlled to be in the ON state.

Then, at the timing at which the reading gate transistor G3 is switched to the OFF state, the vertical scanning circuit 323 causes the reading gate transistor G4 to be in the ON state for the storage time Ta. Thus, charge corresponding to the external light component and the reflected light RL is stored in the charge storage unit CS4 via the reading gate transistor G4 while the reading gate transistor G4 is controlled to be in the ON state.

Then, at the timing at which the reading gate transistor G4 is switched to the OFF state, the vertical scanning circuit 323 switches the drain gate transistor GD to the ON state for discharge. Thus, charge generated through photoelectric conversion by the photoelectric conversion device PD is eliminated via the drain gate transistor GD.

The vertical scanning circuit 323 repeatedly drives the pixels as described above for a predetermined number of distributions in the 1st STEP. In this case, the number of distributions in the 1st STEP is set so that no saturation occurs in the charge storage unit CS1 of the short-distance light receiving pixels.

In the 2nd STEP in the measurement mode M4, control is performed so that no charge is stored in the charge storage unit CS1, but charge is stored in the charge storage units CS2 to CS4. Specifically, as shown in FIG. 11A, in the 2nd STEP, the vertical scanning circuit 323 does not control the reading gate transistor G1 to be in the ON state. Instead, the vertical scanning circuit 323 switches the reading gate transistors G2 to G4 to the ON state at the same timing as in the 1st STEP.

Specifically, first, the vertical scanning circuit 323 causes the light pulse PO to be emitted for the emission time To. Then, at the timing at which emission of the light pulse PO is terminated, the vertical scanning circuit 323 causes the reading gate transistor G2 to be in the ON state for the storage time Ta. Then, at the timing at which the reading gate transistor G2 is switched to the OFF state, the vertical scanning circuit 323 causes the reading gate transistor G3 to be in the ON state for the storage time Ta. Then, at the timing at which the reading gate transistor G3 is switched to the OFF state, the vertical scanning circuit 323 causes the reading gate transistor G4 to be in the ON state for the storage time Ta. Then, at the timing at which the reading gate transistor G4 is switched to the OFF state, the vertical scanning circuit 323 switches the drain gate transistor GD to the ON state for discharge. In the 2nd STEP in the measurement mode M4, the drain gate transistor GD is in the OFF state for the time (3×Ta) during which charge is stored in the charge storage units CS2 to CS4.

The vertical scanning circuit 323 repeatedly drives the pixels as described above for a predetermined number of distributions in the 2nd STEP. Then, the vertical scanning circuit 323 outputs a voltage signal corresponding to the amount of charge distributed to each of the charge storage units CS. The vertical scanning circuit 323 outputs a voltage signal corresponding to the amount of charge in the same manner as shown in FIG. 4A and is thus not described.

With the above configuration, in the case of the short-distance light receiving pixels as shown in FIG. 11A, charge can be distributed to and stored in the charge storage units CS1 and CS2, and in the case of the long-distance light receiving pixels as shown in FIG. 11B, charge can be distributed to and stored in the charge storage units CS2 and CS3. Furthermore, in the present embodiment, in each of the pixels, the charge storage unit CS1 can have an exposure time (with a duration) different from that of the charge storage units CS2 to CS4. This makes it possible to store charge without causing saturation of the charge storage unit CS1 of the short-distance light receiving pixels and to store a larger amount of charge in the charge storage units CS2 and CS3 of the long-distance light receiving pixels. Thus, even when an object located at a short distance and an object located at a long distance are both present in the measurement distance range, it is possible to perform accurate measurement for the object located at a long distance.

The number of distributions in the 1st STEP and the 2nd STEP in the measurement mode M4 of the present embodiment may be set to any number of distributions according to the situation. For example, the number of distributions in the 1st STEP is set not to exceed the upper limit of the number of distributions that does not cause saturation of the charge storage unit CS1 of the short-distance light receiving pixels. The number of distributions in the 2nd STEP is set so that no saturation occurs in the charge storage unit CS2 or CS3 of the pixels 321 (including the short-distance light receiving pixels and the long-distance light receiving pixels) and that the amount of charge stored in the charge storage units CS2 and CS3 of the long-distance light receiving pixels is sufficiently large to allow accurate distance calculation.

In the present embodiment, when the pixels 321 are driven according to the timing chart in FIG. 11A, the distance calculation unit 42 performs correction so that the exposure time of the charge storage unit CS1 is equivalent to the exposure time of each of the other charge storage units CS (the charge storage units CS2 to CS4).

For example, for the short-distance light receiving pixels in the measurement mode M4, the distance calculation unit 42 calculates the delay time Td by applying the following formulas (14) and (15).

Q1 #=Q1×{(x+y)/x} (14)

Td=To×(Q2−Q4)/(Q1 #+Q2−2×Q4) (15)

In the formula (14), Q1 #represents the amount of charge stored in the charge storage unit CS1 after correction, Q1 represents the amount of charge stored in the charge storage unit CS1 before correction, x represents the exposure time of the charge storage unit CS2 in the 1st STEP, and y represents the exposure time of the other charge storage units CS in the 2nd STEP. In the formula (15), To represents the period during which the light pulse PO is emitted, Q1 #represents the amount of charge stored in the charge storage unit CS1 after correction, Q2 represents the amount of charge stored in the charge storage unit CS2, Q3 represents the amount of charge stored in the charge storage unit CS3, and Q4 represents the amount of charge stored in the charge storage unit CS4. In the formula (15), the amount of charge corresponding to the external light component of the amount of charge stored in the charge storage units CS1 and CS2 is assumed to be equal to the amount of charge stored in the charge storage unit CS4.

For example, for the long-distance light receiving pixels in the measurement mode M4, the distance calculation unit 42 calculates the delay time Td by applying the following formula (16).

Td=To×(Q3−Q4)/(Q2+Q3−2×Q4) (16)

In the formula (16), To represents the period during which the light pulse PO is emitted, Q2 represents the amount of charge stored in the charge storage unit CS2, Q3 represents the amount of charge stored in the charge storage unit CS3, and Q4 represents the amount of charge stored in the charge storage unit CS4. In the formula (16), the amount of charge corresponding to the external light component of the amount of charge stored in the charge storage units CS2 and CS3 is assumed to be equal to the amount of charge stored in the charge storage unit CS4.

When an object located at a short distance and an object located at a long distance are both present in the measurement distance range, the distance calculation unit 42 can measure with higher accuracy the distance to the object located at a long distance by applying the formula (15) or (16) according to the pixels. In the process of calculating the distance, the distance calculation unit 42 compares the amount of charge Q1 after correction (i.e., the amount of charge Q1 #) with the amount of charge Q3 to determine one of the formulas (15) and (16) to be applied to the pixels 321.

As described above, in the pixels 321 as the short-distance light receiving pixels, the reflected light RL from the object OB is distributed to and received by the charge storage units CS1 and CS2, and an external light component is received by the charge storage units CS3 and CS4. In this case, the amount of charge Q1 #is larger than the amount of charge Q3. Using this property, the distance calculation unit 42 determines that a pixel 321 in which the amount of charge Q1 #is larger than the amount of charge Q3 is a short-distance light receiving pixel and selects the formula (15) to calculate the distance for the pixel 321.

On the other hand, in the pixels 321 as the long-distance light receiving pixels, the reflected light RL from the object OB is distributed to and received by the charge storage units CS2 and CS3, and an external light component is received by the charge storage units CS1 and CS4. In this case, the amount of charge Q1 #is smaller than the amount of charge Q3. Using this property, the distance calculation unit 42 determines that a pixel 321 in which the amount of charge Q1 #is smaller than or equal to the amount of charge Q3 is a long-distance light receiving pixel and selects the formula (16) to calculate the distance for the pixel 321.

Thus, in the present embodiment, to cause charge corresponding to the reflected light RL to be distributed to and stored in two of the charge storage units CS, control is performed so that the charge corresponding to the reflected light RL is stored in the two of the charge storage units CS for different durations (an example of “reflected light storage time”) in a single frame period according to the intensity of the reflected light RL. For example, the present embodiment focuses on the fact that the intensity of the reflected light RL varies depending on the distance to an object, assuming that the intensity of the light pulse PO and the reflectance of the object are constant.

In FIGS. 11A and 11B, in the case of receiving the reflected light RL reflected by the object OB located at a short distance as in the case shown in FIG. 11A, the intensity of the reflected light RL is higher than in the case of receiving the reflected light RL reflected by an object located at a long distance as in the case shown in FIG. 11B. If control is performed so that the time during which charge corresponding to the reflected light RL is stored is the same in the case shown in FIG. 11A and the case shown in FIG. 11B, in the case shown in FIG. 11A, the amount of charge corresponding to the reflected light RL is saturated, and in the case shown in FIG. 11B, a small amount of charge corresponding to the reflected light RL is stored. This may lead to distance measurement with low accuracy in both cases. In order to address this issue, the range image processing unit 4 performs control so that no saturation occurs in the charge storage units CS in the case of receiving reflected light RL having a high intensity and that a large amount of charge is stored in the charge storage units CS in the case of receiving the reflected light RL having a low intensity. That is, the range image processing unit 4 performs control so that the reflected light storage time of the charge storage unit CS1 is shorter than the reflected light storage time of the charge storage unit CS2 in a single frame period. This makes it possible to prevent saturation of the charge storage unit CS1 in which charge corresponding to the reflected light RL having a higher intensity is stored and to store a large amount of charge in the other charge storage units CS in which charge corresponding to the reflected light RL having a lower intensity is stored. The charge storage units CS1 and CS2 in FIG. 11A are an example of “two of the charge storage units to which charge corresponding to the reflected light RL is distributed and in which the charge is stored”.

Specifically, in FIGS. 11A and 11B, the 1st STEP and the 2nd STEP are provided in a single frame period. In the 1st STEP, charge is stored in all the charge storage units CS1 to CS4. In the 2nd STEP, the relative timing of emission of the light pulse PO and charge storage in the charge storage units CS is the same as in the 1st STEP, and no charge is stored in the charge storage unit CS1, but charge is stored in the charge storage units CS2 to CS4. Thus, the range image processing unit 4 performs control so that the reflected light storage time of the charge storage unit CS1 is shorter than the reflected light storage time of the charge storage unit CS2 in a single frame period. More specifically, the range image processing unit 4 sets the reflected light storage time of the charge storage unit CS1 to (x) and sets the reflected light storage time of the charge storage unit CS2 to (x+y). Here, x represents the exposure time of each of the charge storage units CS1 to CS4 in the 1st STEP, and y represents the exposure time of each of the charge storage units CS2 to CS4 in the 2nd STEP.

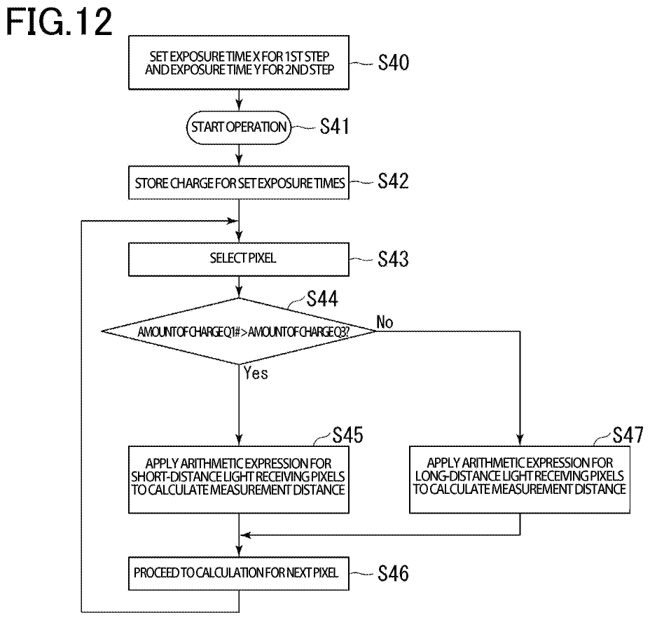

A flow of the process performed by the range imaging device 1 in the measurement mode M4 of the second embodiment will be described with reference to FIG. 12. Steps S40, S41, S43, and S46 in the flowchart shown in FIG. 12 are similar to steps S10, S11, S13, and S16 in FIG. 6, and are thus not described.

### Step S42

The range imaging device 1 causes charge to be stored in the charge storage units CS for the exposure times x and y set in advance. For example, the range imaging device 1 performs an operation corresponding to the timing in the 1st STEP to cause charge corresponding to the exposure time x to be stored in the charge storage units CS1 to CS4. Furthermore, the range imaging device 1 performs an operation corresponding to the timing in the 2nd STEP to cause charge corresponding to the exposure time y to be stored in the charge storage units CS2 to CS4.

### Step S44

The range imaging device 1 determines whether in the selected pixel 321, the amount of charge Q1 #as the amount of charge after correction is larger than the amount of charge Q3. The range imaging device 1 uses the formula (14) to calculate the amount of charge Q1 #as the amount of charge after correction and compares the calculated amount of charge Q1 #with the amount of charge Q3 to determine whether the amount of charge Q1 #is larger than the amount of charge Q3.

### Step S45

When the amount of charge Q1 #is larger than the amount of charge Q3, the range imaging device 1 applies the arithmetic expression corresponding to the short-distance light receiving pixels in the measurement mode M4 (the formula (15)) to calculate the measurement distance. The range imaging device 1 applies the amount of charge Q1 #calculated in step S44 and the amounts of charge Q2 to Q4 to the formula (15) to calculate the delay time Td. Based on the calculated delay time Td, the range imaging device 1 calculates the measurement distance for the pixels 321 (short-distance light receiving pixels).

### Step S47

On the other hand, when the amount of charge Q1 #is smaller than or equal to the amount of charge Q3 in step S44, the range imaging device 1 applies the arithmetic expression corresponding to the long-distance light receiving pixels in the measurement mode M4 (the formula (16)) to calculate the measurement distance. The range imaging device 1 applies the amounts of charge Q2 to Q4 to the formula (16) to calculate the delay time Td. Based on the calculated delay time Td, the range imaging device 1 calculates the measurement distance for the pixels 321 (long-distance light receiving pixels).

The great advantage of the second embodiment described above is that the charge storage unit CS for storing the external light component can be fixed. In calculation of the measurement distance, when the charge storage unit CS for storing only the external light component is known, the calculation load can be reduced. On the other hand, a configuration in which the charge storage unit CS for storing the external light component is not fixed has an advantage in that not only objects at a short distance and a long distance but also objects at a still longer distance (hereinafter referred to as an ultra-long distance) can be measured. A case in which the charge storage unit CS for storing the external light component is not fixed will be described below as a third embodiment.

### Third Embodiment

Next, the third embodiment will be described. The present embodiment is different from the embodiments described above in that each of the pixels 321 of the range imaging device 1 includes four charge storage units CS (charge storage units CS1 to CS4) and that the charge storage unit CS for storing only the external light component is not determined (not fixed) in advance.

### Measurement Mode M5

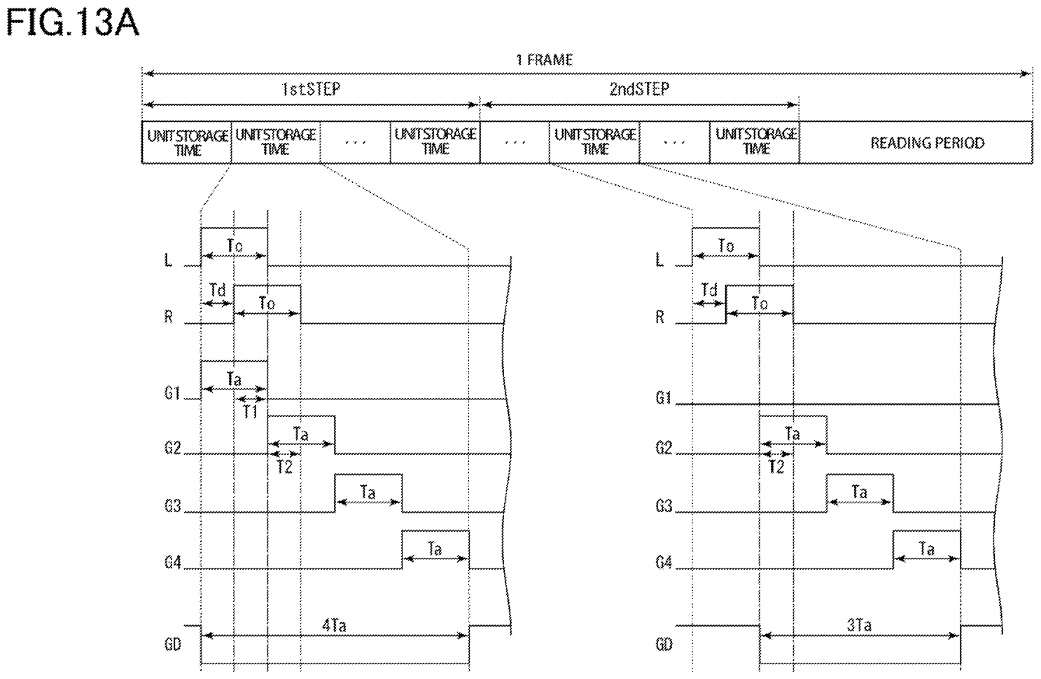

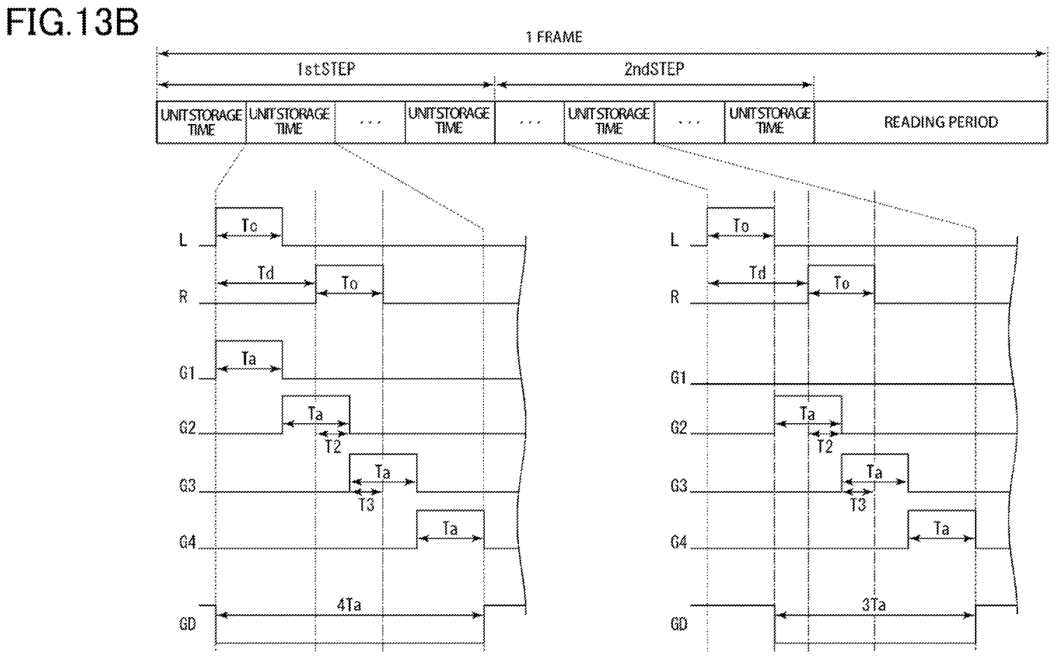

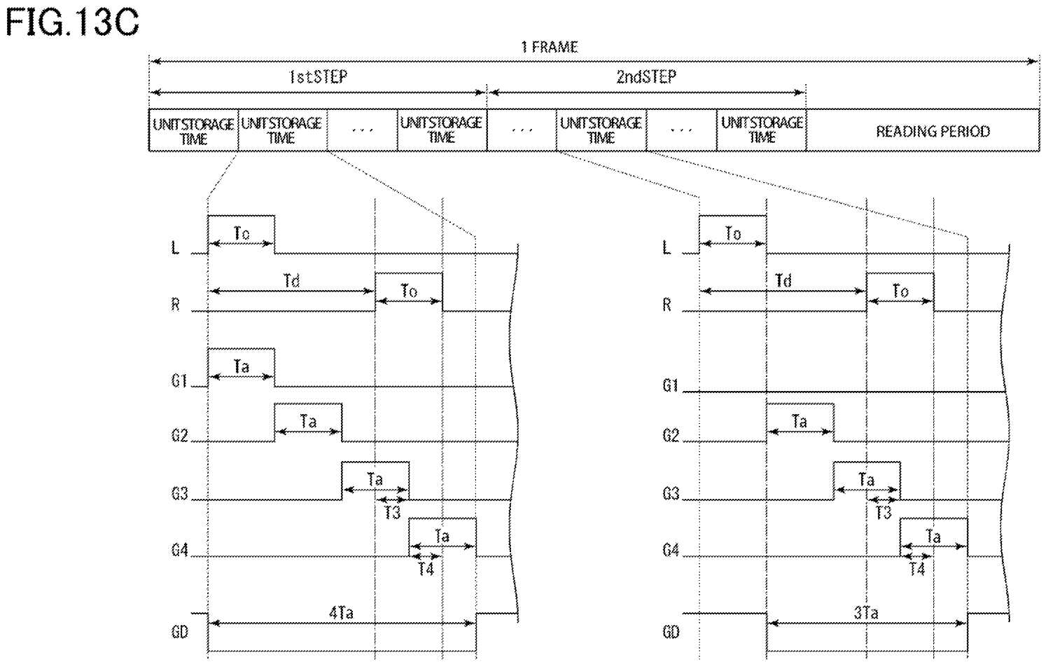

A measurement mode M5 of the present embodiment will be described with reference to FIGS. 13A, 13B, and 13C. FIGS. 13A, 13B, and 13C are a timing chart showing an example of the timing at which the pixels 321 are driven in the third embodiment. FIG. 13A shows a timing chart for the short-distance light receiving pixels. FIG. 13B shows a timing chart for the long-distance light receiving pixels. FIG. 13C shows a timing chart for ultra-long-distance light receiving pixels. The ultra-long-distance light receiving pixels are pixels 321 that receive the reflected light RL from an object located at an ultra-long distance. The symbols such as “L”, “R”, and “G1” in FIGS. 13A, 13B, and 13C are the same as those in FIG. 4A. The ultra-long distance is an example of “third distance”.

In the measurement mode M5, the charge storage unit CS for storing only the external light component is not fixed. In the measurement mode M5, control is performed so that charge corresponding to the reflected light RL from an object located at a short distance is distributed to and stored in the charge storage units CS1 and CS2. In this case, charge corresponding to the external light component is stored in the charge storage units CS3 and CS4. In the measurement mode M5, control is performed so that charge corresponding to the reflected light RL from an object located at a long distance is distributed to and stored in the charge storage units CS2 and CS3. In this case, charge corresponding to the external light component is stored in the charge storage units CS1 and CS4. In the measurement mode M5, control is performed so that charge corresponding to the reflected light RL from an object located at an ultra-long distance is distributed to and stored in the charge storage units CS3 and CS4. In this case, charge corresponding to the external light component is stored in the charge storage units CS1 and CS2. This can increase the measurable distance.

As shown in FIGS. 13A, 13B, and 13C, in the measurement mode M5 of the present embodiment, two measurement steps (1st STEP and 2nd STEP) are provided in each frame.

In the 1st STEP in the measurement mode M5, charge storage operation is performed by applying the conventional driving method. For example, as in the 1st STEP in FIGS. 11A and 11B, the vertical scanning circuit 323 causes charge to be sequentially stored via the reading gate transistors G1 to G4 in synchronization with the timing at which the light pulse PO is emitted.

In the 2nd STEP in the measurement mode M5, control is performed so that no charge is stored in the charge storage unit CS1, but charge is stored in the charge storage units CS2 to CS4. For example, as in the 2nd STEP in FIGS. 11A and 11B, in the 2nd STEP, the vertical scanning circuit 323 does not control the reading gate transistor G1 to be in the ON state. Instead, the vertical scanning circuit 323 switches the reading gate transistors G2 to G4 to the ON state at the same timing as in the 1st STEP.

With the above configuration, in the case of the short-distance light receiving pixels as shown in FIG. 13A, charge can be distributed to and stored in the charge storage units CS1 and CS2. In the case of the long-distance light receiving pixels as shown in FIG. 13B, charge can be distributed to and stored in the charge storage units CS2 and CS3. In the case of the ultra-long-distance light receiving pixels as shown in FIG. 13C, charge can be distributed to and stored in the charge storage units CS3 and CS4.

Furthermore, in the measurement mode M5 of the present embodiment, in each of the pixels, the charge storage unit CS1 can have an exposure time (with a duration) different from that of the charge storage units CS2 to CS4. This makes it possible to store charge without causing saturation of the charge storage unit CS1 of the short-distance light receiving pixels and to store a larger amount of charge in the charge storage units CS2 and CS3 of the long-distance light receiving pixels. Furthermore, a larger amount of charge can be stored in the charge storage units CS3 and CS4 of the ultra-long-distance light receiving pixels. Thus, even when an object located at a short distance, an object located at a long distance, and an object located at an ultra-long distance are all present in the measurement distance range, it is possible to perform accurate measurement for the object located at a long distance and the object located at an ultra-long distance.

The number of distributions in the 1st STEP and the 2nd STEP in the measurement mode M5 of the present embodiment may be set to any number of distributions according to the situation. For example, the number of distributions in the 1st STEP is set not to exceed the upper limit of the number of distributions that does not cause saturation of the charge storage unit CS1 of the short-distance light receiving pixels. The number of distributions in the 2nd STEP is set so that no saturation occurs in the charge storage units CS2 to CS4 of the pixels 321 (including the short-distance light receiving pixels and the long-distance light receiving pixels) and that the amount of charge stored in the charge storage units CS2 and CS3 of the long-distance light receiving pixels is sufficiently large to allow accurate distance calculation. Alternatively, the number of distributions in the 2nd STEP is set so that the amount of charge stored in the charge storage units CS3 and CS4 of the ultra-long-distance light receiving pixels is sufficiently large to allow accurate distance calculation.

In the present embodiment, when the pixels 321 are driven according to the timing chart in FIG. 13A, the distance calculation unit 42 performs correction so that the exposure time of the charge storage unit CS1 is equivalent to the exposure time of each of the other charge storage units CS (the charge storage units CS2 to CS4).

For example, for the short-distance light receiving pixels in the measurement mode M5, the distance calculation unit 42 calculates the delay time Td by applying the following formulas (17) and (18).

Q1 #=Q1×{(x+y)/x} (17)

Td=To×(Q2−Q4)/(Q1 #+Q2−2×Q4) (18)

In the formula (17), x represents the exposure time of the charge storage unit CS1 in the 1st STEP, y represents the exposure time of the other charge storage units CS in the 2nd STEP, and Q1 represents the amount of charge stored in the charge storage unit CS1. In the formula (18), To represents the period during which the light pulse PO is emitted, Q1 #represents the amount of charge after correction, Q2 represents the amount of charge stored in the charge storage unit CS2, and Q4 represents the amount of charge stored in the charge storage unit CS4. In the formula (18), the amount of charge corresponding to the external light component of the amount of charge stored in the charge storage units CS1 and CS2 is assumed to be equal to the amount of charge stored in the charge storage unit CS4.

For example, for the long-distance light receiving pixels in the measurement mode M5, the distance calculation unit 42 calculates the delay time Td by applying the following formula (19).

Td=To×(Q3−Q1 #)/(Q2+Q3−2×Q1 #) (19)

In the formula (19), To represents the period during which the light pulse PO is emitted, Q1 #represents the amount of charge after correction using the formula (17), Q2 represents the amount of charge stored in the charge storage unit CS2, and Q3 represents the amount of charge stored in the charge storage unit CS3. In the formula (19), the amount of charge corresponding to the external light component of the amount of charge stored in the charge storage units CS2 and CS3 is assumed to be equal to the amount of charge stored in the charge storage unit CS1.

For example, for the ultra-long-distance light receiving pixels in the measurement mode M5, the distance calculation unit 42 calculates the delay time Td by applying the following formula (20).

Td=To×(Q4−Q1 #)/(Q3+Q4−2×Q1 #) (20)

In the formula (20), To represents the period during which the light pulse PO is emitted, Q1 #represents the amount of charge after correction using the formula (17), Q3 represents the amount of charge stored in the charge storage unit CS3, and Q4 represents the amount of charge stored in the charge storage unit CS4. In the formula (20), the amount of charge corresponding to the external light component of the amount of charge stored in the charge storage units CS3 and CS4 is assumed to be equal to the amount of charge stored in the charge storage unit CS1.

When an object located at a short distance, an object located at a long distance, and an object located at an ultra-long distance are all present in the measurement distance range, the distance calculation unit 42 can measure with higher accuracy the distance to the object located at a long distance by applying the formulas (18) to (20) according to the pixels. In the process of calculating the distance, the distance calculation unit 42 compares the amount of charge Q1 after correction (i.e., the amount of charge Q1 #) and the amounts of charge Q2 to Q4 with each other to determine one of the formulas (18) to (20) to be applied to the pixels 321.

As described above, in the pixels 321 as the short-distance light receiving pixels, the reflected light RL from the object OB is distributed to and received by the charge storage units CS1 and CS2, and an external light component is received by the charge storage units CS3 and CS4. In this case, the amount of charge Q4 is the smallest. Alternatively, the amounts of charge Q3 and Q4 are the smallest. Using this property, the distance calculation unit 42 determines that a pixel 321 that satisfies the above condition is a short-distance light receiving pixel, and selects the formula (18) to calculate the distance for the pixel 321.

In the pixels 321 as the long-distance light receiving pixels, the reflected light RL from the object OB is distributed to and received by the charge storage units CS2 and CS3, and an external light component is received by the charge storage units CS1 and CS4. In this case, the amount of charge Q1 #is the smallest. Alternatively, the amounts of charge Q1 #and Q4 are the smallest. Using this property, the distance calculation unit 42 determines that a pixel 321 that satisfies the above condition is a long-distance light receiving pixel, and selects the formula (19) to calculate the distance for the pixel 321.

In the pixels 321 as the ultra-long-distance light receiving pixels, the reflected light RL from the object OB is distributed to and received by the charge storage units CS3 and CS4, and an external light component is received by the charge storage units CS1 and CS2. In this case, the amount of charge Q1 #is the smallest. Alternatively, the amounts of charge Q1 #and Q2 are the smallest. Using this property, the distance calculation unit 42 determines that a pixel 321 that satisfies the above condition is an ultra-long-distance light receiving pixel and selects the formula (20) to calculate the distance for the pixel 321.

Thus, in the present embodiment, to cause charge corresponding to the reflected light RL to be distributed to and stored in two of the charge storage units CS, control is performed so that the charge corresponding to the reflected light RL is stored in the two of the charge storage units CS for different durations (an example of “reflected light storage time”) in a single frame period according to the intensity of the reflected light RL. For example, the present embodiment focuses on the fact that the intensity of the reflected light RL varies depending on the distance to an object, assuming that the intensity of the light pulse PO and the reflectance of the object are constant.

In FIGS. 13A to 13C, in the case of receiving the reflected light RL reflected by the object OB located at a short distance as in the case shown in FIG. 13A, the intensity of the reflected light RL is higher than in the case of receiving the reflected light RL reflected by an object located at a long distance as in the case shown in FIG. 13B and in the case of receiving the reflected light RL reflected by an object located at an ultra-long distance as in the case shown in FIG. 13C. If control is performed so that the time during which charge corresponding to the reflected light RL is stored is the same in the case shown in FIG. 13A and the cases shown in FIGS. 13B and 13C, in the case shown in FIG. 13A, the amount of charge corresponding to the reflected light RL is saturated, and in the cases shown in FIGS. 13B and 13C, a small amount of charge corresponding to the reflected light RL is stored. This may lead to distance measurement with low accuracy in both cases. In order to address this issue, the range image processing unit 4 performs control so that no saturation occurs in the charge storage units CS in the case of receiving reflected light RL having a high intensity and that a large amount of charge is stored in the charge storage units CS in the case of receiving the reflected light RL having a low intensity. That is, the range image processing unit 4 performs control so that the reflected light storage time of the charge storage unit CS1 is shorter than the reflected light storage time of the charge storage unit CS2 in a single frame period. This makes it possible to prevent saturation of the charge storage unit CS1 in which charge corresponding to the reflected light RL having a higher intensity is stored and to store a large amount of charge in the other charge storage units CS in which charge corresponding to the reflected light RL having a lower intensity is stored. The charge storage units CS1 and CS2 in FIG. 13A are an example of “two of the charge storage units to which charge corresponding to the reflected light RL is distributed and in which the charge is stored”.

Specifically, in FIG. 13A, the 1st STEP and the 2nd STEP are provided in a single frame period. In the 1st STEP, charge is stored in all the charge storage units CS1 to CS4. In the 2nd STEP, the relative timing of emission of the light pulse PO and charge storage in the charge storage units CS is the same as in the 1st STEP, and no charge is stored in the charge storage unit CS1, but charge is stored in the charge storage units CS2 to CS4. Thus, the range image processing unit 4 performs control so that the reflected light storage time of the charge storage unit CS1 is shorter than the reflected light storage time of the charge storage unit CS2 in a single frame period. More specifically, the range image processing unit 4 sets the reflected light storage time of the charge storage unit CS1 to (x) and sets the reflected light storage time of the charge storage unit CS2 to (x+y). Here, x represents the exposure time of each of the charge storage units CS1 to CS4 in the 1st STEP, and y represents the exposure time of each of the charge storage units CS2 to CS4 in the 2nd STEP.

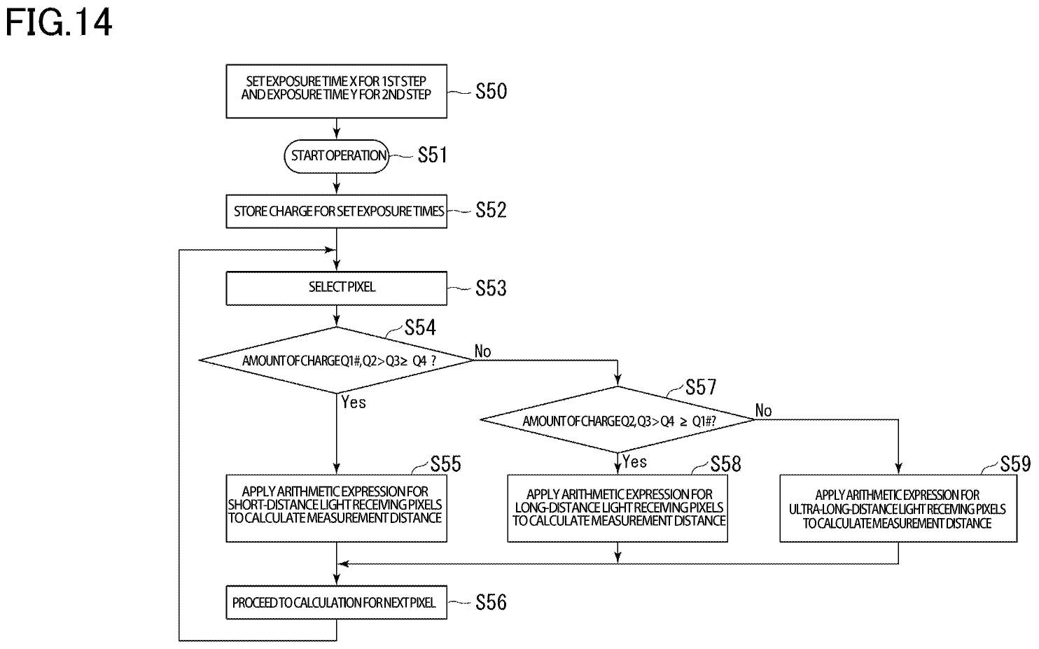

A flow of the process performed by the range imaging device 1 in the measurement mode M5 of the third embodiment will be described with reference to FIG. 14. Steps S50, S51, S53, and S56 in the flowchart shown in FIG. 14 are similar to steps S10, S11, S13, and S16 in FIG. 6, and are thus not described. Furthermore, step S52 in FIG. 14 is similar to step S42 in FIG. 12 and is thus not described.

### Step S54

The range imaging device 1 determines whether in the selected pixel 321, the amount of charge Q1 #as the amount of charge after correction and the amount of charge Q2 are larger than the amount of charge Q3 and the amount of charge Q3 is larger than or equal to the amount of charge Q4. The range imaging device 1 uses the formula (17) to calculate the amount of charge Q1 #as the amount of charge after correction and compares each of the calculated amount of charge Q1 #and the amount of charge Q2 with the amount of charge Q3 to determine whether the amounts of charge Q1 #and Q2 are larger than the amount of charge Q3. Furthermore, the range imaging device 1 compares the amount of charge Q3 with the amount of charge Q4 to determine whether the amount of charge Q3 is larger than or equal to the amount of charge Q4.

Step S55 When the amounts of charge Q1 #and Q2 are larger than the amount of charge Q3 and the amount of charge Q3 is larger than or equal to the amount of charge Q4, the range imaging device 1 applies the arithmetic expression corresponding to the short-distance light receiving pixels in the measurement mode M5 (the formula (18)) to calculate the measurement distance.

### Step S57

On the other hand, when the amounts of charge Q1 #and Q2 are smaller than or equal to the amount of charge Q3 or the amount of charge Q3 is larger than the amount of charge Q4 in step S54, the range imaging device 1 determines whether the amounts of charge Q2 and Q3 are larger than the amount of charge Q4 and the amount of charge Q4 is larger than or equal to the amount of charge Q1 #. The range imaging device 1 compares each of the amounts of charge Q2 and Q3 with the amount of charge Q4 to determine whether the amounts of charge Q2 and Q3 are larger than the amount of charge Q4. The range imaging device 1 uses the formula (17) to calculate the amount of charge Q1 #as the amount of charge after correction and compares the calculated amount of charge Q1 #with the amount of charge Q4 to determine whether the amount of charge Q4 is larger than or equal to the amount of charge Q1 #.

### Step S58

When the amounts of charge Q2 and Q3 are larger than the amount of charge Q4 and the amount of charge Q4 is larger than or equal to the amount of charge Q1 #, the range imaging device 1 applies the arithmetic expression corresponding to the long-distance light receiving pixels in the measurement mode M5 (the formula (19)) to calculate the measurement distance.

### Step S59

When the amounts of charge Q2 and Q3 are smaller than or equal to the amount of charge Q4 or the amount of charge Q4 is smaller than the amount of charge Q1 #, the range imaging device 1 applies the arithmetic expression corresponding to the ultra-long-distance light receiving pixels in the measurement mode M5 (the formula (20)) to calculate the measurement distance.

In at least one of the embodiments described above, an example has been described in which for each of the pixels, the distance is calculated based on the amount of stored charge. However, the present invention is not limited to this. For example, the distance value calculated for each of the pixels may be corrected based on the distance value for pixels located around the target pixel, and a value (distance value) obtained by the correction may be used as the measurement distance.

When the pixels 321 receive the reflected light RL, charge is generated through photoelectric conversion; however, charge corresponding to the entire amount of received light is not simultaneously generated. For example, in the photoelectric conversion device PD, charge is presumably generated from light corresponding to a near-infrared light component of the reflected light RL received, to which the pixels 321 have high transparency. In such a case, a part of the charge supposed to be distributed is generated with delay, and thus, for example, charge originally supposed to be distributed to the first charge storage unit is stored in the second charge storage unit. That is, a delay charge may be generated.

Possible factors causing such a delay charge include delayed charge transfer due to the structure of the photoelectric conversion device PD, the emission time To of the light pulse PO, and the distribution time Ta for the charge storage units CS. When a large delay charge is caused by such a factor, not only the external light component but also the delay charge generated from the reflected light RL may be stored in the charge storage unit CS for storing only the external light component. In such a case, the accuracy of the measurement distance is reduced.

In order to address this issue, as in the measurement mode M3 of the second embodiment described above, the external light component may be stored immediately before emission of the light pulse PO.

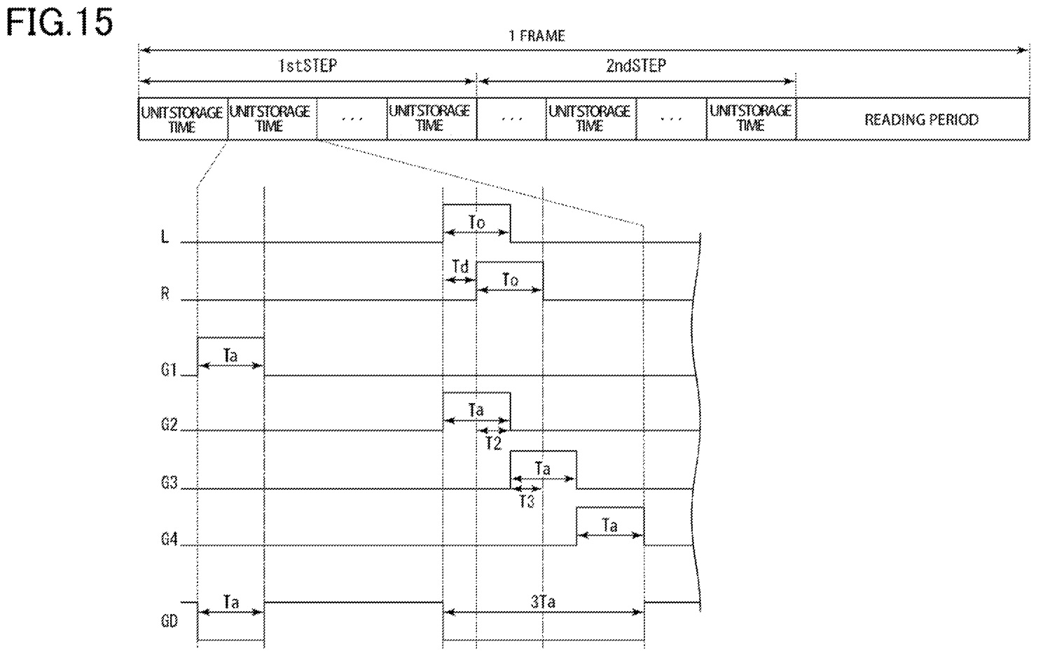

As in the relationship between the timing at which the light pulse PO is emitted and the timing at which charge is stored in the charge storage unit CS1 in FIG. 15, the timing at which the light pulse PO is emitted and the timing at which the external light component is stored may be sufficiently separated from each other.

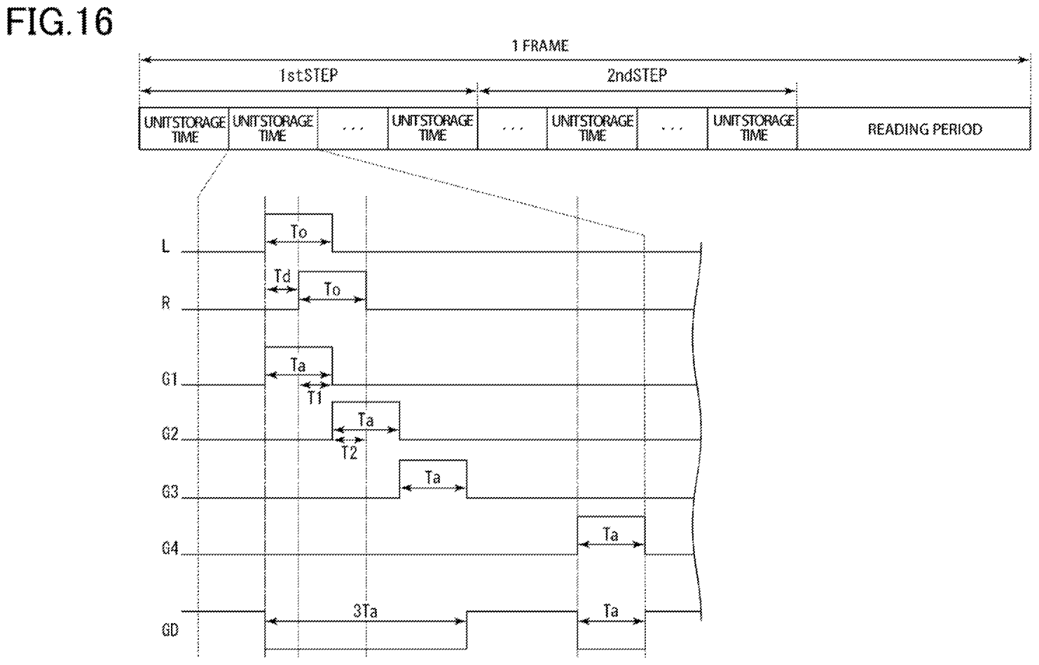

As in the relationship between the timing at which the light pulse PO is emitted and the timing at which charge is stored in the charge storage unit CS4 in FIG. 16, the timing at which the light pulse PO is emitted and the timing at which the external light component is stored may be sufficiently separated from each other.

FIGS. 15 and 16 are a diagram showing a modification of the embodiment. FIG. 15 shows an operation of storing the external light component in the charge storage unit CS1 at the timing sufficiently earlier than the timing at which the light pulse PO is emitted in the measurement mode M3 of the second embodiment described above. FIG. 16 shows an operation of storing the external light component in the charge storage unit CS4 at the timing sufficiently later than the timing at which the light pulse PO is emitted in the measurement mode M4 of the second embodiment described above.

### Fourth Embodiment

Next, a fourth embodiment will be described. The present embodiment is different from the embodiments described above in that control is performed so that in each frame, the charge storage units CS have the same exposure time and charge corresponding to the reflected light RL is stored in the charge storage units CS for different durations. In the present embodiment, the charge storage unit CS for storing only the external light component is not determined (not fixed) in advance.

Specifically, in the present embodiment, the timing at which charge is stored in each of the charge storage units CS is changed during each frame. For example, in the present embodiment, measurement steps are provided in each frame. In the measurement steps, the timing at which charge is stored in the charge storage units CS is different.

In the following, an example will be described in which the 1st STEP and the 2nd STEP are provided as the multiple measurement steps. The timing at which charge is stored in the charge storage units CS in the 1st STEP is an example of “first timing”. A storage process in the 1st STEP is an example of “first process”. The number of repetitions of the storage process in the 1st STEP is an example of “first number of times”. The timing at which charge is stored in the charge storage units CS in the 2nd STEP is an example of “second timing”. A storage process in the 2nd STEP is an example of “second process”. The number of repetitions of the storage process in the 2nd STEP is an example of “second number of times”.

For example, when each of the pixels 321 of the range imaging device 1 includes three charge storage units CS (charge storage units CS1 to CS3), first, in the 1st STEP, control is performed so that charge is stored in the charge storage units CS1, CS2, and CS3 in this order in synchronization with the timing at which the light pulse PO is emitted. Then, in the 2nd STEP, control is performed so that charge is stored in the charge storage units CS2, CS3, and CS1 in this order without changing the timing at which charge is stored in the charge storage units CS2 and CS3.

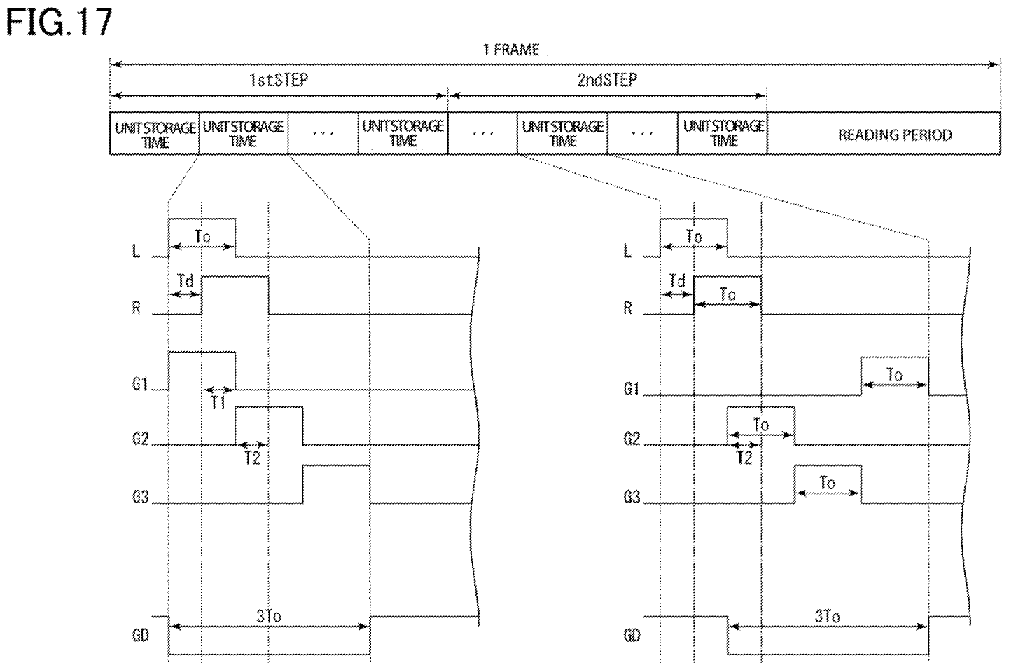

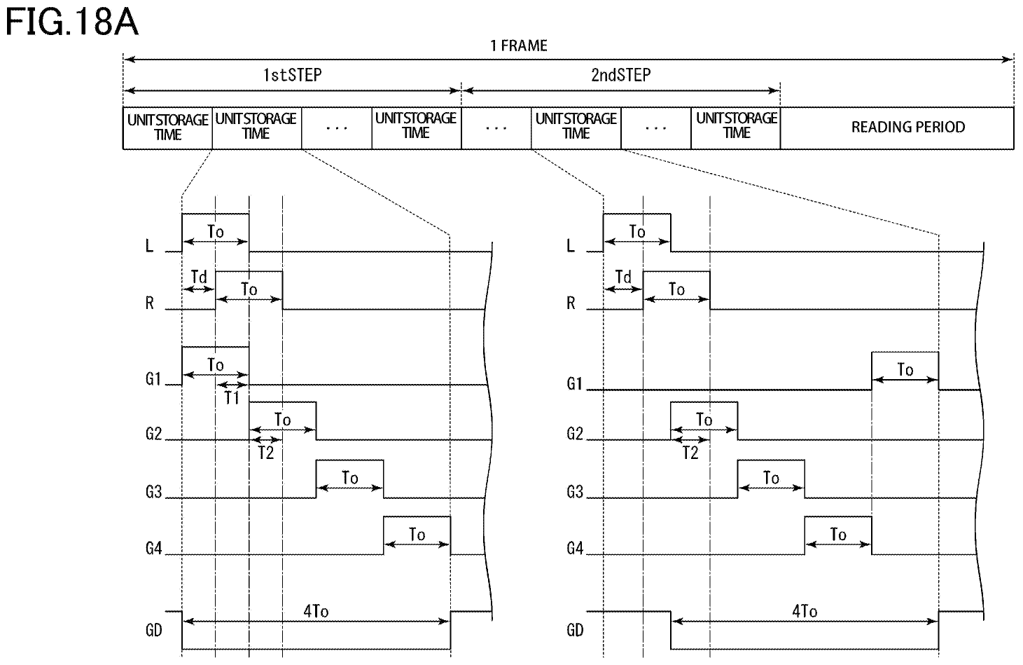

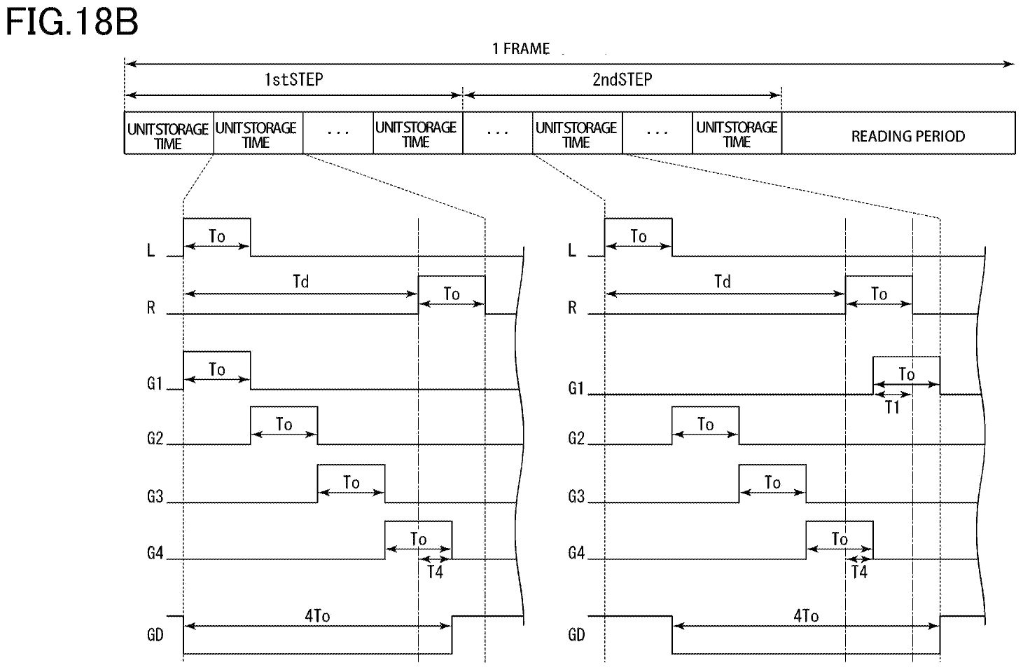

The present embodiment will be described with reference to FIGS. 17, 18A, and 18B. FIGS. 17, 18A, and 18B are a timing chart showing an example of the timing at which the pixels 321 are driven in the fourth embodiment. FIG. 17 shows a timing chart for the pixels 321 each of which includes three charge storage units CS (charge storage units CS1 to CS3). FIGS. 18A and 18B show a timing chart for the pixels 321 each of which includes four charge storage units CS (charge storage units CS1 to CS4). The symbols such as “L”, “R”, and “G1” in FIGS. 17, 18A, and 18B are the same as those in FIG. 4A. FIGS. 17, 18A, and 18B show an example in which the emission time of the light pulse PO and the storage time have the same duration To.

In the following description, a “zone Z1” refers to the distance range corresponding to a short distance, a “zone Z2” refers to the distance range corresponding to a long distance, a “zone Z3” refers to the distance range corresponding to an ultra-long distance, and a “zone Z4” refers to the distance range corresponding to a distance longer than the ultra-long distance. The zone Z1 is an example of “first distance”. The zone Z2 is an example of “second distance”. The zone Z3 is an example of “third distance”. The zone Z4 is an example of “fourth distance”.

FIG. 17 shows a timing chart for a case in which each of the pixels 321 includes three charge storage units CS and two measurement steps (1st STEP and 2nd STEP) are provided in each frame. In the 1st STEP, the measurement control unit 43 switches the reading gate transistors G1 to G3 to the ON state in the order of the reading gate transistor G1, G2, and G3 by applying the conventional timing. In the 2nd STEP, the measurement control unit 43 switches the reading gate transistors G2 and G3 to the ON state at the same timing as in the 1st STEP, and switches the reading gate transistors G1 to G3 to the ON state in the order of the reading gate transistors G2, G3, and G1.

Specifically, in the 2nd STEP, at the timing at which the storage time Ta has elapsed from emission of the light pulse PO, the vertical scanning circuit 323 switches the drain gate transistor GD to the OFF state and causes the reading gate transistor G2 to be in the ON state for the storage time Ta. Then, at the timing at which the reading gate transistor G2 is switched to the OFF state, the vertical scanning circuit 323 causes the reading gate transistor G3 to be in the ON state for the storage time Ta. Then, at the timing at which the reading gate transistor G3 is switched to the OFF state, the vertical scanning circuit 323 causes the reading gate transistor G1 to be in the ON state for the storage time Ta. Then, at the timing at which the reading gate transistor G1 is switched to the OFF state, the vertical scanning circuit 323 switches the drain gate transistor GD to the ON state for discharge. In the 2nd STEP, the time during which charge is stored in the charge storage units CS1 to CS3 is the same as in the 1st STEP, but the timing at which charge is stored is different from that in the 1st STEP.

As shown in FIG. 17, a case will be described in which the delay time Td is relatively short and charge corresponding to the reflected light RL from an object located in the zone Z1 is distributed to and stored in the charge storage units CS1 and CS2 in the 1st STEP (first example). In this case, charge corresponding to the external light component is stored in the charge storage unit CS3 in the 1st STEP and the charge storage units CS1 and CS3 in the 2nd STEP. Furthermore, charge corresponding to the reflected light RL is stored in the charge storage units CS1 and CS2 in the 1st STEP and the charge storage unit CS2 in the 2nd STEP. The charge storage unit CS1 in the 1st STEP is an example of “reflected light charge storage unit”. The charge storage unit CS1 in the 2nd STEP is an example of “external light charge storage unit”.

Next, a case will be described in which the delay time Td is longer than the delay time Td shown in FIG. 17 (first example) and charge corresponding to the reflected light RL from an object located in the zone Z2 is distributed to and stored in the charge storage units CS2 and CS3 in the 1st STEP (second example). In this case, charge corresponding to the external light component is stored in the charge storage unit CS1 in the 1st STEP and the charge storage unit CS1 in the 2nd STEP. Furthermore, charge corresponding to the reflected light RL is stored in the charge storage units CS2 and CS3 in the 1st STEP and the charge storage units CS2 and CS3 in the 2nd STEP.

Next, a case will be described in which the delay time Td is longer than the delay time Td in the first and second examples and charge corresponding to the reflected light RL from an object located in the zone Z3 is distributed to and stored in the charge storage units CS3 and CS1 in the 2nd STEP (third example). In this case, charge corresponding to the external light component is stored in the charge storage units CS1 and CS2 in the 1st STEP and the charge storage unit CS2 in the 2nd STEP. Furthermore, charge corresponding to the reflected light RL is stored in the charge storage unit CS3 in the 1st STEP and the charge storage units CS3 and CS1 in the 2nd STEP. The charge storage unit CS1 in the 1st STEP is an example of “external light charge storage unit”. The charge storage unit CS1 in the 2nd STEP is an example of “reflected light charge storage unit”.

Thus, in the present embodiment, the timing at which charge is stored in the charge storage units CS is different in the 1st STEP and the 2nd STEP. This enables the configuration including the pixels 321 each of which includes three charge storage units CS to measure a longer distance. In the operation shown in FIG. 17, the exposure time of the charge storage unit CS1 in each frame is the same as the exposure time of the charge storage units CS2 and CS3 in each frame. However, the storage time during which charge corresponding to the reflected light RL is stored in the charge storage unit CS1 in each frame is different from the storage time during which charge corresponding to the reflected light RL is stored in the charge storage units CS2 and CS3 in each frame. Thus, before distance calculation, correction is performed so that the storage time during which charge corresponding to the reflected light RL is stored in the charge storage unit CS1 is the same as in the charge storage units CS2 and CS3. A specific method of correction will be described later.

Thus, in the present embodiment, to cause charge corresponding to the reflected light RL to be distributed to and stored in two of the charge storage units CS, control is performed so that the charge corresponding to the reflected light RL is stored in the two of the charge storage units CS for different durations (an example of “reflected light storage time”) in a single frame period according to the intensity of the reflected light RL. For example, the present embodiment focuses on the fact that the intensity of the reflected light RL varies depending on the distance to an object, assuming that the intensity of the light pulse PO and the reflectance of the object are constant.

In the case of receiving the reflected light RL reflected by the object OB located in the zone Z1 as in the case shown in FIG. 17, the intensity of the reflected light RL is higher than in the case of receiving the reflected light RL reflected by an object located in the zone Z2 or Z3. If control is performed so that the time during which charge corresponding to the reflected light RL is stored is the same in the case shown in FIG. 17 and the case of receiving the reflected light RL reflected by an object located in the zone Z2 or Z3, in the case shown in FIG. 17, the amount of charge corresponding to the reflected light RL is saturated, and in the case of receiving the reflected light RL reflected by an object located in the zone Z2 or Z3, a small amount of charge corresponding to the reflected light RL is stored. This may lead to distance measurement with low accuracy in both cases. In order to address this issue, the range image processing unit 4 performs control so that no saturation occurs in the charge storage units CS in the case of receiving the reflected light RL having a high intensity and that a large amount of charge is stored in the charge storage units CS in the case of receiving the reflected light RL having a low intensity, thus allowing distance measurement with higher accuracy. That is, the range image processing unit 4 performs control so that the reflected light storage time of the charge storage unit CS1 is shorter than the reflected light storage time of the charge storage unit CS2 in a single frame period. This makes it possible to prevent saturation of the charge storage unit CS1 in which charge corresponding to the reflected light RL having a higher intensity is stored and to store a large amount of charge in the charge storage units CS in which charge corresponding to the reflected light RL having a lower intensity is stored. The charge storage units CS1 and CS2 in FIG. 17 are an example of “two of the charge storage units to which charge corresponding to the reflected light RL is distributed and in which the charge is stored”.

Specifically, in FIG. 17, the 1st STEP and the 2nd STEP are provided in a single frame period. In the 1st STEP, charge is sequentially stored in the charge storage units CS1 to CS3. In the 2nd STEP, the relative timing of emission of the light pulse PO and charge storage in the charge storage units CS is the same as in the 1st STEP, and the timing at which charge is stored in the charge storage units CS2 and CS3 is unchanged, but the timing at which charge is stored in the charge storage unit CS1 is changed to the timing after the timing at which charge is stored in the charge storage unit CS3. Thus, the range image processing unit 4 performs control so that the reflected light storage time of the charge storage unit CS1 is shorter than the reflected light storage time of the charge storage unit CS2. More specifically, the range image processing unit 4 sets the reflected light storage time of the charge storage unit CS1 to (x) and sets the reflected light storage time of the charge storage unit CS2 to (x+y). Here, x represents the exposure time of each of the charge storage units CS1 to CS3 in the 1st STEP, and y represents the exposure time of each of the charge storage units CS2 and CS3 in the 2nd STEP.

FIGS. 18A and 18B show a timing chart for a case in which each of the pixels 321 includes four charge storage units CS and two measurement steps (1st STEP and 2nd STEP) are provided in each frame. In the 1st STEP, the measurement control unit 43 switches the reading gate transistors G1 to G4 to the ON state in the order of the reading gate transistor G1, G2, G3, and G4 by applying the conventional timing. In the 2nd STEP, the measurement control unit 43 switches the reading gate transistors G2 to G4 to the ON state at the same timing as in the 1st STEP and switches the reading gate transistors G1 to G4 to the ON state in the order of the reading gate transistors G2, G3, G4, and G1.

Specifically, in the 2nd STEP, at the timing at which the storage time Ta has elapsed from emission of the light pulse PO, the vertical scanning circuit 323 switches the drain gate transistor GD to the OFF state and causes the reading gate transistor G2 to be in the ON state for the storage time Ta. Then, at the timing at which the reading gate transistor G2 is switched to the OFF state, the vertical scanning circuit 323 causes the reading gate transistor G3 to be in the ON state for the storage time Ta. Then, at the timing at which the reading gate transistor G3 is switched to the OFF state, the vertical scanning circuit 323 causes the reading gate transistor G4 to be in the ON state for the storage time Ta. Then, at the timing at which the reading gate transistor G4 is switched to the OFF state, the vertical scanning circuit 323 causes the reading gate transistor G1 to be in the ON state for the storage time Ta. Then, at the timing at which the reading gate transistor G1 is switched to the OFF state, the vertical scanning circuit 323 switches the drain gate transistor GD to the ON state for discharge. In the 2nd STEP, the time during which charge is stored in the charge storage units CS1 to CS4 is the same as in the 1st STEP, but the timing at which charge is stored is different from that in the 1st STEP.

As shown in FIG. 18A, a case will be described in which the delay time Td is relatively short and charge corresponding to the reflected light RL from an object located in the zone Z1 is distributed to and stored in the charge storage units CS1 and CS2 in the 1st STEP. In this case, charge corresponding to the external light component is stored in the charge storage units CS3 and CS4 in the 1st STEP and the charge storage units CS2, CS3, and CS1 in the 2nd STEP. Furthermore, charge corresponding to the reflected light RL is stored in the charge storage units CS1 and CS2 in the 1st STEP and the charge storage unit CS2 in the 2nd STEP. The charge storage unit CS1 in the 1st STEP is an example of “reflected light charge storage unit”. The charge storage unit CS1 in the 2nd STEP is an example of “external light charge storage unit”.

Next, a case will be described in which the delay time Td is longer than the delay time Td shown in FIG. 18A and charge corresponding to the reflected light RL from an object located in the zone Z2 is distributed to and stored in the charge storage units CS2 and CS3 in the 1st STEP (fourth example). In this case, charge corresponding to the external light component is stored in the charge storage units CS1 and CS4 in the 1st STEP and the charge storage units CS4 and CS1 in the 2nd STEP. Furthermore, charge corresponding to the reflected light RL is stored in the charge storage units CS2 and CS3 in the 1st STEP and the charge storage units CS2 and CS3 in the 2nd STEP.

Next, a case will be described in which the delay time Td is longer than the delay time Td in the fourth example and charge corresponding to the reflected light RL from an object located in the zone Z3 is distributed to and stored in the charge storage units CS3 and CS4 in the 1st STEP (fifth example). In this case, charge corresponding to the external light component is stored in the charge storage units CS1 and CS2 in the 1st STEP and the charge storage units CS2 and CS1 in the 2nd STEP. Furthermore, charge corresponding to the reflected light RL is stored in the charge storage units CS3 and CS4 in the 1st STEP and the charge storage units CS3 and CS4 in the 2nd STEP.

As shown in FIG. 18B, a case will be described in which the delay time Td is longer than the delay time Td in the fifth example and charge corresponding to the reflected light RL from an object located in the zone Z4 is distributed to and stored in the charge storage units CS4 and CS1 in the 2nd STEP. In this case, charge corresponding to the external light component is stored in the charge storage units CS1 to CS3 in the 1st STEP and the charge storage units CS2 and CS3 in the 2nd STEP. Furthermore, charge corresponding to the reflected light RL is stored in the charge storage unit CS4 in the 1st STEP and the charge storage units CS4 and CS1 in the 2nd STEP. The charge storage unit CS1 in the 1st STEP is an example of “external light charge storage unit”. The charge storage unit CS1 in the 2nd STEP is an example of “reflected light charge storage unit”.

Thus, in the present embodiment, the timing at which charge is stored in the charge storage units CS is different in the 1st STEP and the 2nd STEP. This enables the configuration including the pixels 321 each of which includes four charge storage units CS to measure a longer distance than in the case where charge is stored in the charge storage units CS at the fixed timing. In the operation shown in FIGS. 18A and 18B, the exposure time of the charge storage unit CS1 in each frame is the same as the exposure time of the other charge storage units CS2 to CS4 in each frame. However, the storage time during which charge corresponding to the reflected light RL is stored in the charge storage unit CS1 in each frame is different from the storage time during which charge corresponding to the reflected light RL is stored in the charge storage units CS2 and CS3 in each frame. Thus, before distance calculation, correction is performed so that the storage time during which charge corresponding to the reflected light RL is stored in the charge storage unit CS1 is the same as in the charge storage units CS2 to CS4.

The specific method of correction will be described. In the following, an example will be described in which the pixels 321 including four charge storage units CS are driven according to the timing chart in FIG. 18A (FIG. 18B). The method can also be applied to drive the pixels 321 including three charge storage units CS as shown in FIG. 17. The distance calculation unit 42 determines from which one of the zones Z the reflected light has been received, for each of the pixels 321, and performs correction for the corresponding pixel 321 according to the determination results.

Reflected Light RL Received from Zone Z1

For the pixels 321 that receive the reflected light RL from the zone Z1, the distance calculation unit 42 calculates the delay time Td by applying the following formulas (21) and (22).

Q1 ###=(Q1−Q4)×{(x+y)/x}+Q4 (21)

Td=To×(Q2−Q4)/(Q1 ###+Q2−2×Q4) (22)

In the formulas (21) and (22), Q1 ###represents the amount of charge stored in the charge storage unit CS1 after correction. In the formula (21), x represents the exposure time of the charge storage unit CS1 in the 1st STEP. In the formula (21), y represents the exposure time of the other charge storage unit CS (the charge storage unit CS2) in the 2nd STEP.

The value of the exposure time of each of the charge storage units CS is obtained by multiplying the storage time and the number of distributions for the corresponding charge storage unit CS in a unit storage time. That is, for each of the charge storage units CS, the number of distributions and the exposure time are proportional to each other. Thus, x may represent the number of distributions in the 1st STEP, and y may represent the number of distributions in the 2nd STEP.

In the formulas (21) and (22), Q1 represents the amount of charge stored in the charge storage unit CS1, Q2 represents the amount of charge stored in the charge storage unit CS2, and Q4 represents the amount of charge stored in the charge storage unit CS4. In the formula (22), Td represents the delay time, and To represents the period during which the light pulse PO is emitted.

In the formulas (21) and (22), the amount of charge corresponding to the external light component of the amount of charge stored in the charge storage units CS1 and CS2 is assumed to be equal to the amount of charge stored in the charge storage unit CS4. In the formulas (21) and (22), the charge storage unit CS4 serves as the charge storage unit CS for storing only the external light component. In the case of receiving the reflected light RL from the zone Z1, the charge storage units CS3 and CS4 each serve as the charge storage unit CS for storing only the external light component. Thus, in the formulas (21) and (22), Q4 may be replaced by Q3. Q3 represents the amount of charge stored in the charge storage unit CS3.

When each of the pixels 321 includes multiple charge storage units CS for storing only the external light component, the amount of charge corresponding to the external light component may be determined to be the amount of charge stored in any of the multiple charge storage units CS. For example, the amount of charge corresponding to the external light component is determined to be the smallest amount of charge of the amount of charge stored in the charge storage units CS for storing only the external light component.

Reflected Light RL Received from Zone Z2 or Zone Z3

For the pixels 321 that receive the reflected light RL from the zone Z2, the distance calculation unit 42 calculates the delay time Td by applying the following formula (23). For the pixels 321 that receive the reflected light RL from the zone Z3, the distance calculation unit 42 calculates the delay time Td by applying the following formula (24).

Td=To×(Q3−Q1)/(Q2+Q3−2×Q1) (23)

Td=To×(Q4−Q1)/(Q3+Q4−2×Q1) (24)

In the formulas (23) and (24), Td represents the delay time, and To represents the period during which the light pulse PO is emitted. In the formulas (23) and (24), Q1 represents the amount of charge stored in the charge storage unit CS1, Q2 represents the amount of charge stored in the charge storage unit CS2, Q3 represents the amount of charge stored in the charge storage unit CS3, and Q4 represents the amount of charge stored in the charge storage unit CS4.

In the formula (23), the amount of charge corresponding to the external light component of the amount of charge stored in the charge storage units CS2 and CS3 is assumed to be equal to the amount of charge stored in the charge storage unit CS1. In the formula (24) it is assumed that the amount of charge stored in each of the charge storage units CS3 and CS4, corresponding to the external light component, is the same as the amount of charge stored in the charge storage unit CS1. In the formula (23), Q1 may be replaced by Q4. In the formula (24), Q1 may be replaced by Q2.

Reflected Light RL Received from Zone Z4

For the pixels 321 that receive the reflected light RL from the zone Z4, the distance calculation unit 42 calculates the delay time Td by applying the following formulas (25) and (26).

Q1 ####=(Q1−Q2)×{(x+y)/x}+Q2 (25)

Td=To×(Q1 ####−Q2)/(Q4+Q1 ####−2×Q2) (26)

In the formulas (25) and (26), Q1 ####represents the amount of charge stored in the charge storage unit CS1 after correction. In the formula (25), x represents the reflected light storage time of the charge storage unit CS1 in the 1st STEP. In the formula (25), y represents the reflected light storage time of the other charge storage unit CS (the charge storage unit CS4) in the 2nd STEP.

In the formulas (25) and (26), Q1 represents the amount of charge stored in the charge storage unit CS1, Q2 represents the amount of charge stored in the charge storage unit CS2, and Q4 represents the amount of charge stored in the charge storage unit CS4. In the formula (26), Td represents the delay time, and To represents the time during which the light pulse PO is emitted. In the formulas (25) and (26) it is assumed that the amount of charge stored in each of the charge storage units CS4 and CS1, corresponding to the external light component, is the same as the amount of charge stored in the charge storage unit CS2. In the formulas (25) and (26), Q2 may be replaced by Q3. Q3 represents the amount of charge stored in the charge storage unit CS3.

The distance calculation unit 42 applies the above formulas according to the reflected light RL received by each of the pixels 321. In the process of calculating the distance, for example, the distance calculation unit 42 compares the amount of charge Q1 after correction (i.e., the amounts of charge Q1 ###and Q1 ####) and the amounts of charge Q2 to Q4 with each other to determine one of the zones Z1 to Z4 that includes an object from which each of the pixels 321 has received the reflected light RL. Based on the determination results, the distance calculation unit 42 determines one of the above formulas to be applied to the corresponding pixel 321.

For example, in the pixels 321 as zone-Z1 light receiving pixels, the reflected light RL from the object OB is distributed to and received by the charge storage units CS1 and CS2, and an external light component is received by the charge storage units CS3 and CS4. In this case, the amount of charge stored in the charge storage units CS3 and CS4 is smaller than the amount of charge stored in the charge storage units CS1 and CS2. Using this property, the distance calculation unit 42 determines whether a pixel 321 is a zone-Z1 light receiving pixel, and in response to the determination that the pixel 321 is a zone-Z1 light receiving pixel, the distance calculation unit 42 applies the formulas (21) and (22) to calculate the distance for the pixel 321.

For example, in the pixels 321 as zone-Z2 light receiving pixels, the reflected light RL from the object OB is distributed to and received by the charge storage units CS2 and CS3, and an external light component is received by the charge storage units CS1 and CS4. In this case, the amount of charge stored in the charge storage units CS1 and CS4 is smaller than the amount of charge stored in the charge storage units CS2 and CS3. Using this property, the distance calculation unit 42 determines whether a pixel 321 is a zone-Z2 light receiving pixel, and in response to the determination that the pixel 321 is a zone-Z2 light receiving pixel, the distance calculation unit 42 applies the formula (23) to calculate the distance for the pixel 321.

For example, in the pixels 321 as zone-Z3 light receiving pixels, the reflected light RL from the object OB is distributed to and received by the charge storage units CS3 and CS4, and an external light component is received by the charge storage units CS1 and CS2. In this case, the amount of charge stored in the charge storage units CS1 and CS2 is smaller than the amount of charge stored in the charge storage units CS3 and CS4. Using this property, the distance calculation unit 42 determines whether a pixel 321 is a zone-Z3 light receiving pixel, and in response to the determination that the pixel 321 is a zone-Z3 light receiving pixel, the distance calculation unit 42 applies the formula (24) to calculate the distance for the pixel 321.

For example, in the pixels 321 as zone-Z4 light receiving pixels, the reflected light RL from the object OB is distributed to and received by the charge storage units CS4 and CS1, and an external light component is received by the charge storage units CS2 and CS3. In this case, the amount of charge stored in the charge storage units CS2 and CS3 is smaller than the amount of charge stored in the charge storage units CS4 and CS1. Using this property, the distance calculation unit 42 determines whether a pixel 321 is a zone-Z4 light receiving pixel, and in response to the determination that the pixel 321 is a zone-Z4 light receiving pixel, the distance calculation unit 42 applies the formulas (25) and (26) to calculate the distance for the pixel 321.

In the example described above, each frame is divided into two steps, that is, the 1st STEP and the 2nd STEP. In these steps, the process of storing charge in the charge storage unit CS1 is performed at different timings, and the process is repeatedly performed in each of the steps. However, the present invention is not limited to this. In a series of storage processes in each frame, the storage process in the 1st STEP and the storage process in the 2nd STEP may be randomly or pseudo-randomly performed. This eliminates unevenness in the timing at which charge is stored in the charge storage unit CS1 in each frame, reducing disturbance factors such as noise.

In the example described above, the timing at which charge is stored in the charge storage unit CS1 is changed to increase the measurable distance to the zone Z4. However, the present invention is not limited to this. For example, in the 2nd STEP, not only the timing at which charge is stored in the charge storage unit CS1 but also the timing at which charge is stored in the charge storage units CS2 and CS3 may be changed. Specifically, in the 2nd STEP, control is performed so that the timing at which charge is stored in the charge storage unit CS4 is the same as in the 1st STEP and that charge is stored in the charge storage units CS4, CS1, CS2, and CS3 in this order. This makes it possible to increase the measurable distance range to a zone Z5 that is further than the zone Z4 or a zone Z6 that is further than the zone Z5. In this case, the same amount of charge corresponding to the external light component is stored in the charge storage units CS. On the other hand, charge corresponding to the reflected light RL may be stored for different durations in the charge storage units CS for storing charge corresponding to the reflected light RL. In such a case, correction is performed so that the time during which charge corresponding to the reflected light RL is stored in one of the charge storage units CS is the same as the time during which charge corresponding to the reflected light RL is stored in the other charge storage unit CS. In the correction, the same concept as in the formulas (21) and (25) can be applied.

In the example described above, by comparing the amounts of charge stored in the charge storage units CS and the amounts of charge after correction with each other to determine the charge storage unit CS in which only the external light component is stored and determine one of the zones Z from which each of the pixels 321 has received the reflected light RL. However, the present invention is not limited to such a determination method. For example, as described in WO 2019/031510, the distance may be obtained by determining whether the total amount of charge corresponding to the reflected light RL exceeds a predetermined threshold to determine whether to change the calculation formula or determine the validity of the measurement distance.

As described above, in the present embodiment, control is performed so that in each of the pixels 321, charge corresponding to the reflected light RL is stored for different storage times in the multiple charge storage units CS (the charge storage unit CS1 and the charge storage units CS2 to CS4). This makes it possible to store charge without causing saturation of the charge storage unit CS1 of the zone-Z1 light receiving pixels and to store a larger amount of charge in the charge storage units CS2 and CS3 of the zone-Z2 light receiving pixels. Furthermore, a larger amount of charge can be stored in the charge storage units CS3 and CS4 of the zone-Z3 light receiving pixels. Furthermore, the measurement distance range can be expanded to the zone Z4. The zone-Z1 light receiving pixels are pixels 321 that receive the reflected light RL from the zone Z1. The zone-Z2 light receiving pixels are pixels 321 that receive the reflected light RL from the zone Z2. The zone-Z3 light receiving pixels are pixels 321 that receive the reflected light RL from the zone Z3. Thus, even when an object located in the zone Z1, an object located in the zone Z2, an object located in the zone Z3, and an object located in the zone Z4 are all present in the measurement distance range, it is possible to perform accurate measurement for the object located in the zone Z2, the object located in the zone Z3, and the object located in the zone Z4.

In the present embodiment, the total exposure time of the charge storage unit CS1 in each frame is the same as the exposure time of the charge storage units CS2 to CS4. Thus, the same amount of charge corresponding to the external light component is stored in the charge storage units. Therefore, in the charge storage unit CS in which only charge corresponding to the external light component is stored, the amount of charge stored in the charge storage unit CS is not corrected to calculate the distance. That is, disturbance factors such as noise can be reduced.

In the present embodiment, the number of distributions (exposure time) in the 1st STEP and the 2nd STEP may be set to any number of distributions (exposure time) according to the situation. For example, control may be performed so that charge distribution is performed a predetermined number of times. In the present embodiment, it is preferable to set the number of distributions in the 1st STEP not to exceed the upper limit of the number of distributions that does not cause saturation of the charge storage unit CS1 of the zone-Z1 light receiving pixels. The number of distributions in the 1st STEP may be determined based on a specific threshold. For example, the number of distributions in the 1st STEP may be determined so that an amount of charge of approximately 80% of the capacity of the charge storage unit CS1 is stored when an object having a reflectance of 90% is located at a distance of 0.5 m.

In the present embodiment, in the 2nd STEP, after the charge storage unit CS4, the charge storage unit CS1 is switched to the ON state to receive the reflected light RL from the zone Z4. In this case, the amount of charge stored in the charge storage unit CS1 may be significantly smaller than the amount of charge stored in the charge storage unit CS4. In general, a larger amount of charge stored in the charge storage units CS allows distance measurement with higher accuracy. Thus, in order to measure with high accuracy the distance to an object located in the zone Z1, a large number of distributions may be performed in the 1st STEP. On the other hand, in order to measure with high accuracy the distance to an object located in the zone Z4, it is preferable to perform a small number of distributions in the 1st STEP and a large number of distributions in the 2nd STEP.

Furthermore, it is preferable to set the number of distributions in the 2nd STEP so that no saturation occurs in the charge storage units CS2 to CS4 of the pixels 321 that receive the reflected light RL from any of the zones Z and that the amount of charge stored in the charge storage units CS that receive the reflected light RL from the zones Z is sufficiently large to allow accurate distance calculation.

Thus, in the present embodiment, to cause charge corresponding to the reflected light RL to be distributed to and stored in two of the charge storage units CS, control is performed so that the charge corresponding to the reflected light RL is stored in the two of the charge storage units CS for different durations (an example of “reflected light storage time”) in a single frame period according to the intensity of the reflected light RL. For example, the present embodiment focuses on the fact that the intensity of the reflected light RL varies depending on the distance to an object, assuming that the intensity of the light pulse PO and the reflectance of the object are constant.

In FIGS. 18A and 18B, in the case of receiving the reflected light RL reflected by the object OB located in the zone Z1 as in the case shown in FIG. 18A, the intensity of the reflected light RL is higher than in the case of receiving the reflected light RL reflected by an object located in the zone Z4 as in the case shown in FIG. 18B. If control is performed so that the time during which charge corresponding to the reflected light RL is stored is the same in the case shown in FIG. 18A and the case shown in 18B, in the case shown in FIG. 18A, the amount of charge corresponding to the reflected light RL is saturated, and in the case shown in 18B, a small amount of charge corresponding to the reflected light RL is stored. This may lead to distance measurement with low accuracy in both cases. In order to address this issue, the range image processing unit 4 performs control so that no saturation occurs in the charge storage units CS in the case of receiving the reflected light RL having a high intensity and that a large amount of charge is stored in the charge storage units CS in the case of receiving the reflected light RL having a low intensity, thus allowing distance measurement with higher accuracy. That is, the range image processing unit 4 performs control so that the reflected light storage time of the charge storage unit CS1 is shorter than the reflected light storage time of the charge storage unit CS2 in a single frame period. This makes it possible to prevent saturation of the charge storage unit CS1 in which charge corresponding to the reflected light RL having a higher intensity is stored and to store a large amount of charge in the charge storage units CS in which charge corresponding to the reflected light RL having a lower intensity is stored. The charge storage units CS1 and CS2 in FIG. 18A are an example of “two of the charge storage units to which charge corresponding to the reflected light RL is distributed and in which the charge is stored”.

Specifically, in FIGS. 18A and 18B, the 1st STEP and the 2nd STEP are provided in a single frame period. In the 1st STEP, charge is sequentially stored in the charge storage units CS1 to CS4. In the 2nd STEP, the relative timing of emission of the light pulse PO and charge storage in the charge storage units CS is the same as in the 1st STEP, and the timing at which charge is stored in the charge storage units CS2 to CS4 is unchanged, but the timing at which charge is stored in the charge storage unit CS1 is changed to the timing after the timing at which charge is stored in the charge storage unit CS4. Thus, the range image processing unit 4 performs control so that the reflected light storage time of the charge storage unit CS1 is shorter than the reflected light storage time of the charge storage unit CS2. More specifically, the range image processing unit 4 sets the reflected light storage time of the charge storage unit CS1 to (x) and sets the reflected light storage time of the charge storage unit CS2 to (x+y). Here, x represents the exposure time of each of the charge storage units CS1 to CS4 in the 1st STEP, and y represents the exposure time of each of the charge storage units CS2 to CS4 in the 2nd STEP.

In the examples shown in FIGS. 18A and 18B, in the 2nd STEP, the timing at which charge is stored in the charge storage unit CS1 is changed to the timing after the timing at which charge is stored in the charge storage unit CS4, thus making it possible to expand the measurement distance range to the zone Z4.

Advantageous effects of the first embodiment will be described. In the first embodiment, each of the pixels 321 includes three charge storage units CS. As a conventional operation, the operation defined in the timing chart in FIG. 4A was applied. The range imaging device 1 was operated so that the emission time To of the light pulse PO and the storage time Ta for the charge storage units CS were 39 ns. In this case, an object TA (object OB) was located at a distance of 0.5 m from the range imaging device 1, and the reflected light RL reflected by the object TA was received by a pixel GA. Furthermore, an object TB (object OB) was located at a distance of 8 m from the range imaging device 1, and the reflected light RL reflected by the object TB was received by a pixel GB.

The objects TA and TB had a reflectance of 80%. In this situation, when the conventional operation was performed, the pixel GA was saturated at an early stage. In the above configuration, the pixel GA was saturated when the cumulative number of distributions reached 5,000 (exposure time: 170 μs). In a conventional example, the cumulative number of distributions for the pixel GB receiving the reflected light RL from the object TB was also 5,000 (exposure time: 170 μs). A small amount of charge was stored in the charge storage units CS. This leads to a short exposure time and no significant difference from the amount of charge generated from external light; thus, the obtained data is more likely to include noise, making it difficult to accurately calculate the distance. When the range imaging device 1 was operated in the conventional example, the distance resolution was 10%. This shows that measurement for the object (object OB) located at a distance of 8 m was performed in the range of 7.2 m to 8.8 m.

On the other hand, in the measurement mode M1 of the first embodiment, in the short-distance light receiving pixels, distance measurement was performed when the cumulative number of distributions was 5,000. In the long-distance light receiving pixels, charge distribution was performed while the distribution of charge to the first charge storage unit was terminated, and the charge was stored without saturation until the total cumulative number of distributions reached 250,000 (exposure time: 8,500 μs). In distance calculation, the amount of charge was corrected by multiplying the charge stored in the first charge storage unit by 8500/170 as a correction value. Thus, the distance resolution for the object located at a distance of 8 m was 0.5%. This shows that measurement for the object (object OB) located at a distance of 8 m was performed in the range of 7.96 m to 8.04 m.

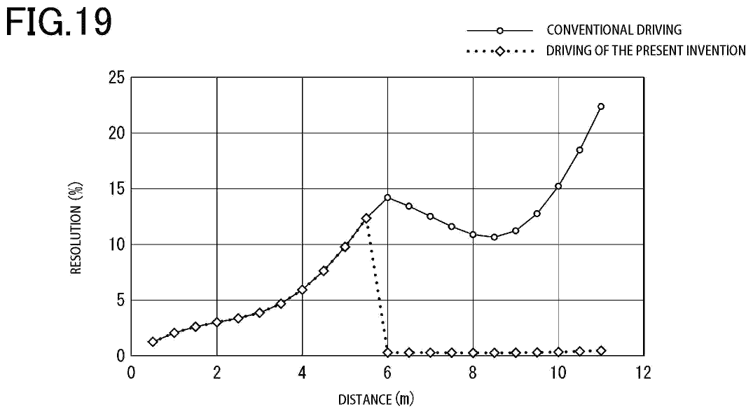

FIG. 19 shows the measurement results for the distance of 0.5 m to 12 m when an object at a short distance is located at a distance of 0.5 m, obtained by the method according to an embodiment of the present invention in comparison with the conventional example. A distance of 12 m is the upper limit of the distance range measurable by the range imaging device 1 having the structure described above.

FIG. 19 shows advantageous effects of the embodiment. The horizontal axis in FIG. 19 represents the measurement distance (m). The vertical axis in FIG. 19 represents the measurement distance resolution (%).

As shown in FIG. 19, for example, the short distance is determined as the measurement distance range of approximately 0.5 m to 6 m. This is because the emission time To of the light pulse PO and the distribution time Ta for the charge storage units CS are set to 39 ns. For the short distance in both the conventional example (indicated as conventional driving) and the present embodiment (indicated as driving according to an embodiment of the present invention), the number of distributions is set so that the exposure time does not exceed the upper limit of the exposure time that does not cause saturation of the reflected light RL from the object OB located at a measurement distance of approximately 0.5 m. Thus, in the measurement distance range of less than 6 m, the distance resolution is several percent or more, which is low. In the conventional example, when the emission time To and the storage time Ta are reduced, for example, set to 20 ns, the short distance is approximately 0 to 3 m, and the long distance is 3 m to 6 m. In this manner, when the number of distributions is set so that the exposure time does not exceed the upper limit of the exposure time that does not cause saturation of the reflected light RL from the object OB located at a distance of approximately 0.5 m, a distance resolution of 1% or less is achieved in the range of less than 3 m. However, in that case, the resolution at a long distance of 3 m or more is reduced by several percent or more.

On the other hand, in the present embodiment (indicated as driving according to an embodiment of the present invention), to reduce the measurement distance range, the emission time To and the storage time Ta are reduced, for example, set to 20 ns. In this case, the short distance is approximately 0 to 3 m, and the long distance is 3 m to 6 m. By applying the present embodiment under these conditions, the resolution can be increased to approximately 1% or less even at a distance of less than 6 m. In order to measure a longer distance under these conditions, one of the measurement modes M3 to M5 is used, and the number of charge storage units CS provided in each of the pixels 321 is set to four. Thus, in the present embodiment (indicated as driving according to an embodiment of the present invention), it is possible to measure the range from a short distance to a longer distance while the distance accuracy is maintained until the measurement distance range reaches 9 m. In order to measure a still longer range, the number of charge storage units is more than four.

Advantageous effects of the second embodiment will be described. In the second embodiment, each of the pixels 321 includes four charge storage units CS. The operation in the measurement mode M4 (operation defined in the timing chart in FIG. 12) was applied to measure the distance.

The emission time To of the light pulse PO and the distribution time Ta for the charge storage units CS were set to 39 ns. In a space for which an image was to be captured, the object TA (object OB) was located at a distance of 0.5 m from the range imaging device 1. In the range imaging device 1, the reflected light RL from the object TA was received by the pixel GA. In a space for which an image was to be captured, the object TB (object OB) was located at a distance of 8.0 m from the range imaging device 1. In the range imaging device 1, the reflected light RL from the object TB was received by the pixel GB. The object TA had a reflectance of 80% to the light pulse PO. The charge storage unit CS storing charge corresponding to the external light was fixed to the charge storage unit CS4.

When an operation was performed under the setting conditions described above, the pixel GA receiving the reflected light RL from an object at a short distance was saturated at a relatively early stage. In the above configuration, the pixel GA was saturated when the cumulative number of distributions (also referred to as the number of distributions) reached 5,000 (corresponding to an exposure time of 170 μs). In the conventional operation, the cumulative number of distributions for the pixel GB receiving the reflected light RL from the object TB located at a distance of 8 m was also 5,000.

In this case, the amount of reflected light RL from an object at a long distance was attenuated before reception; thus, a small amount of charge was stored in the charge storage units CS. This leads to a short exposure time and no significant difference from the amount of charge generated from external light; thus, the obtained data is more likely to include noise, making it difficult to accurately calculate the distance. When the range imaging device 1 was operated in the conventional example, the distance resolution was 10%. This shows that measurement for the object (object OB) located at a distance of 8 m was performed in the range of 7.2 m to 8.8 m.

On the other hand, in the measurement mode M4 of the second embodiment, in the short-distance light receiving pixels, distance measurement was performed when the cumulative number of distributions was 5,000. In the long-distance light receiving pixels, charge distribution was performed so that the distribution of charge to the charge storage unit CS1 was terminated, and the charge could be stored without saturation until the total cumulative number of distributions reached 250,000 (exposure time: 8,500 μs). In distance calculation, the amount of charge was corrected by multiplying the charge stored in the first charge storage unit by 8500/170 as a correction value. Thus, the distance resolution for the object located at a distance of 8 m was 0.5%. This shows that measurement for the object (object OB) located at a distance of 8 m was performed in the range of 7.96 m to 8.04 m.

Under the above conditions, the same results were obtained for the first embodiment and the second embodiment. For these embodiments, the emission time To of the light pulse PO and the distribution time Ta for the charge storage units CS were set to 39 ns. In this case, the emission time To was set to a large value; thus, a small amount of delay charge was generated, and the influence of the delay charge was small. In the case where the emission time To is set to a small value in order to measure the distance with high accuracy, a large amount of delay charge is more likely to be generated. Therefore, the second embodiment including a larger number of charge storage units CS is presumably more suitable. However, in the second embodiment, implementation tends to be difficult; thus, it is preferable to set a suitable structure and operation timing according to the conditions.

As described above, the range imaging device 1 according to the first embodiment includes the light source unit 2, the light receiving unit 3, and the range image processing unit 4. The light source unit 2 emits the light pulse PO to a measurement space E. The light receiving unit 3 includes the pixels and the vertical scanning circuit 323 (pixel driving circuit). Each of the pixels includes the photoelectric conversion device PD that generates charge corresponding to incident light, and the multiple charge storage units CS that store the charge. The vertical scanning circuit 323 causes the charge to be distributed to and stored in each of the charge storage units CS at a predetermined storage timing synchronized with emission of the light pulse PO. The range image processing unit 4 measures the distance to the object OB that is present in the measurement space E, based on the amount of charge stored in each of the charge storage units CS. The range image processing unit 4 controls the storage time Ta during which charge is stored in the charge storage units CS in a single distribution process or the number of distribution processes (the number of distributions) in a single frame period so that the charge storage units CS have different exposure times in a single frame period.

Thus, in the range imaging device 1 according to the first embodiment, charge can be stored in the multiple charge storage units of each of the pixels for different exposure times. This makes it possible to perform accurate measurement for an object located at a short distance and an object located at a long distance.

As a comparative example, a configuration will be described in which instead of the multiple measurement steps provided in each frame, multiple subframes are provided in each frame, the exposure time is changed for each of the subframes, and data is read each time when an operation for each of the subframes ends. In this case, even when the pulse width (storage time Ta) is reduced, by increasing the number of subframes while ensuring a sufficient cumulative number of distributions for each of the subframes, the measurement distance can be increased. Thus, the configuration has an advantage in that the accuracy of measurement is improved while the measurement distance is increased. However, the configuration has a disadvantage in that data is read each time an operation for each of the subframes ends; thus, data reading becomes time consuming and measurement also becomes time consuming. The configuration has a data storage region for holding the read data. Furthermore, having a large number of subframes tends to cause a short exposure time, making it difficult to maintain the measurement accuracy. Furthermore, having a large number of subframes tends to require complicated control.

On the other hand, in the first embodiment, although the measurement steps are provided in each frame, data is read only once after an operation for each frame ends. Thus, less time is required to read data for each frame, allowing a longer exposure time in each frame.

In the first embodiment, control is performed in the measurement steps not through completely different operations but through the same operation within each frame, except that control is performed to prevent a situation in which only the reading gate transistor G via which no charge is stored is in the ON state. Thus, control is easy even when a larger number of steps are provided.

All or part of the range imaging device 1 and the range image processing unit 4 of the embodiments described above may be implemented by a computer. This may be achieved by recording a program for implementing the functions on a computer-readable recording medium and causing a computer system to read and execute the program recorded on the recording medium. The “computer system” herein includes an OS and hardware such as peripheral devices. The “computer-readable recording medium” refers to a storage device such as a portable medium such as a flexible disk, a magneto-optical disk, a ROM, or a CD-ROM, or a hard disk incorporated in a computer system. The “computer-readable recording medium” may also include a recording medium dynamically holding a program for a short period of time, such as a communication line in the case of transmitting the program via a network such as the Internet or a communication channel such as a telephone line, and a recording medium holding a program for a certain period of time, such as a volatile memory in a computer system serving as a server or a client in the above case. The program may be a program for implementing some of the functions described above, a program capable of implementing the above-described functions in combination with a program already recorded in a computer system, or a program implemented using a programmable logic device such as an FPGA.

Embodiments of the present invention have been described in detail with reference to the drawings; however, the specific configuration of the present invention is not limited to the embodiments, and includes, for example, designs within the scope not departing from the spirit of the present invention.

An embodiment according to the present invention enables charge generated from reflected light received by pixels to be stored in multiple charge storage units of the pixels for different durations according to the intensity of the reflected light.

Conventional techniques for measuring the distance to an object include a technique of measuring the time of flight of a light pulse. Such a technique is called a time-of-flight (hereinafter referred to as TOF) technique. In the TOF technique, which uses the known speed of light, a light pulse in the near-infrared range is emitted to an object. The TOF technique measures the time difference between the time at which the light pulse is emitted and the time at which reflected light of the emitted light pulse reflected by the object is received. The time difference is used to calculate the distance to the object. Ranging sensors that use a photodiode (photoelectric conversion device) to detect light for distance measurement are used in practical applications.

In recent years, ranging sensors in practical applications can obtain not only the distance to an object but also depth information for each pixel of a two-dimensional image including the object, that is, three-dimensional information on an object. Such ranging sensors are also called range imaging devices. In a range imaging device, multiple pixels including a photodiode are arranged in a two-dimensional matrix on a silicon substrate, and the pixel surface receives light reflected by an object. In the range imaging device, a photoelectric conversion signal based on the amount of light (charge) received by each of the pixels is output for a single image to obtain a two-dimensional image including the object, and distance information for each of the pixels constituting the image. For example, JP 4235729 B discloses a technique of calculating a distance by sequentially distributing charge to three charge storage units provided in each pixel.

In such range imaging devices, a larger amount of reflected light received by pixels allows distance measurement with higher accuracy. Thus, range imaging devices are required to have a longer exposure time during which pixels can receive light (a larger cumulative number of charge distributions and a larger amount of exposure).

The intensity of light is generally known to be inversely proportional to the square of the distance. Thus, the intensity of reflected light from an object located at a short distance received by a light receiving unit is hardly attenuated; however, the intensity of reflected light from an object located at a long distance received by the light receiving unit is attenuated. As in the range imaging device described in JP 4235729 B, to cause charge to be distributed to and stored in three charge storage units, in pixels that receive reflected light from an object at a short distance (hereinafter referred to as short-distance light receiving pixels), charge is stored in a first charge storage unit and a second charge storage unit to which reflected light is distributed, which is relatively quickly reaching the pixel. In pixels that receive reflected light from an object at a long distance (hereinafter referred to as long-distance light receiving pixels), charge is stored in a second charge storage unit and a third charge storage unit to which reflected light is distributed, which is relatively delayed in reaching the pixel.

In this case, reflected light having a relatively high intensity is received by the short-distance light receiving pixels. This makes it possible to store a large amount of charge in the charge storage units, allowing distance measurement with high accuracy. However, if the amount of charge stored in the charge storage units exceeds the upper limit of the storage capacity of the charge storage units (if the charge storage units are saturated), the distance cannot be accurately calculated. Thus, the upper limit of the exposure time is set to prevent saturation of the charge storage units. That is, the upper limit of the exposure time is determined according to the amount of charge stored in the first charge storage unit.

On the other hand, reflected light having a relatively low intensity is received by the long-distance light receiving pixels. Thus, no saturation of the three charge storage units occurs when the long-distance light receiving pixels have the same exposure time as the short-distance light receiving pixels. However, in this case, the amount of charge stored in the long-distance light receiving pixels is smaller than the amount of charge stored in the short-distance light receiving pixels. This leads to distance measurement with low accuracy.

Range imaging devices are typically designed such that all pixels used for distance measurement are driven at the same timing. The pixels used for distance measurement are, of pixels provided in a range imaging device such as an image sensor, pixels that store charge whose quantity is used for distance calculation, except for pixels for special uses such as PDAF (phase difference autofocus) pixels and optical black pixels. That is, the same exposure time is applied to all the pixels used for distance measurement. Thus, when a range imaging device captures an image of a space in which an object located at a short distance and an object located at a long distance are mixed, the exposure time is determined according to the intensity of reflected light from the object at a short distance.

In this case, the maximum amount of charge that does not cause saturation is stored in a first charge storage unit of short-distance light receiving pixels. As compared with the first charge storage unit of the short-distance light receiving pixels, a smaller amount of charge is stored in the other charge storage units. The other charge storage units are a second charge storage unit and a third charge storage unit of the short-distance light receiving pixels, and a first charge storage unit, a second charge storage unit, and a third charge storage unit of long-distance light receiving pixels. In this case, by causing the second charge storage unit and the third charge storage unit of the long-distance light receiving pixels to have a longer exposure time, it is possible to prevent reduction in accuracy of distance measurement for the object located at a long distance. That is, by causing charge corresponding to reflected light received by the pixels to be stored in the multiple charge storage units of the pixels for different durations (reflected light storage times described later) according to the intensity of the reflected light, it is possible to perform accurate measurement for the object located at a short distance and the object located at a long distance. The intensity of reflected light may vary depending on the distance from the range imaging device to an object. However, the intensity of reflected light also varies depending on the intensity of an emitted light pulse and the reflectance of the object. Hereinafter, the intensity of reflected light that varies depending on factors such as the distance to an object, the intensity of an emitted light pulse, and the reflectance of the object is simply referred to as “intensity of reflected light”.

A range imaging device and a range imaging method according to embodiments of the present invention enable charge generated from reflected light received by pixels to be stored in multiple charge storage units of the pixels for different durations according to the intensity of the reflected light.

A range imaging device according to an embodiment of the present invention includes a light source unit that emits a light pulse to a measurement space which is a space to be measured, a light receiving unit that includes a pixel and a pixel driving circuit, the pixel including a photoelectric conversion device that generates charge corresponding to incident light, and three or more charge storage units that store the charge, the pixel driving circuit causing the charge to be distributed to and stored in each of the charge storage units of the pixel at predetermined timings synchronized with emission of the light pulse, and a range image processing unit that calculates a distance to an object that is present in the measurement space, based on an amount of charge stored in each of the charge storage units. To cause charge corresponding to reflected light of the light pulse reflected by the object to be distributed to and stored in two of the charge storage units, the range image processing unit performs control so that the charge corresponding to the reflected light is stored in the two of the charge storage units for different reflected light storage times in a single frame period according to an intensity of the reflected light.

In a range imaging device according to an embodiment of the present invention, in a distribution process, the range image processing unit controls the pixel driving circuit so that charge corresponding to reflected light of the light pulse reflected by the object is sequentially distributed to and stored in a first charge storage unit and a second charge storage unit of the three or more charge storage units, the second charge storage unit being different from the first charge storage unit. The range image processing unit controls a storage time or the number of distribution processes performed in a single frame period so that an exposure time of the first charge storage unit is shorter than an exposure time of each of the other charge storage units, the storage time being a time during which charge is stored in each of the charge storage units in a single distribution process.

In a range imaging device according to an embodiment of the present invention, in a distribution process, the range image processing unit controls the pixel driving circuit so that only charge corresponding to an external light component is stored in a first charge storage unit of the three or more charge storage units and that charge corresponding to reflected light of the light pulse reflected by the object is sequentially distributed to and stored in a second charge storage unit and a third charge storage unit, the second charge storage unit being different from the first charge storage unit, the third charge storage unit being different from the first charge storage unit and different from the second charge storage unit. The range image processing unit controls a storage time or the number of distribution processes performed in a single frame period so that an exposure time of the second charge storage unit is shorter than an exposure time of each of the other charge storage units, the storage time being a time during which charge is stored in each of the charge storage units in a single distribution process.

In a range imaging device according to an embodiment of the present invention, the range image processing unit performs correction of the amount of charge stored in each of the charge storage units, based on an exposure time of the corresponding one of the charge storage units, and the range image processing unit calculates the distance to the object using the amount of charge obtained by the correction.

In a range imaging device according to an embodiment of the present invention, the pixel includes a first charge storage unit, a second charge storage unit, and a third charge storage unit. The range image processing unit controls the pixel driving circuit so that charge corresponding to reflected light of the light pulse reflected by the object located at a first distance is sequentially distributed to and stored in the first charge storage unit and the second charge storage unit and that charge corresponding to reflected light of the light pulse reflected by the object located at a second distance that is greater than the first distance is sequentially distributed to and stored in the second charge storage unit and the third charge storage unit.

In a range imaging device according to an embodiment of the present invention, the range image processing unit performs correction of the amount of charge stored in each of the charge storage units, based on an exposure time of the corresponding one of the charge storage units, and compares the amount of charge stored in the first charge storage unit after correction with the amount of charge in the third charge storage unit after correction. When the amount of charge stored in the first charge storage unit after correction is larger than the amount of charge in the third charge storage unit after correction, the range image processing unit determines that the pixel has received reflected light of the light pulse reflected by the object located at the first distance, and when the amount of charge stored in the first charge storage unit after correction is smaller than or equal to the amount of charge in the third charge storage unit after correction, the range image processing unit determines that the pixel has received reflected light of the light pulse reflected by the object located at the second distance.

In a range imaging device according to an embodiment of the present invention, the range image processing unit applies, as a range of the first distance and the second distance, a range corresponding to an emission time during which the light pulse is emitted and a storage time during which charge is stored in each of the charge storage units in a single distribution process.

In a range imaging device according to an embodiment of the present invention, the pixel includes a first charge storage unit, a second charge storage unit, a third charge storage unit, and a fourth charge storage unit. The range image processing unit controls the pixel driving circuit so that only charge corresponding to an external light component is stored in the first charge storage unit and that charge corresponding to reflected light of the light pulse reflected by the object located at a first distance is sequentially distributed to and stored in the second charge storage unit and the third charge storage unit and that charge corresponding to reflected light of the light pulse reflected by the object located at a second distance that is greater than the first distance is sequentially distributed to and stored in the third charge storage unit and the fourth charge storage unit.

In a range imaging device according to an embodiment of the present invention, the pixel includes a first charge storage unit, a second charge storage unit, a third charge storage unit, and a fourth charge storage unit. The range image processing unit controls the pixel driving circuit so that charge corresponding to reflected light of the light pulse reflected by the object located at a first distance is sequentially distributed to and stored in the first charge storage unit and the second charge storage unit and that charge corresponding to reflected light of the light pulse reflected by the object located at a second distance that is greater than the first distance is sequentially distributed to and stored in the second charge storage unit and the third charge storage unit and that only charge corresponding to an external light component is stored in the fourth charge storage unit.

In a range imaging device according to an embodiment of the present invention, the pixel includes a first charge storage unit, a second charge storage unit, a third charge storage unit, and a fourth charge storage unit. The range image processing unit controls the pixel driving circuit so that charge corresponding to reflected light of the light pulse reflected by the object located at a first distance is sequentially distributed to and stored in the first charge storage unit and the second charge storage unit and that charge corresponding to reflected light of the light pulse reflected by the object located at a second distance that is greater than the first distance is sequentially distributed to and stored in the second charge storage unit and the third charge storage unit and that charge corresponding to reflected light of the light pulse reflected by the object located at a third distance that is greater than the second distance is sequentially distributed to and stored in the third charge storage unit and the fourth charge storage unit.

In a range imaging device according to an embodiment of the present invention, the range image processing unit performs correction of the amount of charge stored in each of the charge storage units, based on an exposure time of the corresponding one of the charge storage units, and the range image processing unit uses the amount of charge stored in the first charge storage unit after correction and the amount of charge in the fourth charge storage unit after correction to determine whether the pixel has received reflected light of the light pulse reflected by the object located at the first distance.

In a range imaging device according to an embodiment of the present invention, the range image processing unit applies, as a range of the first distance and the second distance, a range corresponding to an emission time during which the light pulse is emitted and a storage time during which charge is stored in each of the charge storage units in a single distribution process.

In a range imaging device according to an embodiment of the present invention, the range image processing unit performs control so that the charge storage units have the same exposure time in a single frame period and that a storage timing at which charge is stored in each of the charge storage units is different in multiple distribution processes performed in a single frame period.

In a range imaging device according to an embodiment of the present invention, the pixel includes a first charge storage unit, a second charge storage unit, and a third charge storage unit. The range image processing unit performs a first process a first number of times and a second process a second number of times in a single frame period, the first process being a process in which the storage timing is a first timing, the second process being a process in which the storage timing is a second timing. In the first process, the range image processing unit performs control so that charge corresponding to reflected light of the light pulse reflected by the object located at a first distance is sequentially distributed to and stored in the first charge storage unit and the second charge storage unit and that charge corresponding to reflected light of the light pulse reflected by the object located at a second distance that is greater than the first distance is sequentially distributed to and stored in the second charge storage unit and the third charge storage unit. In the second process, the range image processing unit performs control so that charge is stored in the second charge storage unit and the third charge storage unit at the same timing as in the first process and that charge corresponding to reflected light of the light pulse reflected by the object located at a third distance that is greater than the second distance is sequentially distributed to and stored in the third charge storage unit and the first charge storage unit.

In a range imaging device according to an embodiment of the present invention, the pixel includes a first charge storage unit, a second charge storage unit, a third charge storage unit, and a fourth charge storage unit. The range image processing unit performs a first process a first number of times and a second process a second number of times in a single frame period, the first process being a process in which the storage timing is a first timing, the second process being a process in which the storage timing is a second timing. In the first process, the range image processing unit performs control so that charge corresponding to reflected light of the light pulse reflected by the object located at a first distance is sequentially distributed to and stored in the first charge storage unit and the second charge storage unit and that charge corresponding to reflected light of the light pulse reflected by the object located at a second distance that is greater than the first distance is sequentially distributed to and stored in the second charge storage unit and the third charge storage unit and that charge corresponding to reflected light of the light pulse reflected by the object located at a third distance that is greater than the second distance is sequentially distributed to and stored in the third charge storage unit and the fourth charge storage unit. In the second process, the range image processing unit performs control so that charge is stored in the second charge storage unit, the third charge storage unit, and the fourth charge storage unit at the same timing as in the first process and that charge corresponding to reflected light of the light pulse reflected by the object located at a fourth distance that is greater than the third distance is sequentially distributed to and stored in the fourth charge storage unit and the first charge storage unit.

In a range imaging device according to an embodiment of the present invention, the range image processing unit determines the first number of times so that an amount of charge corresponding to reflected light of the light pulse reflected by the object located at the first distance stored in the charge storage units exceeds a threshold set in advance, and the threshold is a value determined according to an upper limit of an amount of charge allowed to be stored in the charge storage units.

In a range imaging device according to an embodiment of the present invention, the range image processing unit randomly or pseudo-randomly performs the first process and the second process in a single frame period.

In a range imaging device according to an embodiment of the present invention, the range image processing unit performs correction of the amount of charge stored in the first charge storage unit and calculates the distance to the object using the amount of charge obtained by the correction, when the first charge storage unit in the first process is an external light charge storage unit and the first charge storage unit in the second process is a reflected light charge storage unit, or when the first charge storage unit in the first process is the reflected light charge storage unit and the first charge storage unit in the second process is the external light charge storage unit, the external light charge storage unit being one of the charge storage units in which only charge corresponding to an external light component is stored, the reflected light charge storage unit being one of the charge storage units to which charge corresponding to reflected light of the light pulse reflected by the object is distributed and in which the charge is stored.

A range imaging method according to an embodiment of the present invention is a range imaging method executed by a range imaging device including a light source unit that emits a light pulse to a measurement space which is a space to be measured, and a light receiving unit that includes a pixel and a pixel driving circuit, the pixel including a photoelectric conversion device that generates charge corresponding to incident light, and three or more charge storage units that store the charge, the pixel driving circuit causing the charge to be distributed to and stored in each of the charge storage units of the pixel at predetermined timings synchronized with emission of the light pulse. A range image processing unit calculates a distance to an object that is present in the measurement space, based on an amount of charge stored in each of the charge storage units. Also, to cause charge corresponding to reflected light of the light pulse reflected by the object to be distributed to and stored in two of the charge storage units, the range image processing unit performs control so that the charge corresponding to the reflected light is stored in the two of the charge storage units for different reflected light storage times in a single frame period according to an intensity of the reflected light.

An embodiment according to the present invention enables charge generated from reflected light received by pixels to be stored in multiple charge storage units of the pixels for different durations according to the intensity of the reflected light.

Obviously, numerous modifications and variations of the present invention are possible in light of the above teachings. It is therefore to be understood that within the scope of the appended claims, the invention may be practiced otherwise than as specifically described herein.

1. A range imaging device, comprising:
a light source configured to emit a light pulse to a measurement space;
a range image processing unit comprising circuitry configured to calculate a distance to an object in the measurement space; and
a light receiving unit comprising a pixel and a pixel driving circuit such that the pixel includes a photoelectric conversion device that generates charge corresponding to incident light, and three or more charge storage units that store the charge, and that the pixel driving circuit causes the charge to be distributed to and stored in each of the charge storage units of the pixel at predetermined timings synchronized with emission of the light pulse,
wherein the range image processing unit calculates the distance to the object in the measurement space based on an amount of the charge stored in each of the charge storage units and controls such that the charge corresponding to reflected light of the light pulse reflected by the object is stored in two of the charge storage units for different reflected light storage times in a single frame period according to an intensity of the reflected light.

2. The range imaging device according to claim 1, wherein in a distribution process, the range image processing unit controls the pixel driving circuit so that charge corresponding to reflected light of the light pulse reflected by the object is sequentially distributed to and stored in a first charge storage unit and a second charge storage unit of the three or more charge storage units, the second charge storage unit being different from the first charge storage unit, and the range image processing unit controls a storage time or the number of distribution processes performed in a single frame period so that an exposure time of the first charge storage unit is shorter than an exposure time of each of the other charge storage units, the storage time being a time during which charge is stored in each of the charge storage units in a single distribution process.

3. The range imaging device according to claim 1, wherein in a distribution process, the range image processing unit controls the pixel driving circuit so that only charge corresponding to an external light component is stored in a first charge storage unit of the three or more charge storage units and that charge corresponding to reflected light of the light pulse reflected by the object is sequentially distributed to and stored in a second charge storage unit and a third charge storage unit, the second charge storage unit being different from the first charge storage unit, the third charge storage unit being different from the first charge storage unit and different from the second charge storage unit, and the range image processing unit controls a storage time or the number of distribution processes performed in a single frame period so that an exposure time of the second charge storage unit is shorter than an exposure time of each of the other charge storage units, the storage time being a time during which charge is stored in each of the charge storage units in a single distribution process.

4. The range imaging device according to claim 1, wherein the range image processing unit performs correction of the amount of charge stored in each of the charge storage units, based on an exposure time of the corresponding one of the charge storage units, and the range image processing unit calculates the distance to the object using the amount of charge obtained by the correction.

5. The range imaging device according to claim 1, wherein the pixel includes a first charge storage unit, a second charge storage unit, and a third charge storage unit, and the range image processing unit controls the pixel driving circuit so that charge corresponding to reflected light of the light pulse reflected by the object located at a first distance is sequentially distributed to and stored in the first charge storage unit and the second charge storage unit and that charge corresponding to reflected light of the light pulse reflected by the object located at a second distance that is greater than the first distance is sequentially distributed to and stored in the second charge storage unit and the third charge storage unit.

6. The range imaging device according to claim 5, wherein the range image processing unit performs correction of the amount of charge stored in each of the charge storage units, based on an exposure time of the corresponding one of the charge storage units, and compares the amount of charge stored in the first charge storage unit after correction with the amount of charge in the third charge storage unit after correction, when the amount of charge stored in the first charge storage unit after correction is larger than the amount of charge in the third charge storage unit after correction, the range image processing unit determines that the pixel has received reflected light of the light pulse reflected by the object located at the first distance, and when the amount of charge stored in the first charge storage unit after correction is smaller than or equal to the amount of charge in the third charge storage unit after correction, the range image processing unit determines that the pixel has received reflected light of the light pulse reflected by the object located at the second distance.

7. The range imaging device according to claim 6, wherein the range image processing unit applies, as a range of the first distance and the second distance, a range corresponding to an emission time during which the light pulse is emitted and a storage time during which charge is stored in each of the charge storage units in a single distribution process.

8. The range imaging device according to claim 1, wherein the pixel includes a first charge storage unit, a second charge storage unit, a third charge storage unit, and a fourth charge storage unit, and the range image processing unit controls the pixel driving circuit so that only charge corresponding to an external light component is stored in the first charge storage unit and that charge corresponding to reflected light of the light pulse reflected by the object located at a first distance is sequentially distributed to and stored in the second charge storage unit and the third charge storage unit and that charge corresponding to reflected light of the light pulse reflected by the object located at a second distance that is greater than the first distance is sequentially distributed to and stored in the third charge storage unit and the fourth charge storage unit.

9. The range imaging device according to claim 1, wherein the pixel includes a first charge storage unit, a second charge storage unit, a third charge storage unit, and a fourth charge storage unit, and the range image processing unit controls the pixel driving circuit so that charge corresponding to reflected light of the light pulse reflected by the object located at a first distance is sequentially distributed to and stored in the first charge storage unit and the second charge storage unit and that charge corresponding to reflected light of the light pulse reflected by the object located at a second distance that is greater than the first distance is sequentially distributed to and stored in the second charge storage unit and the third charge storage unit and that only charge corresponding to an external light component is stored in the fourth charge storage unit.

10. The range imaging device according to claim 1, wherein the pixel includes a first charge storage unit, a second charge storage unit, a third charge storage unit, and a fourth charge storage unit, and the range image processing unit controls the pixel driving circuit so that charge corresponding to reflected light of the light pulse reflected by the object located at a first distance is sequentially distributed to and stored in the first charge storage unit and the second charge storage unit and that charge corresponding to reflected light of the light pulse reflected by the object located at a second distance that is greater than the first distance is sequentially distributed to and stored in the second charge storage unit and the third charge storage unit and that charge corresponding to reflected light of the light pulse reflected by the object located at a third distance that is greater than the second distance is sequentially distributed to and stored in the third charge storage unit and the fourth charge storage unit.

11. The range imaging device according to claim 8, wherein the range image processing unit performs correction of the amount of charge stored in each of the charge storage units, based on an exposure time of the corresponding one of the charge storage units, and the range image processing unit uses the amount of charge stored in the first charge storage unit after correction and the amount of charge in the fourth charge storage unit after correction to determine whether the pixel has received reflected light of the light pulse reflected by the object located at the first distance.

12. The range imaging device according to claim 8, wherein the range image processing unit applies, as a range of the first distance and the second distance, a range corresponding to an emission time during which the light pulse is emitted and a storage time during which charge is stored in each of the charge storage units in a single distribution process.

13. The range imaging device according to claim 1, wherein the range image processing unit performs control so that the charge storage units have the same exposure time in a single frame period and that a storage timing at which charge is stored in each of the charge storage units is different in a plurality of distribution processes performed in a single frame period.

14. The range imaging device according to claim 13, wherein the pixel includes a first charge storage unit, a second charge storage unit, and a third charge storage unit, the range image processing unit performs a first process a first number of times and a second process a second number of times in a single frame period, the first process being a process in which the storage timing is a first timing, the second process being a process in which the storage timing is a second timing, in the first process, the range image processing unit performs control so that charge corresponding to reflected light of the light pulse reflected by the object located at a first distance is sequentially distributed to and stored in the first charge storage unit and the second charge storage unit and that charge corresponding to reflected light of the light pulse reflected by the object located at a second distance that is greater than the first distance is sequentially distributed to and stored in the second charge storage unit and the third charge storage unit, and in the second process, the range image processing unit performs control so that charge is stored in the second charge storage unit and the third charge storage unit at the same timing as in the first process and that charge corresponding to reflected light of the light pulse reflected by the object located at a third distance that is greater than the second distance is sequentially distributed to and stored in the third charge storage unit and the first charge storage unit.

15. The range imaging device according to claim 13, wherein the pixel includes a first charge storage unit, a second charge storage unit, a third charge storage unit, and a fourth charge storage unit, the range image processing unit performs a first process a first number of times and a second process a second number of times in a single frame period, the first process being a process in which the storage timing is a first timing, the second process being a process in which the storage timing is a second timing, in the first process, the range image processing unit performs control so that charge corresponding to reflected light of the light pulse reflected by the object located at a first distance is sequentially distributed to and stored in the first charge storage unit and the second charge storage unit and that charge corresponding to reflected light of the light pulse reflected by the object located at a second distance that is greater than the first distance is sequentially distributed to and stored in the second charge storage unit and the third charge storage unit and that charge corresponding to reflected light of the light pulse reflected by the object located at a third distance that is greater than the second distance is sequentially distributed to and stored in the third charge storage unit and the fourth charge storage unit, and in the second process, the range image processing unit performs control so that charge is stored in the second charge storage unit, the third charge storage unit, and the fourth charge storage unit at the same timing as in the first process and that charge corresponding to reflected light of the light pulse reflected by the object located at a fourth distance that is greater than the third distance is sequentially distributed to and stored in the fourth charge storage unit and the first charge storage unit.

16. The range imaging device according to claim 14, wherein the range image processing unit determines the first number of times so that an amount of charge corresponding to reflected light of the light pulse reflected by the object located at the first distance stored in the charge storage units exceeds a threshold set in advance, and the threshold is a value determined according to an upper limit of an amount of charge allowed to be stored in the charge storage units.

17. The range imaging device according to claim 14, wherein the range image processing unit randomly or pseudo-randomly performs the first process and the second process in a single frame period.

18. The range imaging device according to claim 14, wherein the range image processing unit performs correction of the amount of charge stored in the first charge storage unit and calculates the distance to the object using the amount of charge obtained by the correction, when the first charge storage unit in the first process is an external light charge storage unit and the first charge storage unit in the second process is a reflected light charge storage unit, or when the first charge storage unit in the first process is the reflected light charge storage unit and the first charge storage unit in the second process is the external light charge storage unit, the external light charge storage unit being one of the charge storage units in which only charge corresponding to an external light component is stored, the reflected light charge storage unit being one of the charge storage units to which charge corresponding to reflected light of the light pulse reflected by the object is distributed and in which the charge is stored.

19. The range imaging device according to claim 2, wherein the range image processing unit performs correction of the amount of charge stored in each of the charge storage units, based on an exposure time of the corresponding one of the charge storage units, and the range image processing unit calculates the distance to the object using the amount of charge obtained by the correction.

20. A range imaging method, comprising:
emitting a light pulse to a measurement space; and
calculating a distance to an object in the measurement space based on an amount of charge stored in each of charge storage units,
wherein a range imaging device is configured to execute the range imaging method and includes a light source configured to emit the light pulse to the measurement space, a range image processing unit comprising circuitry configured to calculate the distance to the object in the measurement space based on the amount of charge stored in each of the charge storage units, and a light receiving unit includes a pixel and a pixel driving circuit such that the pixel includes a photoelectric conversion device that generates the charge corresponding to incident light, and three or more charge storage units that store the charge, and that the pixel driving circuit causes the charge to be distributed to and stored in each of the charge storage units of the pixel at predetermined timings synchronized with emission of the light pulse.
